(19) United States
(12) Patent Application Publication
(10) Pub. No.: US 2023/0344563 A1
(43) Pub. Date: Oct. 26, 2023

(54) Method and Apparatus for Transmitting Sidelink Feedback in a Wireless Communication System

(71) Applicant: AUSTEK Computer Inc., Taipei City (TW)

(72) Inventors: Chun-Wei Huang, Taipei City (TW); Ming-Che Li, Taipei City (TW)

(21) Appl. No.: 18/119,878

(22) Filed: Mar. 10, 2023

Related U.S. Application Data
(60) Provisional application No. 63/319,047, filed on Mar. 11, 2022.
(60) Provisional application No. 63/319,061, filed on Mar. 11, 2022.
(60) Provisional application No. 63/319,074, filed on Mar. 11, 2022.

(51) Int. Cl. H04L 1/1829; H04W 74/00; H04W 74/08

(52) U.S. Cl. CPC H04L 1/1854; H04W 74/002; H04W 74/0808

(57) ABSTRACT

In an example, a first User Equipment (UE) receives a sidelink transmission, associated with enabled sidelink Hybrid Automatic Repeat Request (HARQ) feedback, from a second UE in a first timing. The first UE attempts to access a channel for transmission of a sidelink HARQ feedback in a first feedback resource in a second timing. The sidelink HARQ feedback is in response to the sidelink transmission. The attempt to access the channel for the transmission of the sidelink HARQ feedback in the first feedback resource fails. The first UE performs channel access for a second feedback resource. The second feedback resource is within a window and/or within a predefined duration of the first timing or the second timing. In response to successfully performing the channel access, the first UE performs, in the second feedback resource, a sidelink feedback transmission of the sidelink HARQ feedback to the second UE.

### CROSS-REFERENCE TO RELATED APPLICATIONS

The present Application claims the benefit of U.S. Provisional Pat. Application Serial No. 63/319,047 filed on Mar. 11, 2022, the entire disclosure of which is incorporated herein in its entirety by reference. The present Application also claims the benefit of U.S. Provisional Pat. Application Serial No. 63/319,061 filed on Mar. 11, 2022, the entire disclosure of which is incorporated herein in its entirety by reference. The present Application also claims the benefit of U.S. Provisional Pat. Application Serial No. 63/319,074 filed on Mar. 11, 2022, the entire disclosure of which is incorporated herein in its entirety by reference.

### FIELD

This disclosure generally relates to wireless communication networks, and more particularly, to a method and apparatus for transmitting sidelink feedback in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a first User Equipment (UE) performing sidelink communication in a sidelink resource pool, the first UE receives a sidelink transmission from a second UE, wherein the sidelink transmission is associated with enabled sidelink Hybrid Automatic Repeat Request (HARQ) feedback. The first UE attempts to access a channel for transmission of a sidelink HARQ feedback in a first feedback resource. The sidelink HARQ feedback is in response to the sidelink transmission. The attempt to access the channel for the transmission of the sidelink HARQ feedback in the first feedback resource fails. The first UE performs channel access for a second feedback resource. The second feedback resource is within a window. The channel access for the second feedback resource is performed successfully. In response to successfully performing the channel access for the second feedback resource, the first UE performs, in the second feedback resource, a sidelink feedback transmission of the sidelink HARQ feedback to the second UE.

In an example from the perspective of a first UE performing sidelink communication in a sidelink resource pool, the first UE receives. a sidelink transmission from a second UE in a first timing, wherein the sidelink transmission is associated with enabled sidelink HARQ feedback. The first UE attempts to access a channel for transmission of a sidelink HARQ feedback in a first feedback resource in a second timing. The sidelink HARQ feedback is in response to the sidelink transmission. The attempt to access the channel for the transmission of the sidelink HARQ feedback in the first feedback resource fails. The first UE performs channel access for a second feedback resource. The second feedback resource is within a predefined duration of the first timing or the second timing. The channel access for the second feedback resource is performed successfully. In response to successfully performing the channel access for the second feedback resource, the first UE performs, in the second feedback resource, a sidelink feedback transmission of the sidelink HARQ feedback to the second UE.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram illustrating an exemplary scenario associated with a first UE receives a Physical Sidelink Control Channel (PSCCH) and/or Physical Sidelink Shared Channel (PSSCH) from a second UE according to one exemplary embodiment.

FIG. 6 is a diagram illustrating periods for Physical Sidelink Feedback Channel (PSFCH) according to one exemplary embodiment.

FIG. 7 is a diagram illustrating configuration of fixed frame periods (FFPs) and/or slots according to one exemplary embodiment.

FIG. 8 is a flow chart according to one exemplary embodiment.

FIG. 9 is a flow chart according to one exemplary embodiment.

FIG. 10 is a flow chart according to one exemplary embodiment.

FIG. 11 is a flow chart according to one exemplary embodiment.

FIG. 12 is a flow chart according to one exemplary embodiment.

FIG. 13 is a flow chart according to one exemplary embodiment.

FIG. 14 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based upon code division multiple access (CDMA), time division multiple access (TDMA), orthogonal frequency division multiple access (OFDMA), 3^{rd} Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: 3GPP TS 38.321 V16.5.0 (2021-06) 3rd Generation Partnership Project; Technical Specification Group Radio Access Network; NR; Medium Access Control (MAC) protocol specification (Release 16); 3GPP TS 38.212 V16.6.0 (2021-06) 3rd Generation Partnership Project; Technical Specification Group Radio Access Network; NR; Multiplexing and channel coding (Release 16); 3GPP TS 38.213 V16.6.0 (2021-06) 3rd Generation Partnership Project; Technical Specification Group Radio Access Network; NR; Physical layer procedures for control (Release 16); 3GPP TS 38.214 V16.6.0 (2021-06) 3rd Generation Partnership Project; Technical Specification Group Radio Access Network; NR; Physical layer procedures for data (Release 16); 3GPP TS 37.213 V17.0.0 (2021-12) 3rd Generation Partnership Project; Technical Specification Group Radio Access Network; Physical layer procedures for shared spectrum channel access (Release 17); Mohammed Hirzallah, Marwan Krunz, Balkan Kecicioglu and Belal Hamzeh, 5G New Radio Unlicensed: Challenges and Evaluation. 2020, IEEE Transactions on Cognitive Communications and Networking, Retrieved from the Internet <URL: https://arxiv.org/pdf/2012.10937.pdf > <DOI: 10.1109/TCCN.2020.3041851>; 3GPP TR 38.889 V16.0.0 (2018-12) 3rd Generation Partnership Project; Technical Specification Group Services and System Aspects; Study on NR-based access to unlicensed spectrum (Release 16); 3GPP TS 38.331 V16.5.0 (2021-06) 3rd Generation Partnership Project; Technical Specification Group Radio Access Network; NR; Radio Resource Control (RRC) protocol specification (Release 16); 3GPP TS 38.300 V16.6.0 (2021-06) 3rd Generation Partnership Project; Technical Specification Group Radio Access Network; NR; NR and NG-RAN Overall Description; Stage 2 (Release 16); RP-213678, New WID on NR sidelink evolution. The standards and documents listed above are hereby expressly incorporated by reference in their entirety.

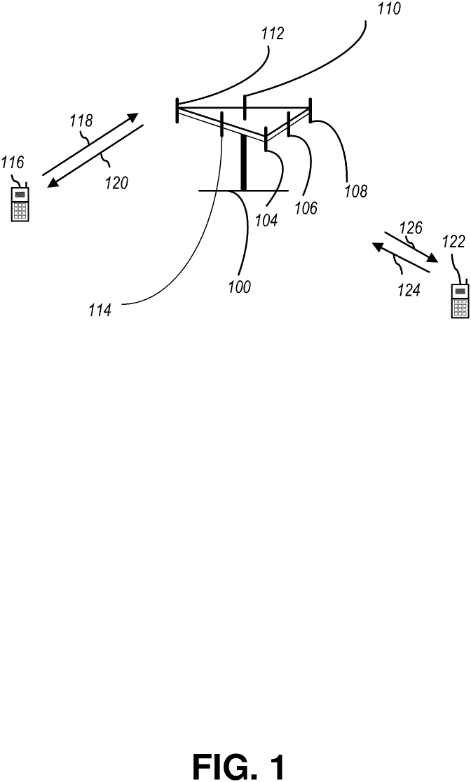

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

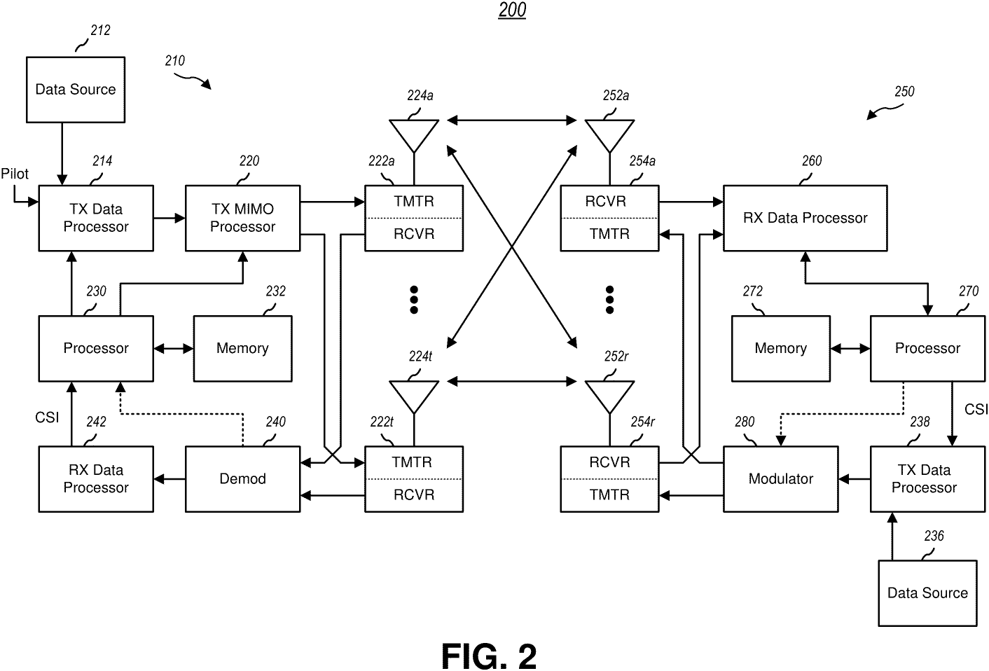

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based upon a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based upon a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the N_{R} received symbol streams from N_{R} receivers 254 based upon a particular receiver processing technique to provide N_{T} “detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

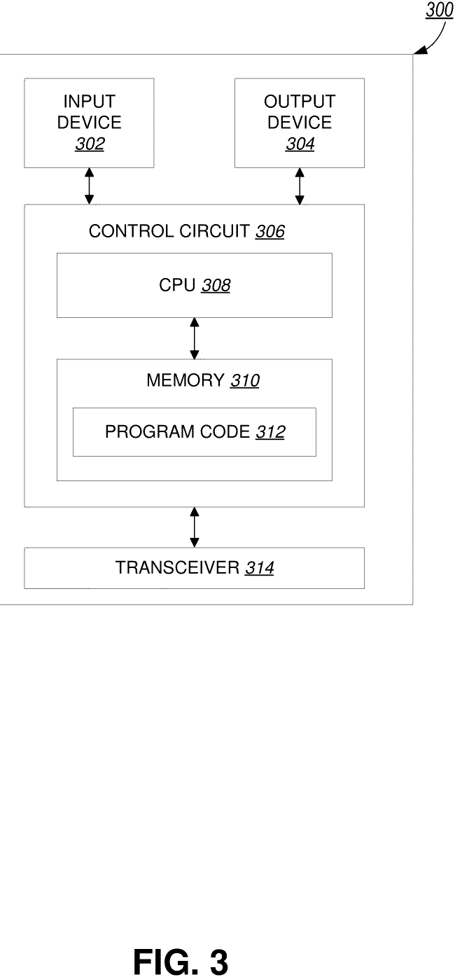

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

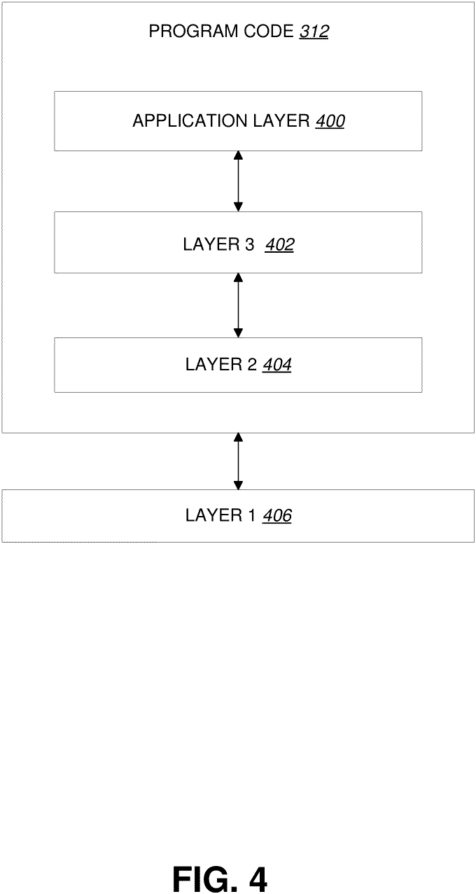

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1 portion 406. The Layer 3 portion 402 may perform radio resource control. The Layer 2 portion 404 may perform link control. The Layer 1 portion 406 may perform and/or implement physical connections.

3GPP TS 38.321 V16.5.0 discusses sidelink (SL) data reception and/or transmission (associated with NR, for example). One or more parts of 3GPP TS 38.321 V16.5.0 are quoted below:
5.22 SL-SCH Data transfer
5.22.1 SL-SCH Data transmission
5.22.1.1 SL Grant reception and SCI transmission

Sidelink grant is received dynamically on the PDCCH, configured semi-persistently by RRC or autonomously selected by the MAC entity. The MAC entity shall have a sidelink grant on an active SL BWP to determine a set of PSCCH duration(s) in which transmission of SCI occurs and a set of PSSCH duration(s) in which transmission of SL-SCH associated with the SCI occurs. ....

If the MAC entity has been configured with Sidelink resource allocation mode 2 to transmit using pool(s) of resources in a carrier as indicated in TS 38.331 [5] or TS 36.331 [21] based on sensing or random selection, the MAC entity shall for each Sidelink process: NOTE 2: The MAC entity expects that PSFCH is always configured by RRC for at least one pool of resources in case that at least a logical channel configured with sl-HARQ-FeedbackEnabled is set to enabled.
1> if the MAC entity has selected to create a selected sidelink grant corresponding to transmission(s) of a single MAC PDU, and if SL data is available in a logical channel, or a SL-CSI reporting is triggered:
   2> if SL data is available in the logical channel:
      3> if sl-HARQ-FeedbackEnabled is set to enabled for the logical channel:
         4> select any pool of resources configured with PSFCH resources among the pools of resources;
      3> else:
         4> select any pool of resources among the pools of resources; ····
   2> perform the TX resource (re-)selection check on the selected pool of resources as specified in clause 5.22.1.2;
   2> if the TX resource (re-)selection is triggered as the result of the TX resource (re-)selection check:
      3> select the number of HARQ retransmissions from the allowed numbers that are configured by RRC in sl-MaxTxTransNumPSSCH included in sl-PSSCH-TxConfigList and, if configured by RRC, overlapped in sl-MaxTxTransNumPSSCH indicated in sl-CBR-PriorityTxConfigList for the highest priority of the logical channel(s) allowed on the carrier and the CBR measured by lower layers according to clause 5.1.27 of TS 38.215 [24] if CBR measurement results are available or the corresponding sl-defaultTxConfiglndex configured by RRC if CBR measurement results are not available; ···
      3> randomly select the time and frequency resources for one transmission opportunity from the resources indicated by the physical layer as specified in clause 8.1.4 of TS 38.214 [7], according to the amount of selected frequency resources and the remaining PDB of SL data available in the logical channel(s) allowed on the carrier, and/or the latency requirement of the triggered SL-CSI reporting;
      3> if one or more HARQ retransmissions are selected:
         4> if there are available resources left in the resources indicated by the physical layer according to clause 8.1.4 of TS 38.214 [7] for more transmission opportunities:
         5> randomly select the time and frequency resources for one or more transmission opportunities from the available resources, according to the amount of selected frequency resources, the selected number of HARQ retransmissions and the remaining PDB of SL data available in the logical channel(s) allowed on the carrier, and/or the latency requirement of the triggered SL-CSI by ensuring the minimum time gap between any two selected resources in case that PSFCH is configured for this pool of resources, and that a retransmission resource can be indicated by the time resource assignment of a prior SCI according to clause 8.3.1.1 of TS 38.212 [9];
         5> consider a transmission opportunity which comes first in time as the initial transmission opportunity and other transmission opportunities as the retransmission opportunities;
         5> consider all the transmission opportunities as the selected sidelink grant;
      3> else:
         4> consider the set as the selected sidelink grant;
      3> use the selected sidelink grant to determine PSCCH duration(s) and PSSCH duration(s) according to TS 38.214 [7].
1> if a selected sidelink grant is available for retransmission(s) of a MAC PDU which has been positively acknowledged as specified in clause 5.22.1.3.3:
   2> clear the PSCCH duration(s) and PSSCH duration(s) corresponding to retransmission(s) of the MAC PDU from the selected sidelink grant.

For a selected sidelink grant, the minimum time gap between any two selected resources comprises:
a time gap between the end of the last symbol of a PSSCH transmission of the first resource and the start of the first symbol of the corresponding PSFCH reception determined by sl-MinTimeGapPSFCH and sl-PSFCH-Period for the pool of resources; and
a time required for PSFCH reception and processing plus sidelink retransmission preparation including multiplexing of necessary physical channels and any TX-RX/RX-TX switching time.

The MAC entity shall for each PSSCH duration:
1> for each sidelink grant occurring in this PSSCH duration: ···
   2> if the MAC entity has been configured with Sidelink resource allocation mode 1: ····
   2> else: ···
      3> if the MAC entity decides not to use the selected sidelink grant for the next PSSCH duration:
         4> set the resource reservation interval to 0 ms.
      3> else:
         4> set the resource reservation interval to the selected value.
   ....2> deliver the sidelink grant, the selected MCS, and the associated HARQ information to the Sidelink HARQ Entity for this PSSCH duration.

### 5.22.1.3 Sidelink HARQ Operation

### 5.22.1.3.1 Sidelink HARQ Entity

The MAC entity includes at most one Sidelink HARQ entity for transmission on SL-SCH, which maintains a number of parallel Sidelink processes.

The maximum number of transmitting Sidelink processes associated with the Sidelink HARQ Entity is 16. A sidelink process may be configured for transmissions of multiple MAC PDUs. For transmissions of multiple MAC PDUs with Sidelink resource allocation mode 2, the maximum number of transmitting Sidelink processes associated with the Sidelink HARQ Entity is 4.

A delivered sidelink grant and its associated Sidelink transmission information are associated with a Sidelink process. Each Sidelink process supports one TB.

For each sidelink grant, the Sidelink HARQ Entity shall:
1> if the MAC entity determines that the sidelink grant is used for initial transmission as specified in clause 5.22.1.1; or
1> if the sidelink grant is a configured sidelink grant and no MAC PDU has been obtained in a sl-PeriodCG of the configured sidelink grant:
   2> (re-)associate a Sidelink process to this grant, and for the associated Sidelink process:
      NOTE 1A: The Sidelink HARQ Entity will associate the selected sidelink grant to the Sidelink process determined by the MAC entity.
         3> obtain the MAC PDU to transmit from the Multiplexing and assembly entity, if any;
         3> if a MAC PDU to transmit has been obtained:
         4> if a HARQ Process ID has been set for the sidelink grant:
         5> (re-)associate the HARQ Process ID corresponding to the sidelink grant to the Sidelink process;
      NOTE 1a: There is one-to-one mapping between a HARQ Process ID and a Sidelink process in the MAC entity configured with Sidelink resource allocation mode 1.
         4> determines Sidelink transmission information of the TB for the source and destination pair of the MAC PDU as follows:
         5> set the Source Layer-1 ID to the 8 LSB of the Source Layer-2 ID of the MAC PDU;
         5> set the Destination Layer-1 ID to the 16 LSB of the Destination Layer-2 ID of the MAC PDU;
         5> (re-)associate the Sidelink process to a Sidelink process ID;
      NOTE 1b: How UE determine Sidelink process ID in SCI is left to UE implementation for NR sidelink.
         5> consider the NDI to have been toggled compared to the value of the previous transmission corresponding to the Sidelink identification information and the Sidelink process ID of the MAC PDU and set the NDI to the toggled value;
         5> set the cast type indicator to one of broadcast, groupcast and unicast as indicated by upper layers;
         5> if HARQ feedback has been enabled for the MAC PDU according to clause 5.22.1.4.2;
         6> set the HARQ feedback enabled/disabled indicator to enabled.
         5> else:
         6> set the HARQ feedback enabled/disabled indicator to disabled.
         5> set the priority to the value of the highest priority of the logical channel(s), if any, and a MAC CE, if included, in the MAC PDU;
         5> if HARQ feedback is enabled for groupcast:
         6> if both a group size and a member ID are provided by upper layers and the group size is not greater than the number of candidate PSFCH resources associated with this sidelink grant:
         7> select either positive-negative acknowledgement or negative-only acknowledgement.
         6> else:
         7> select negative-only acknowledgement. ····
         4> deliver the MAC PDU, the sidelink grant and the Sidelink transmission information of the TB to the associated Sidelink process;
         4> instruct the associated Sidelink process to trigger a new transmission.
         3> else:
         4> flush the HARQ buffer of the associated Sidelink process.
1> else (i.e. retransmission):
   2> if the HARQ Process ID corresponding to the sidelink grant received on PDCCH, the configured sidelink grant or the selected sidelink grant is associated to a Sidelink process of which HARQ buffer is empty; or
   2> if the HARQ Process ID corresponding to the sidelink grant received on PDCCH is not associated to any Sidelink process:
      3> ignore the sidelink grant.
   2> else:
      3> identify the Sidelink process associated with this grant, and for the associated Sidelink process:
         4> deliver the sidelink grant of the MAC PDU to the associated Sidelink process;
         4> instruct the associated Sidelink process to trigger a retransmission.

### 5.22.1.3.1A Sidelink Process

The Sidelink process is associated with a HARQ buffer.

New transmissions and retransmissions are performed on the resource indicated in the sidelink grant as specified in clause 5.22.1.1 and with the MCS selected as specified in clause 8.1.3.1 of TS 38.214 [7] and clause 5.22.1.1.

If the Sidelink HARQ Entity requests a new transmission, the Sidelink process shall:
1> store the MAC PDU in the associated HARQ buffer;
1> store the sidelink grant received from the Sidelink HARQ Entity;
1> generate a transmission as described below.

If the Sidelink HARQ Entity requests a retransmission, the Sidelink process shall:
1> store the sidelink grant received from the Sidelink HARQ Entity;
1> generate a transmission as described below.

To generate a transmission, the Sidelink process shall:
1> if there is no uplink transmission; or
1> if the MAC entity is able to simultaneously perform uplink transmission(s) and sidelink transmission at the time of the transmission; or
1> if the other MAC entity and the MAC entity are able to simultaneously perform uplink transmission(s) and sidelink transmission at the time of the transmission respectively; or
1> if there is a MAC PDU to be transmitted for this duration in uplink, except a MAC PDU obtained from the Msg3 buffer, the MSGA buffer, or prioritized as specified in clause 5.4.2.2, and the sidelink transmission is prioritized over uplink transmission:
   2> instruct the physical layer to transmit SCI according to the stored sidelink grant with the associated Sidelink transmission information;
   2> instruct the physical layer to generate a transmission according to the stored sidelink grant;
   2> if HARQ feedback has been enabled the MAC PDU according to clause 5.22.1.4.2:
      3> instruct the physical layer to monitor PSFCH for the transmission and perform PSFCH reception as specified in clause 5.22.1.3.2.

### 5.22.1.3.2 PSFCH Reception

The MAC entity shall for each PSSCH transmission:
1> if an acknowledgement corresponding to the PSSCH transmission in clause 5.22.1.3.1a is obtained from the physical layer:
   2> deliver the acknowledgement to the corresponding Sidelink HARQ entity for the Sidelink process;
1> else:
   2> deliver a negative acknowledgement to the corresponding Sidelink HARQ entity for the Sidelink process;
1> if the PSSCH transmission occurs for a pair of Source Layer-2 ID and Destination Layer-2 ID corresponding to a PC5-RRC connection which has been established by upper layers:
   2> perform the HARQ-Based Sidelink RLF Detection procedure as specified in clause 5.22.1.3.3.

### 5.22.1.4 Multiplexing and Assembly

For PDU(s) associated with one SCI, MAC shall consider only logical channels with the same Source Layer-2 ID-Destination Layer-2 ID pair for one of unicast, groupcast and broadcast which is associated with the pair. Multiple transmissions for different Sidelink processes are allowed to be independently performed in different PSSCH durations.

### 5.22.1.4.1.2 Selection of Logical Channels

The MAC entity shall for each SCI corresponding to a new transmission:
1> select a Destination associated to one of unicast, groupcast and broadcast, having at least one of the MAC CE and the logical channel with the highest priority, among the logical channels that satisfy all the following conditions and MAC CE(s), if any, for the SL grant associated to the SCI:
   2> SL data is available for transmission; and
   2> SBj > 0, in case there is any logical channel having SBj > 0; and
   2> sl-configuredGrantType1Allowed, if configured, is set to true in case the SL grant is a Configured Grant Type 1; and
   2> sl-AllowedCG-List, if configured, includes the configured grant index associated to the SL grant; and
   2> sl-HARQ-FeedbackEnabled is set to disabled, if PSFCH is not configured for the SL grant associated to the SCI.
1> select the logical channels satisfying all the following conditions among the logical channels belonging to the selected Destination:
   2> SL data is available for transmission; and
   2> sl-configuredGrantType1Allowed, if configured, is set to true in case the SL grant is a Configured Grant Type 1; and.
   2> sl-AllowedCG-List, if configured, includes the configured grant index associated to the SL grant; and
      3> if PSFCH is configured for the sidelink grant associated to the SCI:
         4> sl-HARQ-FeedbackEnabled is set to enabled, if sl-HARQ-FeedbackEnabled is set to enabled for the highest priority logical channel satisfying the above conditions; or
         4> sl-HARQ-FeedbackEnabled is set to disabled, if sl-HARQ-FeedbackEnabled is set to disabled for the highest priority logical channel satisfying the above conditions.
      3> else:
         4> sl-HARQ-FeedbackEnabled is set to disabled.

5.22.1.4.2 Multiplexing of MAC Control Elements and MAC SDUs

The MAC entity shall multiplex a MAC CE and MAC SDUs in a MAC PDU according to clauses 5.22.1.4.1 and 6.1.6.

### 5.22.2 SL-SCH Data Reception

### 5.22.2.1 SCI Reception

SCI indicate if there is a transmission on SL-SCH and provide the relevant HARQ information. A SCI consists of two parts: the 1^{st} stage SCI on PSCCH and the 2^{nd} stage SCI on PSSCH as specified in clause 8.1 of TS 38.214 [7].

The MAC entity shall:
1> for each PSCCH duration during which the MAC entity monitors PSCCH:
   2> if a 1^{st} stage SCI has been received on the PSCCH:
      3> determine the set of PSSCH durations in which reception of a 2^{nd} stage SCI and the transport block occur using the received part of the SCI;
      3> if the 2^{nd} stage SCI for this PSSCH duration has been received on the PSSCH:
         4> store the SCI as a valid SCI for the PSSCH durations corresponding to transmission(s) of the transport block and the associated HARQ information and QoS information;
1> for each PSSCH duration for which the MAC entity has a valid SCI:
   2> deliver the SCI and the associated Sidelink transmission information to the Sidelink HARQ Entity.

### 5.22.2.2 Sidelink HARQ Operation

### 5.22.2.2.1 Sidelink HARQ Entity

There is at most one Sidelink HARQ Entity at the MAC entity for reception of the SL-SCH, which maintains a number of parallel Sidelink processes.

Each Sidelink process is associated with SCI in which the MAC entity is interested. This interest is determined by the Sidelink identification information of the SCI. The Sidelink HARQ Entity directs Sidelink transmission information and associated TBs received on the SL-SCH to the corresponding Sidelink processes.

The number of Receiving Sidelink processes associated with the Sidelink HARQ Entity is defined in TS 38.306 [5].

For each PSSCH duration, the Sidelink HARQ Entity shall:
1> for each SCI valid for this PSSCH duration:
   2> if the NDI has been toggled compared to the value of the previous received transmission corresponding to the Sidelink identification information and the Sidelink process ID of the SCI or this is the very first received transmission for the pair of the Sidelink identification information and the Sidelink process ID of the SCI:
      3> if there is a Sidelink process associated with the Sidelink identification information and the Sidelink process ID of the SCI:
         4> consider the Sidelink process as unoccupied;
         4> flush the soft buffer for the Sidelink process.
      3> allocate the TB received from the physical layer and the associated Sidelink identification information and Sidelink process ID to an unoccupied Sidelink process;
      3> associate the Sidelink process with the Sidelink identification information and the Sidelink process ID of this SCI and consider this transmission to be a new transmission.
1> for each Sidelink process:
   2> if the NDI has not been toggled compared to the value of the previous received transmission corresponding to the Sidelink identification information and the Sidelink process ID of the SCI for the Sidelink process according to its associated SCI:
      3> allocate the TB received from the physical layer to the Sidelink process and consider this transmission to be a retransmission.

NOTE 2: A single sidelink process can only be (re-)associated to a single combination of Sidelink identification information and Sidelink process ID at a time and a single combination of Sidelink identification information and Sidelink process ID can only be (re-)associated to a single sidelink process at a time.

### 5.22.2.2.2 Sidelink Process

For each PSSCH duration where a transmission takes place for the Sidelink process, one TB and the associated HARQ information is received from the Sidelink HARQ Entity.

For each received TB and associated Sidelink transmission information, the Sidelink process shall:
1> if this is a new transmission:
   2> attempt to decode the received data.
1> else if this is a retransmission:
   2> if the data for this TB has not yet been successfully decoded:
      3> instruct the physical layer to combine the received data with the data currently in the soft buffer for this TB and attempt to decode the combined data.
1> if the data which the MAC entity attempted to decode was successfully decoded for this TB; or
1> if the data for this TB was successfully decoded before:
   2> if this is the first successful decoding of the data for this TB:
      3> if this TB is associated to unicast, the DST field of the decoded MAC PDU subheader is equal to the 8 MSB of any of the Source Layer-2 ID(s) of the UE for which the 16 LSB are equal to the Destination ID in the corresponding SCI, and the SRC field of the decoded MAC PDU subheader is equal to the 16 MSB of any of the Destination Layer-2 ID(s) of the UE for which the 8 LSB are equal to the Source ID in the corresponding SCI; or
      3> if this TB is associated to groupcast or broadcast and the DST field of the decoded MAC PDU subheader is equal to the 8 MSB of any of the Destination Layer-2 ID(s) of the UE for which the 16 LSB are equal to the Destination ID in the corresponding SCI:
         4> deliver the decoded MAC PDU to the disassembly and demultiplexing entity;
   2> consider the Sidelink process as unoccupied.
1> else:
   2> instruct the physical layer to replace the data in the soft buffer for this TB with the data which the MAC entity attempted to decode.
1> if HARQ feedback is enabled by the SCI: ····
   2> if negative-positive acknowledgement or unicast is indicated by the SCI according to clause 8.4.1 of TS 38.212 [9]:
      3> if the data which the MAC entity attempted to decode was successfully decoded for this TB or the data for this TB was successfully decoded before:
         4> instruct the physical layer to generate a positive acknowledgement of the data in this TB.
      3> else:
         4> instruct the physical layer to generate a negative acknowledgement of the data in this TB.

### 5.22.2.3 Disassembly and Demultiplexing

The MAC entity shall disassemble and demultiplex a MAC PDU as defined in clause 6.1.6.

3GPP TS 38.212 V16.6.0 discusses Downlink Control Information (DCI) format, Configured Grant Uplink Control Information (CG-UCI), and Sidelink Control Information (SCI) format (associated with NR, for example). One or more parts of 3GPP TS 38.212 V16.6.0 are quoted below:

### 8.3.1.1 SCI Format 1-A

SCI format 1-A is used for the scheduling of PSSCH and 2^{nd}-stage-SCI on PSSCH

The following information is transmitted by means of the SCI format 1-A:
Priority 3 bits as specified in clause 5.4.3.3 of [12, TS 23.287] and clause 5.22.1.3.1 of [8, TS 38.321].
Frequency resource assignment
$$\left⌈{log}_{2} \left(\frac{{N}_{\text{subChannel}}^{\text{SL}} \left({N}_{\text{subChannel}}^{\text{SL}} + 1\right)}{2}\right)\right⌉$$
bits when the value of the higher layer parameter sl-MaxNumPerReserve is configured to 2; otherwise
$$\left⌈{log}_{2} \left(\frac{{N}_{\text{subChannel}}^{\text{SL}} \left({N}_{\text{subChannel}}^{\text{SL}} + 1\right) \left(2 {N}_{\text{subChannel}}^{\text{SL}} + 1\right)}{6}\right)\right⌉$$
bits when the value of the higher layer parameter sl-MaxNumPerReserve is configured to 3, as defined in clause 8.1.5 of [6, TS 38.214].
Time resource assignment 5 bits when the value of the higher layer parameter sl-MaxNumPerReserve is configured to 2; otherwise 9 bits when the value of the higher layer parameter sl-MaxNumPerReserve is configured to 3, as defined in clause 8.1.5 of [6, TS 38.214].
Resource reservation period -^{┌}log₂ N_{rsv_period}^{┐} bits as defined in clause 16.4 of [5, TS 38.213], where N_{rsv_period} is the number of entries in the higher layer parameter sl-ResourceReservePeriodList, if higher layer parameter sl-MultiReserveResource is configured; 0 bit otherwise.
DMRS pattern ^{┌}log₂ Nₚₐₜₜₑᵣₙ^{┐} bits as defined in clause 8.4.1.1.2 of [4, TS 38.211], where Nₚₐₜₜₑᵣₙ is the number of DMRS patterns configured by higher layer parameter sl-PSSCH-DMRS-TimePatternList.
2^{nd}-stage SCI format - 2 bits as defined in Table 8.3.1.1-1.
Beta_offset indicator 2 bits as provided by higher layer parameter sl-BetaOffsets2ndSCI and Table 8.3.1.1-2.
Number of DMRS port 1 bit as defined in Table 8.3.1.1-3.
Modulation and coding scheme 5 bits as defined in clause 8.1.3 of [6, TS 38.214].
Additional MCS table indicator as defined in clause 8.1.3.1 of [6, TS 38.214]: 1 bit if one MCS table is configured by higher layer parameter sl-Additional-MCS-Table; 2 bits if two MCS tables are configured by higher layer parameter sl- Additional-MCS-Table; 0 bit otherwise.
PSFCH overhead indication 1 bit as defined clause 8.1.3.2 of [6, TS 38.214] if higher layer parameter sl-PSFCH-Period = 2 or 4; 0 bit otherwise.
Reserved a number of bits as determined by higher layer parameter sl-NumReservedBits, with value set to zero.

TABLE 8.3.1.1-1

2^{nd}-stage SCI formats

| Value of 2nd-stage SCI format field | 2nd-stage SCI format |
|---|---|
| 00 | SCI format 2-A |
| 01 | SCI format 2-B |
| 10 | Reserved |
| 11 | Reserved |

### 8.4.1.1 SCI Format 2-A

SCI format 2-A is used for the decoding of PSSCH, with HARQ operation when HARQ-ACK information includes ACK or NACK, when HARQ-ACK information includes only NACK, or when there is no feedback of HARQ-ACK information.

The following information is transmitted by means of the SCI format 2-A:
HARQ process number 4 bits.
New data indicator 1 bit.
Redundancy version 2 bits as defined in Table 7.3.1.1.1-2.
Source ID 8 bits as defined in clause 8.1 of [6, TS 38.214].
Destination ID 16 bits as defined in clause 8.1 of [6, TS 38.214].
HARQ feedback enabled/disabled indicator 1 bit as defined in clause 16.3 of [5, TS 38.213].
Cast type indicator 2 bits as defined in Table 8.4.1.1-1 and in clause 8.1 of [6, TS 38.214].
CSI request 1 bit as defined in clause 8.2.1 of [6, TS 38.214] and in clause 8.1 of [6, TS 38.214].

TABLE 8.4.1.1-1:

Cast type indicator

| Value of Cast type indicator | Cast type |
|---|---|
| 00 | Broadcast |
| 01 | Groupcast when HARQ-ACK information includes ACK or NACK |
| 10 | Unicast |
| 11 | Groupcast when HARQ-ACK information includes only NACK |

One or more parts of 3GPP TS 38.213 V16.6.0 are quoted below:

### 16 UE PROCEDURES FOR SIDELINK

···

### 16.3 UE Procedure for Reporting HARQ-ACK on Sidelink

A UE can be indicated by an SCI format scheduling a PSSCH reception, in one or more sub-channels from a number of

$${N}_{\text{subch}}^{\text{PSSCH}}$$

sub-channels, to transmit a PSFCH with HARQ-ACK information in response to the PSSCH reception. The UE provides HARQ-ACK information that includes ACK or NACK, or only NACK.

A UE can be provided, by sl-PSFCH-Period, a number of slots in a resource pool for a period of PSFCH transmission occasion resources. If the number is zero, PSFCH transmissions from the UE in the resource pool are disabled.

A UE expects that a slot

$${{t}^{′}}_{k}^{S L} \left(0 \leq k < {{T}^{′}}_{m a x}\right)$$

has a PSFCH transmission occasion resource if k mod

$${N}_{\text{PSSCH}}^{\text{PSFCH}} = 0 , \text{where} {{t}^{′}}_{k}^{S L}$$

is defined in [6, TS 38.214], and T′ₘₐₓ is a number of slots that belong to the resource pool within 10240 msec according to [6, TS 38.214], and

$${N}_{\text{PSSCH}}^{\text{PSFCH}}$$

is provided by sl-PSFCH-Period.

A UE may be indicated by higher layers to not transmit a PSFCH in response to a PSSCH reception [11, TS 38.321].

If a UE receives a PSSCH in a resource pool and the HARQ feedback enabled/disabled indicator field in an associated SCI format 2-A or a SCI format 2-B has value 1 [5, TS 38.212], the UE provides the HARQ-ACK information in a PSFCH transmission in the resource pool. The UE transmits the PSFCH in a first slot that includes PSFCH resources and is at least a number of slots, provided by sl-MinTimeGapPSFCH, of the resource pool after a last slot of the PSSCH reception.

A UE is provided by sl-PSFCH-RB-Set a set of

$${M}_{\text{PRB,} \text{set}}^{\text{PSFCH}}$$

PRBs in a resource pool for PSFCH transmission in a PRB of the resource pool. For a number of N_{subch} sub-channels for the resource pool, provided by sl-NumSubchannel, and a number of PSSCH slots associated with a PSFCH slot that is less than or equal to

$${N}_{\text{PSSCH}}^{\text{PSFCH}} , \text{the} \text{UE} \text{allocates} \text{the} \left[\begin{matrix}\left(i + j ⋅ {N}_{\text{PSSCH}}^{\text{PSFCH}}\right) ⋅ {M}_{\text{subch,} \text{slot}}^{\text{PSFCH}} , \\ \left(i + 1 + j ⋅ {N}_{\text{PSSCH}}^{\text{PSFCH}}\right) ⋅ {M}_{\text{subch,} \text{slot}}^{\text{PSFCH}} - 1\end{matrix}\right]$$

PRBs from the

$${M}_{\text{PRB,} \text{set}}^{\text{PSFCH}}$$

PRBs to slot i among the PSSCH slots associated with the PSFCH slot and sub-channel and the allocation starts in an ascending order of i and continues in an ascending order of j. The UE expects that

$${M}_{\text{PRB,} \text{set}}^{\text{PSFCH}}$$

is a multiple of

$${N}_{\text{subch}} ⋅ {N}_{\text{PSSCH}}^{\text{PSFCH}} .$$

The second OFDM symbol l′of PSFCH transmission in a slot is defined as l′= startSLsymbols+ lengthSLsymbols - 2.

### 16.3.1 UE Procedure for Receiving HARQ-ACK on Sidelink

A UE that transmitted a PSSCH scheduled by a SCI format 2-A or a SCI format 2-B that indicates HARQ feedback enabled, attempts to receive associated PSFCHs according to PSFCH resources determined as described in clause 16.3. The UE determines an ACK or a NACK value for HARQ-ACK information provided in each PSFCH resource as described in [10, TS 38.133]. The UE does not determine both an ACK value and a NACK value at a same time for a PSFCH resource.

For each PSFCH reception occasion, from a number of PSFCH reception occasions, the UE generates HARQ-ACK information to report to higher layers. For generating the HARQ-ACK information, the UE can be indicated by a SCI format to perform one of the following
if the UE receives a PSFCH associated with a SCI format 2-A with Cast type indicator field value of “10”
report to higher layers HARQ-ACK information with same value as a value of HARQ-ACK information that the UE determines from the PSFCH reception
if the UE receives a PSFCH associated with a SCI format 2-A with Cast type indicator field value of “01”
report an ACK value to higher layers if the UE determines an ACK value from at least one PSFCH reception occasion from the number of PSFCH reception occasions in PSFCH resources corresponding to every identity M_{ID} of UEs that the UE expects to receive corresponding PSSCHs as described in clause 16.3; otherwise, report a NACK value to higher layers
if the UE receives a PSFCH associated with a SCI format 2-B or a SCI format 2-A with Cast type indicator field value of “11”
report to higher layers an ACK value if the UE determines absence of PSFCH reception for the PSFCH reception occasion; otherwise, report a NACK value to higher layers

One or more parts of 3GPP TS 38.214 V16.6.0 (associated with NR, for example) are quoted below:

### 8 PHYSICAL SIDELINK SHARED CHANNEL RELATED PROCEDURES

A UE can be configured by higher layers with one or more sidelink resource pools. A sidelink resource pool can be for transmission of PSSCH, as described in Clause 8.1, or for reception of PSSCH, as described in Clause 8.3 and can be associated with either sidelink resource allocation mode 1 or sidelink resource allocation mode 2.

In the frequency domain, a sidelink resource pool consists of sl-NumSubchannel contiguous sub-channels. A sub-channel consists of sl-SubchannelSize contiguous PRBs, where sl-NumSubchannel and sl-SubchannelSize are higher layer parameters.

The set of slots that may belong to a sidelink resource pool is denoted by

$$\left({t}_{0}^{\text{SL}} , {t}_{1}^{\text{SL}} , ⋯ , {t}_{{T}_{m a x} - 1}^{\text{SL}}\right)$$

where

$$\text{-} 0 \leq {t}_{i}^{S L} < 10240 \times \text{} {2}^{μ} , 0 \leq i < {T}_{m a x} ,$$

the slot index is relative to slot#0 of the radio frame corresponding to SFN 0 of the serving cell or DFN 0,
the set includes all the slots except the following slots,
   ...
The slots in the set are arranged in increasing order of slot index.

The UE determines the set of slots assigned to a sidelink resource pool as follows:
a bitmap (b₀, b₁, ..., b_{Lbitmap-1}) associated with the resource pool is used where L_{bitmap} the length of the bitmap is configured by higher layers.
a slot
$${t}_{k}^{\text{SL}} \left(0 \leq k < 10240 \times {2}^{μ} - {N}_{{S}_{S S B}} - {N}_{n o n S L} - \text{} {N}_{r e s e r v e d}\right)$$
belongs to the set if b_{k′} = 1 where k′ = k mod L_{bitmap}.
The slots in the set are re-indexed such that the subscripts i of the remaining slots
$${{t}^{′}}_{i}^{S L}$$
are successive {0, 1, ..., T′ₘₐₓ - 1} where T′ₘₐₓ is the number of the slots remaining in the set.

### 8.1.4 UE Procedure for Determining the Subset of Resources to Be Reported to Higher Layers in PSSCH Resource Selection in Sidelink Resource Allocation Mode 2

In resource allocation mode 2, the higher layer can request the UE to determine a subset of resources from which the higher layer will select resources for PSSCH/PSCCH transmission. To trigger this procedure, in slot n, the higher layer provides the following parameters for this PSSCH/PSCCH transmission:
the resource pool from which the resources are to be reported;
L1 priority, prio_{TX};
the remaining packet delay budget;
the number of sub-channels to be used for the PSSCH/PSCCH transmission in a slot, L_{subCH};
optionally, the resource reservation interval, P_{rsvp_TX}, in units of msec.

The following higher layer parameters affect this procedure:
sl-SelectionWindowList: internal parameter T₂ₘᵢₙ is set to the corresponding value from higher layer parameter sl-SelectionWindowList for the given value of prio_{TX}.
sl-Thres-RSRP-List: this higher layer parameter provides an RSRP threshold for each combination (pᵢ, pⱼ), where pᵢ is the value of the priority field in a received SCI format 1-A and pⱼ is the priority of the transmission of the UE selecting resources; for a given invocation of this procedure, pⱼ = prio_{TX}.
sl-RS-ForSensing selects if the UE uses the PSSCH-RSRP or PSCCH-RSRP measurement, as defined in clause 8.4.2.1.
sl-ResourceReservePeriodList
sl-SensingWindow: internal parameter T₀ is defined as the number of slots corresponding to sl-SensingWindow msec
sl-TxPercentageList: internal parameter X for a given prio_{TX} is defined as sl-TxPercentageList (priory) converted from percentage to ratio

The resource reservation interval, P_{rsvp_TX}, if provided, is converted from units of msec to units of logical slots, resulting in

$${{P}^{′}}_{\text{rsvp\_TX}}$$

according to clause 8.1.7.

Notation:

$$\left({{t}^{′}}_{0}^{S L} , {{t}^{′}}_{1}^{S L} , {{t}^{′}}_{2}^{S L} , \text{} …\right)$$
denotes the set of slots which belongs to the sidelink resource pool and is defined in Clause 8.

The following steps are used:

1) A candidate single-slot resource for transmission R_{x,y} is defined as a set of L_{subCH} contiguous sub-channels with sub-channel x+j in slot

$${{t}^{′}}_{y}^{S L}$$

where j = 0,..., L_{subCH} - 1. The UE shall assume that any set of L_{subCH} contiguous sub-channels included in the corresponding resource pool within the time interval [n + T₁,n + T₂] correspond to one candidate single-slot resource, where
selection of T₁ is up to UE implementation under 0 ≤ T₁ ≤
$${T}_{p r o c , 1}^{S L} , \text{where} {T}_{p r o c , 1}^{S L}$$
is defined in slots in Table 8.1.4-2 where µ_{SL} is the SCS configuration of the SL BWP;
if T₂ₘᵢₙ is shorter than the remaining packet delay budget (in slots) then T₂ is up to UE implementation subject to T₂ₘᵢₙ ≤ T₂ ≤ remaining packet delay budget (in slots); otherwise T₂ is set to the remaining packet delay budget (in slots).

The total number of candidate single-slot resources is denoted by Mₜₒₜₐₗ.

2) The sensing window is defined by the range of slots [n - T₀, n-

$$- \left({T}_{p r o c , 0}^{S L}\right)$$

where T₀ is defined above and

$${T}_{p r o c , 0}^{S L}$$

is defined in slots in Table 8.1.4-1 where µ_{SL} is the SCS configuration of the SL BWP. The UE shall monitor slots which belongs to a sidelink resource pool within the sensing window except for those in which its own transmissions occur. The UE shall perform the behaviour in the following steps based on PSCCH decoded and RSRP measured in these slots.

3) The internal parameter Th(pᵢ,pⱼ) is set to the corresponding value of RSRP threshold indicated by the i-th field in sl-Thres-RSRP-List, where i = pᵢ + (pⱼ - 1) ∗ 8.

4) The set S_{A} is initialized to the set of all the candidate single-slot resources.

5) The UE shall exclude any candidate single-slot resource R_{x,y} from the set S_{A} if it meets all the following conditions:
the UE has not monitored slot
$${{t}^{′}}_{m}^{S L}$$
in Step 2.
for any periodicity value allowed by the higher layer parameter sl-ResourceReservePeriodList and a hypothetical SCI format 1-A received in slot
$${{t}^{′}}_{m}^{S L}$$
with ‘Resource reservation period’ field set to that periodicity value and indicating all subchannels of the resource pool in this slot, condition c in step 6 would be met.

5a)If the number of candidate single-slot resources R_{x,y} remaining in the set S_{A} is smaller than X · Mₜₒₜₐₗ, the set S_{A} is initialized to the set of all the candidate single-slot resources as in step 4.

6) The UE shall exclude any candidate single-slot resource R_{x,y} from the set S_{A} if it meets all the following conditions:
a) the UE receives an SCI format 1-A in slot
$${{t}^{′}}_{m}^{S L} ,$$
and ‘Resource reservation period’ field, if present, and ‘Priority’ field in the received SCI format 1-A indicate the values P_{rsvp_RX} and prio_{RX}, respectively according to Clause 16.4 in [6, TS 38.213];
b) the RSRP measurement performed, according to clause 8.4.2.1 for the received SCI format 1-A, is higher than Th(prio_{RX},prio_{TX});
c) the SCI format received in slot
$${{t}^{′}}_{m}^{S L}$$
or the same SCI format which, if and only if the ‘Resource reservation period’ field is present in the received SCI format 1-A, is assumed to be received in slot(s)
$${{t}^{′}}_{m + q \times {{P}^{′}}_{r s v p \_ R X}}^{S L}$$
determines according to clause 8.1.5 the set of resource blocks and slots which overlaps with
$${R}_{x , y + j \times {{P}^{′}}_{r s v p \_ T X}}$$
for q=1, 2, ..., Q and j=0, 1, ..., Cᵣₑₛₑₗ - 1. Here,
$${{P}^{′}}_{r s v p \_ R X}$$
is P_{rsvp_RX} converted to units of logical slots according to clause
$$8.1.7 , Q = \left⌈\frac{{T}_{s c a l}}{{P}_{r s v p \_ R X}}\right⌉$$
P_{rsvp_RX} < T_{scal} and
$${n}^{′} - m \leq {{P}^{′}}_{r s v p \_ R X} ,$$
where
$${{t}^{′}}_{{n}^{′}}^{S L} = n$$
if slot n belongs to the set
$$\left({{t}^{′}}_{0}^{S L} , {{t}^{′}}_{1}^{S L} , … , {{t}^{′}}_{{{T}^{′}}_{m a x} - 1}^{S L}\right) , \text{otherwise} \text{slot} {{t}^{′}}_{{n}^{′}}^{S L}$$
is the first slot after slot n belonging to the set
$$\left({{t}^{′}}_{0}^{S L} , {{t}^{′}}_{1}^{S L} , … , {{t}^{′}}_{{{T}^{′}}_{m a x} - 1}^{S L}\right) ; \text{otherwise} \text{Q} \text{} = \text{} 1.$$
T_{scαl} is set to selection window size T₂ converted to units of msec.

7) If the number of candidate single-slot resources remaining in the set S_{A} is smaller than X · Mₜₒₜₐₗ, then Th(pᵢ,pⱼ) is increased by 3 dB for each priority value Th(pᵢ,pⱼ) and the procedure continues with step 4.

The UE shall report set S_{A} to higher layers.

TABLE 8.1.4-1

${T}_{p r o c , 0}^{S L}$ depending on sub-carrier spacing

| µ_{SL} | ${T}_{p r o c , 0}^{S L} \left[\text{slots}\right]$ [slots] |
|---|---|
| 0 | 1 |
| 1 | 1 |
| 2 | 2 |
| 3 | 4 |

TABLE 8.1.4-2

${T}_{p r o c , 1}^{S L}$ depending on sub-carrier spacing

| µ_{SL} | ${T}_{p r o c , 1}^{S L} \left[\text{slots}\right]$ |
|---|---|
| 0 | 3 |
| 1 | 5 |
| 2 | 9 |
| 3 | 17 |

3GPP TS 37.213 V17.0.0 provides information associated with one or more definitions, one or more abbreviations, channel access procedure, and/or protocol related to channel access procedure in unlicensed spectrum (and/or share spectrum). One or more parts of 3GPP TS 37.213 V17.0.0 are quoted below:

### 4 CHANNEL ACCESS PROCEDURE

### 4.0 General

Unless otherwise noted, the definitions below are applicable for the following terminologies used in this specification:
A channel refers to a carrier or a part of a carrier consisting of a contiguous set of resource blocks (RBs) on which a channel access procedure is performed in shared spectrum.
A channel access procedure is a procedure based on sensing that evaluates the availability of a channel for performing transmissions. The basic unit for sensing is a sensing slot with a duration Tₛₗ = 9 us. The sensing slot duration Tₛₗ is considered to be idle if an eNB/gNB or a UE senses the channel during the sensing slot duration, and determines that the detected power for at least 4 us within the sensing slot duration is less than energy detection threshold X_{Thresh}. Otherwise, the sensing slot duration Tₛₗ is considered to be busy.
A channel occupancy refers to transmission(s) on channel(s) by eNB/gNB/UE(s) after performing the corresponding channel access procedures in this clause.
A Channel Occupancy Time refers to the total time for which eNB/gNB/UE and any eNB/gNB/UE(s) sharing the channel occupancy perform transmission(s) on a channel after an eNB/gNB/UE performs the corresponding channel access procedures described in this clause. For determining a Channel Occupancy Time, if a transmission gap is less than or equal to 25 us, the gap duration is counted in the channel occupancy time. A channel occupancy time can be shared for transmission between an eNB/gNB and the corresponding UE(s).
A DL transmission burst is defined as a set of transmissions from an eNB/gNB without any gaps greater than 16 us. Transmissions from an eNB/gNB separated by a gap of more than 16 us are considered as separate DL transmission bursts. An eNB/gNB can transmit transmission(s) after a gap within a DL transmission burst without sensing the corresponding channel(s) for availability.
A UL transmission burst is defined as a set of transmissions from a UE without any gaps greater than 16 us. Transmissions from a UE separated by a gap of more than 16 us are considered as separate UL transmission bursts. A UE can transmit transmission(s) after a gap within a UL transmission burst without sensing the corresponding channel(s) for availability.

### 4.1 Downlink Channel Access Procedures

A gNB performs channel access procedures in this clause unless the higher layer parameter ChannelAccessMode-r16 is provided and ChannelAccessMode-r16 =‘ semistatic’.

### 4.1.1 Type 1 DL Channel Access Procedures

This clause describes channel access procedures to be performed by an eNB/gNB where the time duration spanned by the sensing slots that are sensed to be idle before a downlink transmission(s) is random. The clause is applicable to the following transmissions:
Transmission(s) initiated by an eNB including PDSCH/PDCCH/EPDCCH, or
Any transmission(s) initiated by a gNB.

The eNB/gNB may transmit a transmission after first sensing the channel to be idle during the sensing slot durations of a defer duration T_{d} and after the counter N is zero in step 4. The counter N is adjusted by sensing the channel for additional sensing slot duration(s) according to the steps below:
1) set N = Nᵢₙᵢₜ, where Nᵢₙᵢₜ is a random number uniformly distributed between 0 and CWₚ, and go to step 4;
2) if N > 0 and the eNB/gNB chooses to decrement the counter, set N = N - 1;
3) sense the channel for an additional sensing slot duration, and if the additional sensing slot duration is idle, go to step 4; else, go to step 5;
4) if N = 0, stop; else, go to step 2.
5) sense the channel until either a busy sensing slot is detected within an additional defer duration T_{d} or all the sensing slots of the additional defer duration T_{d} are detected to be idle;
6) if the channel is sensed to be idle during all the sensing slot durations of the additional defer duration T_{d}, go to step 4; else, go to step 5;

If an eNB/gNB has not transmitted a transmission after step 4 in the procedure above, the eNB/gNB may transmit a transmission on the channel, if the channel is sensed to be idle at least in a sensing slot duration Tₛₗ when the eNB/gNB is ready to transmit and if the channel has been sensed to be idle during all the sensing slot durations of a defer duration T_{d} immediately before this transmission. If the channel has not been sensed to be idle in a sensing slot duration Tₛₗ when the eNB/gNB first senses the channel after it is ready to transmit or if the channel has been sensed to be not idle during any of the sensing slot durations of a defer duration T_{d} immediately before this intended transmission, the eNB/gNB proceeds to step 1 after sensing the channel to be idle during the sensing slot durations of a defer duration T_{d}.

The defer duration T_{d} consists of duration T_{f} = 16 us immediately followed by mₚ consecutive sensing slot durations Tₛₗ, and T_{f} includes an idle sensing slot duration Tₛₗ at start of T_{f}.

An eNB/gNB shall not transmit on a channel for a Channel Occupancy Time that exceeds Tₘ _{cot,} ₚ where the channel access procedures are performed based on a channel access priority class p associated with the eNB/gNB transmissions, as given in Table 4.1.1-1.

If an eNB/gNB transmits discovery burst(s) as described in clause 4.1.2 when N > 0 in the procedure above, the eNB/gNB shall not decrement N during the sensing slot duration(s) overlapping with discovery burst(s).

A gNB may use any channel access priority class for performing the procedures above to transmit transmission(s) including discovery burst(s) satisfying the conditions described in this clause.

A gNB shall use a channel access priority class applicable to the unicast user plane data multiplexed in PDSCH for performing the procedures above to transmit transmission(s) including unicast PDSCH with user plane data.

For p = 3 and = 4, if the absence of any other technology sharing the channel can be guaranteed on a long term basis (e.g. by level of regulation), Tₘ _{cot,} ₚ = 10 ms, otherwise, T_{m cot,} ₚ = 8 ms.

TABLE 4.1.1-1

Channel Access Priority Class (CAPC)

| Channel Access Priority Class (p) | mₚ | CW_{min,} ₚ | Cw_{max,} ₚ | T_{m cot, p} | allowed CWₚsizes |
|---|---|---|---|---|---|
| 1 | 1 | 3 | 7 | 2 ms | {3,7} |
| 2 | 1 | 7 | 15 | 3 ms | {7,15} |
| 3 | 3 | 15 | 63 | 8 or 10 ms | {15,31,63} |
| 4 | 7 | 15 | 1023 | 8 or 10 ms | {15,31,63,127,255,511,1023} |

### 4.1.2 Type 2 DL Channel Access Procedures

This clause describes channel access procedures to be performed by an eNB/gNB where the time duration spanned by sensing slots that are sensed to be idle before a downlink transmission(s) is deterministic.

If an eNB performs Type 2 DL channel access procedures, it follows the procedures described in clause 4.1.2.1.

Type 2A channel access procedures as described in clause 4.1.2.1 are only applicable to the following transmission(s) performed by an eNB/gNB:
Transmission(s) initiated by an eNB including discovery burst and not including PDSCH where the transmission(s) duration is at most 1 ms, or
Transmission(s) initiated by a gNB with only discovery burst or with discovery burst multiplexed with non-unicast information, where the transmission(s) duration is at most 1 ms, and the discovery burst duty cycle is at most 1/20, or
Transmission(s) by an eNB/ gNB following transmission(s) by a UE after a gap of 25 us in a shared channel occupancy as described in clause 4.1.3.

Type 2B or Type 2C DL channel access procedures as described in clause 4.1.2.2 and 4.1.2.3, respectively, are applicable to the transmission(s) performed by a gNB following transmission(s) by a UE after a gap of 16 us or up to 16 us, respectively, in a shared channel occupancy as described in clause 4.1.3.

### 4.1.2.1 Type 2A DL Channel Access Procedures

An eNB/gNB may transmit a DL transmission immediately after sensing the channel to be idle for at least a sensing interval T_{short_dl} = 25 us. T_{short_dl} consists of a duration T_{f} = 16 us immediately followed by one sensing slot and T_{f} includes a sensing slot at start of T_{f}. The channel is considered to be idle for T_{short_dl} if both sensing slots of T_{short_dl} are sensed to be idle.

### 4.1.2.2 Type 2B DL Channel Access Procedures

A gNB may transmit a DL transmission immediately after sensing the channel to be idle within a duration of T_{f} = 16 us. T_{f} includes a sensing slot that occurs within the last 9 us of T_{f}. The channel is considered to be idle within the duration T_{f} if the channel is sensed to be idle for a total of at least 5 us with at least 4 us of sensing occurring in the sensing slot.

### 4.1.2.3 Type 2C DL Channel Access Procedures

When a gNB follows the procedures in this clause for transmission of a DL transmission, the gNB does not sense the channel before transmission of the DL transmission. The duration of the corresponding DL transmission is at most 584 us.

### 4.2 Uplink Channel Access Procedures

A UE performing transmission(s) on LAA Scell(s), an eNB scheduling or configuring UL transmission(s) for a UE performing transmission(s) on LAA Scell(s), and a UE performing transmission(s) on channel(s) and a gNB scheduling or configuring UL transmission(s) for a UE performing transmissions on channel(s) shall perform the procedures described in this clause for the UE to access the channel(s) on which the transmission(s) are performed.

A UE performs channel access procedures in this clause unless the higher layer parameter ChannelAccessMode-r16 is provided and ChannelAccessMode-r16 =‘ semistatic’.

If a UE fails to access the channel(s) prior to an intended UL transmission to a gNB, Layer 1 notifies higher layers about the channel access failure.

### 4.2.1 Channel Access Procedures for Uplink Transmission(s)

A UE can access a channel on which UL transmission(s) are performed according to one of Type 1 or Type 2 UL channel access procedures. Type 1 channel access procedure is described in clause 4.2.1.1. Type 2 channel access procedure is described in clause 4.2.1.2.

If a UL grant scheduling a PUSCH transmission indicates Type 1 channel access procedures, the UE shall use Type 1 channel access procedures for transmitting transmissions including the PUSCH transmission unless stated otherwise in this clause.

A UE shall use Type 1 channel access procedures for transmitting transmissions including the autonomous or configured grant PUSCH transmission on configured UL resources unless stated otherwise in this clause.

If a UL grant scheduling a PUSCH transmission indicates Type 2 channel access procedures, the UE shall use Type 2 channel access procedures for transmitting transmissions including the PUSCH transmission unless stated otherwise in this clause.

A UE shall use Type 1 channel access procedures for transmitting SRS transmissions not including a PUSCH transmission. UL channel access priority class p = 1 in Table 4.2.1-1 is used for SRS transmissions not including a PUSCH.

If a DL assignment triggering SRS but not scheduling a PUCCH transmission indicates Type 2 channel access procedures, the UE shall use Type 2 channel access procedures.

The total Channel Occupancy Time of autonomous uplink transmission(s) obtained by the channel access procedure in this clause, including the following DL transmission if the UE sets ‘COT sharing indication’ in AUL-UCI to ‘1’ in a subframe within the autonomous uplink transmission(s) as described in Clause 4.1.3, shall not exceed T_{ulm cot,} ₚ, where T_{ulm cot,} ₚ is given in Table 4.2.1-1.

TABLE 4.2.1-1

Channel Access Priority Class (CAPC) for UL

| Channel Access Priority Class (p) | mₚ | CW_{min,} ₚ | CW_{max,} ₚ | Tᵤₗₘ _{cot,} ₚ | allowed CWₚ sizes |
|---|---|---|---|---|---|
| 1 | 2 | 3 | 7 | 2 ms | {3,7} |
| 2 | 2 | 7 | 15 | 4 ms | {7,15} |
| 3 | 3 | 15 | 1023 | 6 ms or 10 ms | {15,31,63,127,255,511,1023} |
| 4 | 7 | 15 | 1023 | 6 ms or 10 ms | {15,31,63,127,255,511,1023} |

NOTE1: For p = 3,4, T_{ulm cot,} ₚ = 10 ms if the higher layer parameter absenceOfAnyOtherTechnology-r14 or absenceOfAnyOtherTechnology-r16 is provided, otherwise, T_{ulm cot,} ₚ = 6 ms.
NOTE 2: When T_{ulm cot, p} = 6 ms it may be increased to 8 ms by inserting one or more gaps. The minimum duration of a gap shall be 100 us. The maximum duration before including any such gap shall be 6 ms.

### 4.2.1.1 Type 1 UL Channel Access Procedure

This clause describes channel access procedures by a UE where the time duration spanned by the sensing slots that are sensed to be idle before a UL transmission(s) is random. The clause is applicable to the following transmissions:
PUSCH/SRS transmission(s) scheduled or configured by eNB/gNB, or
PUCCH transmission(s) scheduled or configured by gNB, or
Transmission(s) related to random access procedure.

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N = Nᵢₙᵢₜ, where Nᵢₙᵢₜ is a random number uniformly distributed between 0 and CWₚ, and go to step 4;
2) if N > 0 and the UE chooses to decrement the counter, set N = N - 1;
3) sense the channel for an additional slot duration, and if the additional slot duration is idle, go to step 4; else, go to step 5;
4) if N = 0, stop; else, go to step 2.
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step 4; else, go to step 5;

If a UE has not transmitted a UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f} = 16us immediately followed by mₚ consecutive slot durations where each slot duration is Tₛₗ = 9us, and T_{f} includes an idle slot duration Tₛₗ at start of T_{f}.

### 4.2.1.2 Type 2 UL Channel Access Procedure

This clause describes channel access procedures by UE where the time duration spanned by the sensing slots that are sensed to be idle before a UL transmission(s) is deterministic.

### 4.2.1.2.1 Type 2A UL Channel Access Procedure

If a UE is indicated to perform Type 2A UL channel access procedures, the UE uses Type 2A UL channel access procedures for a UL transmission. The UE may transmit the transmission immediately after sensing the channel to be idle for at least a sensing interval T_{short_ul} = 25 us. T_{short_ul} consists of a duration T_{f} = 16 us immediately followed by one sensing slot and T_{ƒ}includes a sensing slot at start of T_{f}. The channel is considered to be idle for T_{short_ul} if both sensing slots of T_{short_ul}.are sensed to be idle.

### 4.2.1.2.2 Type 2B UL Channel Access Procedure

If a UE is indicated to perform Type 2B UL channel access procedures, the UE uses Type 2B UL channel access procedure for a UL transmission. The UE may transmit the transmission immediately after sensing the channel to be idle within a duration of T_{f} = 16 us.T_{f} includes a sensing slot that occurs within the last 9 us of T_{f}. The channel is considered to be idle within the duration T_{f} if the channel is sensed to be idle for total of at least 5 us with at least 4 us of sensing occurring in the sensing slot.

### 4.2.1.2.3 Type 2C UL Channel Access Procedure

If a UE is indicated to perform Type 2C UL channel access procedures for a UL transmission, the UE does not sense the channel before the transmission. The duration of the corresponding UL transmission is at most 584 us.

### 4.3 Channel Access Procedures for Semi-static Channel Occupancy

Channel access procedures based on semi-static channel occupancy as described in this Clause, are intended for environments where the absence of other technologies is guaranteed e.g., by level of regulations, private premises policies, etc.

If a gNB provides UE(s) with higher layer parameters ChannelAccessMode-r16 =‘semiStatic’ by SIB1 or dedicated configuration for a serving cell, a periodic channel occupancy can be initiated by the gNB on a channel(s) within the bandwidth of the serving cell every Tₓ within every two consecutive radio frames, starting from the even indexed radio frame at i · Tₓ with a maximum channel occupancy time T_{y} = 0.9STₓ, where Tₓ = period in ms, is a higher layer parameter provided in SemiStaticChannelAccessConfig and i ∈

$$\left\{0 , 1 , … \frac{20}{{T}_{x}} - 1\right\} .$$

A duration of T_{z} = max(0.05Tₓ, 100 us) at the end of a period is referred to as the idle duration of that period.

If the gNB additionally configures a UE with higher layer parameter ue-SemiStaticChannelAccessConfig consisting of ue-Period and ue-Offset, the UE can initiate a channel occupancy on a channel(s) within the bandwidth of the serving cell every Tᵤ = ue-Period in ms with corresponding maximum channel occupancy time Tᵥ = 0.95Tᵤ. The offset of the periodic channel occupancy is determined by Tₒ= ue-Offset as the number of symbols from the beginning of an even indexed radio frame to the start of the first period in that radio frame in which the UE can initiate a channel occupancy. A duration of T_{w} = max(0.05Tᵤ, 100 us) at the end of a period is referred to as the idle duration of that period.

For determining a Channel Occupancy Time based on semi-static channel access procedures, duration of any transmission gap within a period excluding the corresponding idle duration is counted in the channel occupancy time.In the following procedures in this clause, when a gNB or UE performs sensing for evaluating a channel availability, the sensing is performed at least during a sensing slot duration Tₛₗ = 9 us, unless longer sensing duration is required (e.g. by level of regulation), in which case sensing is performed within a duration of Tₛₗ = 16 us. When sensing is performed within a duration of Tₛₗ = 16 us, the channel is considered to be idle if the channel is sensed to be idle for total of at least 5 us with at least 4 us of sensing occurring in the last 9 us time interval in the sensing duration. The corresponding X_{Thresh} adjustment for performing sensing by a gNB or a UE is described in clauses 4.1.5 and 4.2.3, respectively.

### 4.3.1 Channel Access Procedures to Initiate a Channel Occupancy

For semi-static channel occupancy, the procedures in Clause 4.3.1.1 are followed if ue-SemiStaticChannelAccessConfig is absent. Otherwise, the procedures in Clause 4.3.1.2 are applicable.

### 4.3.1.1 Channel Occupancy Initiated Only by gNB

A channel occupancy initiated by a gNB and shared with UE(s) satisfies the following:
The gNB shall transmit a DL transmission burst starting at the beginning of the channel occupancy time immediately after sensing the channel to be idle for at least a sensing slot duration Tₛₗ. If the channel is sensed to be busy, the gNB shall not perform any transmission during the current period.
The gNB may transmit a DL transmission burst(s) within the channel occupancy time immediately after sensing the channel to be idle for at least a sensing slot duration Tₛₗ if the gap between the DL transmission burst(s) and any previous transmission burst is more than 16 us.
The gNB may transmit DL transmission burst(s) after UL transmission burst(s) within the channel occupancy time without sensing the channel if the gap between the DL and UL transmission bursts is at most 16 us.
A UE may transmit UL transmission burst(s) after detection of a DL transmission burst(s) within the channel occupancy time as follows:
   If the gap between the UL and DL transmission bursts is at most 16 us, the UE may transmit UL transmission burst(s) after a DL transmission burst(s) within the channel occupancy time without sensing the channel.
   If the gap between the UL and DL transmission bursts is more than 16 us, the UE may transmit UL transmission burst(s) after a DL transmission burst(s) within the channel occupancy time after sensing the channel to be idle for at least a sensing slot duration Tₛₗ within a 25 us interval ending immediately before transmission.
A UE may be indicated by the gNB to transmit UL transmission burst(s) within the channel occupancy time without sensing the channel or after sensing the channel to be idle for at least a sensing slot duration Tₛₗ within a 25 us interval ending immediately before transmission.
The gNB and UEs shall not transmit any transmissions in a set of consecutive symbols for a duration of at least T_{z} = max(0.05Tₓ, 100 us) before the start of the next period.

### 4.3.1.2 Channel Occupancy Initiated by gNB or UE

### 4.3.1.2.1 Channel Occupancy Initiated by gNB and Sensing Procedures

The gNB initiates a channel occupancy in a period of duration Tₓ if the gNB transmits a DL transmission burst starting at the beginning of the period immediately after sensing the channel to be idle for at least a sensing slot duration Tₛₗ = 9 us and ends the transmission of the DL transmission burst before the start of the idle duration of that period. When a UL or DL transmission burst(s) is associated with the channel occupancy that is initiated in that period by the gNB, the following are applicable:
The UL or DL transmission burst(s) is confined within that period and ends before the start of the idle duration of that period.If the gap between the DL transmission burst(s) and any previous DL transmission burst in that period is more than 16 us, the DL transmission burst(s) may be transmitted if the channel is sensed to be idle for at least a sensing slot duration Tₛₗ = 9 us immediately before the DL transmission.
If the gap between the UL transmission burst(s) and any previous DL transmission burst in that period is more than 16 us, the UL transmission burst(s) may be transmitted if the channel is sensed to be idle for at least a sensing slot duration Tₛₗ = 9 us within a 25 us interval ending immediately before the UL transmission.
If the gap between the UL transmission burst(s) and any previous DL transmission burst in that period is at most 16 us, the UL transmission burst(s) may be transmitted without sensing.

### 4.3.1.2.2 Channel Occupancy Initiated by UE and Sensing Procedures

A UE initiates a channel occupancy in a period of duration Tᵤ if the UE transmits a UL transmission burst starting at the beginning of the period immediately after sensing the channel to be idle for at least a sensing slot duration Tₛₗ = 9 us and ends the transmission of the UL transmission burst before the start of the idle duration of that period. When a UL or DL transmission burst(s) is associated with the channel occupancy that is initiated in that period by the UE, the following are applicable:
The UL or DL transmission burst(s) is confined within that period and ends before the start of the idle duration of that period.
If the gap between the UL transmission burst(s) and any previous UL transmission burst in that period is more than 16 us, the UL transmission burst(s) may be transmitted if the channel is sensed to be idle for at least a sensing slot duration Tₛₗ = 9 us immediately before the UL transmission.
If the gap between the DL transmission burst(s) and any previous UL transmission burst in that period is more than 16 us, the DL transmission burst(s) may be transmitted if the channel is sensed to be idle for at least a sensing slot duration Tₛₗ = 9 us within a 25 us interval ending immediately before the DL transmission.
If the gap between the DL transmission burst(s) and any previous UL transmission burst in that period is at most 16 us, the DL transmission burst(s) may be transmitted without sensing.

When a DL transmission burst(s) is associated with a channel occupancy that is initiated in a period of duration Tᵤ by a UE, the DL transmission burst(s) shall include unicast user plane data or control information intended for the UE initiating the channel occupancy in that period. The gNB may include in the DL transmission burst(s) an additional transmission(s) intended to other UEs than the UE that has initiated the channel occupancy in that period or broadcast transmission(s), only if the gNB satisfies the condition that the detection of the additional DL transmission(s) at any UE will not be associated with a channel occupancy that is initiated by gNB following the procedures described in Clause 4.3.1.2.3 and 4.3.1.2.4.

### 4.4.5 Exempted Transmissions From Sensing

In regions where channel sensing is required to access a channel for transmission and short control signalling exemption is allowed by regulation, a gNB/UE may transmit the following transmission(s) on a channel without sensing the channel:
Transmission(s) of the discovery burst by the gNB
Transmission(s) of the first message in a random access procedure by the UE

When the gNB/UE transmits the above transmission(s) without sensing on a channel by utilizing the exemption above, the total duration of such transmission(s) by the gNB/UE shall not occupy the corresponding channel more than 10 ms over any 100 ms interval.

A brief description for different types of LBT and/or channel access procedure is referenced from 5G New Radio Unlicensed: Challenges and Evaluation:
2) LTE-LAA-/NR-U-based Systems: To facilitate 5G NR-U (also LTE-LAA) operation over unlicensed bands, four LBT Categories (CATs) have been defined:
   CAT1-LBT (Type 2C): A gNB can access the channel immediately without performing LBT. The COT can be up to 584 microseconds.
   CAT2-LBT (Type 2A and 2B): An NR-U device must sense the channel for a fixed time duration, Tfixed. If the channel remains idle during this period, the device can access the channel. In Type 2A, Tfixed is 25 microseconds, while in Type 2B, it is 16 microseconds.
   CAT3-LBT: An NR-U device must back off for a random period of time before accessing the channel. This random period is sampled from a fixed-size contention window. The option of CAT3-LBT has been excluded from the specifications.
   CAT4-LBT (Type 1): An NR-U device must back off according to the CSMA/CA procedure with exponential backoff

3GPP TR 38.889 V16.0.0 discusses band n46 targeting range 5150-5925 MHz, which may be in an unlicensed spectrum and/or may be a Time Division Duplex (TDD) band.

### 4 REGULATORY REQUIREMENTS

### 4.1 Regulatory Requirements for 5 GHz Band

The range 5150-5925 MHz, or parts thereof, is potentially available for license-assisted access to unlicensed operation. This represents a significant amount of spectrum that can be used by operators to augment their service offerings in licensed bands. The range above can be operated under a license-exempt regime or ISM but must be shared with existing mobile services and other incumbent services. The quality of service offered by a licensed regime can therefore not be matched. Hence, unlicensed access is viewed as complementary, and does not reduce the need for additional allocations for licensed operation in view of the increased demand for wireless broadband access.

It is relevant to consider the global (International) ITU-R allocations and technical provisions first. These could be basis for defining globally harmonised bands for LAA and starting points for requirements and limits before the local variations are considered.

3GPP TS 38.331 V16.5.0 discusses one or more information elements. One or more parts of 3GPP TS 38.331 V16.5.0 are quoted below:

### 6.3.5 Sidelink Information Elements

### - SL-BWP-Config

The IE SL-BWP-Config is used to configure the UE specific NR sidelink communication on one particular sidelink bandwidth part.

SL-BWP-Config information element

| | |
|---|---|
| -- ASN1START | |
| -- TAG-SL-BWP-CONFIG-START | |
| SL-BWP-Config-r16 ::= | SEQUENCE { |
| sl-BWP-Id | BWP-Id, |
| sl-BWP-Generic-r16 | SL-BWP-Generic-r16 |
| OPTIONAL, -- Need M | |
| sl-BWP-PoolConfig-r16 | SL-BWP-PoolConfig-r16 |
| OPTIONAL, -- Need M | |
| ... | |
| } | |
| SL-BWP-Generic-r16 ::= | SEQUENCE { |
| sl-BWP-r16 | BWP |
| OPTIONAL, -- Need M | |
| sl-LengthSymbols-r16 | ENUMERATED {sym7, sym8, |
| sym9, sym10, sym11, sym12, sym13, sym14} | OPTIONAL, -- Need M |
| sl-StartSymbol-r16 | ENUMERATED {sym0, sym1, |
| sym2, sym3, sym4, sym5, sym6, sym7} | OPTIONAL, -- Need M |
| sl-PSBCH-Config-r16 | SetupRelease {SL-PSBCH- |
| Config-r16} | OPTIONAL, -- Need M |
| ... | |
| } | |
| -- TAG-SL-BWP-CONFIG-STOP | |
| -- ASN1STOP | |

SL-BWP-Generic field descriptions
sl-LengthSymbols
This field indicates the number of symbols used for sidelink in a slot without SL-SSB. A single value can be (pre)configured per sidelink bandwidth part.

sl-StartSymbol
This field indicates the starting symbol used for sidelink in a slot without SL-SSB. A single value can be (pre)configured per sidelink bandwidth part.

One or more parts of 3GPP TS 38.300 V16.6.0 are quoted below:

### 5.6 Access to Shared Spectrum

### 5.6.1 Overview

NR Radio Access operating with shared spectrum channel access can operate in different modes where either PCell, PSCell, or SCells can be in shared spectrum and an SCell may or may not be configured with uplink. The applicable deployment scenarios are described in Annex B.3.

The gNB operates in either dynamic or semi-static channel access mode as described in TS 37.213 [37]. In both channel access modes, the gNB and UE may apply Listen-Before-Talk (LBT) before performing a transmission on a cell configured with shared spectrum channel access. When LBT is applied, the transmitter listens to/senses the channel to determine whether the channel is free or busy and performs transmission only if the channel is sensed free.

RP-213678 discusses application of sidelink techniques on unlicensed band (e.g., band n46/n96/n102) in order to increase data rate. One or more parts of RP-213678 are quoted below:

### JUSTIFICATION

In Rel-16, sidelink communication was developed in RAN mainly to support advanced V2X applications. In Rel-17, SA2 studied and standardized Proximity based service including public safety and commercial related service. As part of Rel-17, power saving solutions (e.g., partial sensing, DRX) and inter-UE coordination have been developed in RAN1 and RAN2 to improve power consumption for battery limited terminals and reliability of sidelink transmissions.

Although NR sidelink was initially developed for V2X applications, there is growing interest in the industry to expand the applicability of NR sidelink to commercial use cases. For commercial sidelink applications, two key requirements have been identified:
Increased sidelink data rate
Support of new carrier frequencies for sidelink

Increased sidelink data rate is motivated by applications such as sensor information (video) sharing between vehicles with high degree of driving automation. Commercial use cases could require data rates in excess of what is possible in Rel-17. Increased data rate can be achieved with the support of sidelink carrier aggregation and sidelink over unlicensed spectrum. Furthermore, by enhancing the FR2 sidelink operation, increased data rate can be more efficiently supported on FR2. While the support of new carrier frequencies and larger bandwidths would also allow to improve its data rate, the main benefit would come from making sidelink more applicable for a wider range of applications. More specifically, with the support of unlicensed spectrum and the enhancement in FR2, sidelink will be in a better position to be implemented in commercial devices since utilization of the ITS band is limited to ITS safety related applications.

### 4 OBJECTIVE

1. ◯ [...]
2. Study and specify support of sidelink on unlicensed spectrum for both mode 1 and mode 2 where Uu operation for mode 1 is limited to licensed spectrum only [RAN1, RAN2, RAN4]
   Channel access mechanisms from NR-U shall be reused for sidelink unlicensed operation

NR Rel-16 may be a first release for NR sidelink Vehicle-to-Everything (V2X), and a standard (associated with NR Rel-16, for example) may meet one or more requirements defined by 3GPP Technical Specification Group Service and System Aspects (TSG SA) Workgroup 1 (WG1) (SA1). Over time, with increasing devices requiring higher throughput and/or higher data rate, sidelink transmission on wider frequency resources may be desired. However, current band(s) supporting PC5 interface and/or sidelink transmission may not be sufficient. Thus, introduction of sidelink transmission on unlicensed spectrum (e.g., shared spectrum) with large spectrum availability may be a targeted solution. In order to have fair coexistence with other devices in a same or different Radio Access Technology (RAT) or different techniques (e.g., WiFi) in unlicensed spectrum, listen before talk (LBT) may be required. LBT is an energy detection and/or sensing technique. For example, according to an LBT result (which may indicate idle or busy) before a transmission, a device may determine whether to allow the transmission. New Radio-Unlicensed for Uu interface is discussed in 3GPP TS 37.213 V17.0.0 and/or 5G New Radio Unlicensed: Challenges and Evaluation. There are multiple types of LBT such as short LBT (e.g., Category 1 LBT (CAT1-LBT), and/or Category 2 LBT (CAT2-LBT)) and/or long LBT (e.g., Category 4 LBT (CAT4-LBT)). For short LBT, a device may be allowed to perform a transmission (i) without LBT (e.g., LBT may not be performed prior to the transmission) and/or (ii) with relatively short LBT (e.g., the device may perform the relatively short LBT, which may be associated with a duration of time smaller than a duration of time of long LBT, prior to the transmission). For long LBT, a device may need to perform transmission with LBT with relative longer time (e.g., long LBT may be performed with more sensing slots being idle compared with short LBT, and/or may be performed with back off). For sidelink reception, continuously monitoring, receiving and/or detecting sidelink resources may be an assumption in sidelink device. Alternatively and/or additionally, there may be a plurality of channel access modes (e.g., two channel access modes) in New Radio Unlicensed (NR-U) comprising (i) semi-static channel access (e.g., frame based equipment (FBE)), and/or (ii) dynamic channel access (e.g., load based equipment (LBE)). According to 3GPP TS 37.213 V17.0.0, FBE may be intended for environments where the absence of other technologies is guaranteed (e.g., FBE may be beneficial for a network controlled environment). Due to the network controlled environment, there may be a Radio Access Network (RAN) (e.g., one RAN) on an unlicensed band, which may be beneficial for a network vendor to deploy smart factor and support service, which may require a higher data rate.

For FBE in NR-U, a gNB may configure periodic channel occupancy initiated by gNB within (every, for example) period (denoted as Tx) within (every, for example) two consecutive radio frames. Each Tx may comprise a span of time Tz = max (0.05 × Tx, 100 microseconds) (e.g., a duration of Tz is equal to a maximum value of a first value equal to 0.05 × Tx and a second value equal to 100 microseconds) at the end of the Tx. The span of time Tz is used for performing LBT for next period Tx. In some examples, channel occupancy in each Tx may be at most Tx-Tz. gNB may perform LBT during Tz for determining whether or not the channel is idle. If the channel is sensed idle during Tz (e.g., if an LBT result of the LBT performed during Tz indicates that the channel is idle), gNB may initiate channel occupancy within a next (e.g., consecutive) Tx. Alternatively and/or additionally, in order to support latency requirement of Ultra-Reliable and Low Latency Communications (URLLC), a UE may have a configuration for periodic channel occupancy initiated by UE within (every, for example) a second period (denoted as Tu) within (every, for example) two consecutive radio frames. Each Tu may comprise a second span of time Tz′ = max (0.05 × Tu, 100 microseconds) at the end of the Tu (e.g., a duration of Tz′ is equal to a maximum value of a first value equal to 0.05 × Tu and a second value equal to 100 microseconds). The second span of time Tz is used for performing LBT for next period Tu. In some examples, channel occupancy in each Tu may be at most Tu-Tz′. The UE may perform LBT during Tz′ for determining whether or not the channel is idle. If the channel is sensed idle during Tz′ (e.g., if an LBT result of the LBT performed during Tz′ indicates that the channel is idle), the UE may initiate channel occupancy within a next (e.g., consecutive) Tu. In some examples, Tx may be an integer, and may be a multiple of Tu. gNB may be allowed to share its occupancy (e.g., channel occupancy) with the UE for performing uplink transmission (e.g., the gNB may share its occupancy with the UE for performing uplink transmission) and/or UE may be allowed to share occupancy (e.g., channel occupancy of the UE) with the gNB for performing downlink scheduling (e.g., the UE may share occupancy with the gNB for performing downlink scheduling). However, there may be a restriction that when gNB uses an occupancy (e.g., channel occupancy) initiated by UE1, a downlink (DL) transmission burst shall include transmission to UE1. In some examples, for FBE, when a UE detects a DL transmission by gNB (e.g., the DL transmission may comprise at least one of a Downlink Control Information (DCI), a Channel State Information-Reference Signal (CSI-RS), a DL burst, a synchronization signals (SS), Physical Broadcast Channel (PBCH), a Physical Downlink Shared Channel (PDSCH), etc.), the UE may consider that the gNB has occupancy (e.g., channel occupancy) in current period Tx. If UE is scheduled and/or configured to perform a UL transmission within a channel occupancy in current period Tx (e.g., the UL transmission is not within the span of time Tz in current period Tx), UE may perform the UL transmission without LBT or after a CAT2-LBT (e.g., the CAT2-LBT may be performed in one sensing slot).

In an example, in a FBE scenario, there may be both a gNB period (e.g., Tx) and a UE period (e.g., Tu). A gNB associated with the gNB period may be associated with a UE-type roadside unit (RSU). In the example, since sidelink resource may be scheduled by DCI format 3_0 in licensed spectrum, validating gNB’s occupancy for current gNB’s period from detecting DL transmission may not be sufficient. One issue is making sure UE knows the scheduled resource from DCI format 3_0 is using gNB’s period or UE period (e.g., the UE should know which period to use), and/or how (and/or whether) the UE knows the scheduled resource is associated with Channel Occupancy (CO) initiated by gNB or by the UE (itself) (e.g., the UE should know whether the scheduled resource is associated with channel occupancy initiated by the gNB or is associated with channel occupancy imitated by the UE). Without solving this issue, if one sidelink resource of multiple (e.g., up to three) scheduled sidelink resources from DCI format 3_0 is scheduled in idle duration of gNB’s period, the UE may be confused whether the UE can perform sidelink transmission using the one sidelink resource if using gNB’s period. In some examples, since there may be up to 3 scheduled resources from DCI format 3_0, whether the UE uses one, some and/or all of the 3 scheduled resources for sidelink transmission may be further discussed, since under some situations the UE may fail to pass LBT for initiating CO. In some examples, when a scheduled resource is overlapping with idle duration, determining (based upon the UE’s behavior, for example) whether or not to perform sidelink transmission on the scheduled resource may be an issue.

Another issue is associated with Physical Sidelink Feedback Channel (PSFCH) transmission. In Rel-16, PSFCH resource may be configured (e.g., pre-configured) per resource pool in a periodic manner. In other words, a single PSFCH period, which may be 1, 2, or 4 slots, is configured (e.g., pre-configured) per resource pool, which may mean that (every, for example) 1, 2 or 4 slots, there is PSFCH in a resource pool. Timing of PSFCH in slot with PSFCH resource may comprise one or more last symbols available for sidelink transmission. A slot may comprise 14 symbols (e.g., symbols index 0~13), and last symbol (symbol index 13) may not be available for sidelink transmission since it may be used as gap for transition. PSFCH may comprise 2 symbols, wherein 1 of the 2 symbols may be for duplication. PSFCH may be in symbol index 11 and symbol index 12 which may be the last two available symbols in a slot for sidelink. Using last two available symbols in a slot for sidelink may benefit from a self-contained slot for fast sidelink feedback and/or short duration of PSFCH (e.g., 2 symbols), and/or may provide for reduced interference for Physical Sidelink Control Channel (PSCCH) transmission and/or Physical Sidelink Shared Channel (PSSCH) transmission. There may be a symbol index 10 (of a symbol in a slot) that may act as a gap for transition between PSSCH and PSFCH. However, when it comes to sidelink on unlicensed spectrum, when a receiver UE (RX UE) (which has received PSSCH and needs to transmit PSFCH), the (merely few, for example) choices for RX UE for CO is (i) using another UE’s initiated CO or (ii) using a previously initiated CO (if available, for example), initiated by a RX UE, that covers PSFCH resource (since PSFCH cannot align slot boundary, for example). Thus, one or more of the techniques provided herein may be implemented to enhance PSFCH transmission in Sidelink Unlicensed (SL-U) (e.g., Sidelink in Unlicensed spectrum).

In some examples, a sidelink burst (e.g., one sidelink burst) may comprise one or more sidelink transmissions. In some examples, a time gap between two of the one or more sidelink transmission is at most a time threshold (e.g., 16 microseconds). For example, between each pair of (consecutive) sidelink transmissions of the one or more sidelink transmissions, there may be a time gap of at most the time threshold.

A concept of the present disclosure may be that a first UE may transmit sidelink Hybrid Automatic Repeat Request (HARQ) feedback on PSCCH and/or PSSCH. In some examples, it may be beneficial and/or logical to transmit the sidelink HARQ feedback at a beginning of a fixed frame period (FFP) (rather than transmitting the sidelink HARQ feedback outside the beginning of the FFP, such as in a middle portion of the FFP or at an end of the FFP, for example). However, in some scenarios, it may be difficult to transmit the sidelink HARQ feedback at the beginning of the FFP. In some examples, the first UE may receive a request from a different UE. In some examples, the request from the different UE may indicate to (e.g., instruct) the first UE to transmit one or more sidelink HARQ feedbacks on PSCCH and/or PSSCH. In some examples, a transmission of sidelink HARQ feedback on PSCCH, PSSCH and/or PSFCH may be a retransmission for a (previous) sidelink HARQ feedback. In some examples, the transmission being a retransmission for the (previous) sidelink HARQ feedback may mean the first UE is not available to transmit sidelink HARQ feedback on PSFCH, and thus may need to perform the retransmission to transmit the sidelink HARQ feedback. In some examples, the first UE may transmit sidelink HARQ feedback on a 1-st stage Sidelink Control Information (SCI) (e.g., SCI format 1-A), a 2-nd stage SCI (e.g., SCI format 2-X), or a Medium Access Control (MAC) Control Element (CE) (MAC CE). In some examples, the transmission of the sidelink HARQ feedback (e.g., on the 1-st stage SCI, the 2-nd stage SCI, or the MAC CE) may be a retransmission after an original PSFCH location for the sidelink HARQ feedback (e.g., the original PSFCH location may be a PSFCH location originally scheduled for the sidelink HARQ feedback). In some examples, the transmission of the sidelink HARQ feedback (e.g., on the 1-st stage SCI, the 2-nd stage SCI, or the MAC CE) may be earlier than the original PSFCH location for the sidelink HARQ feedback. In some examples, the transmission of the sidelink HARQ feedback (e.g., on the 1-st stage SCI, the 2-nd stage SCI, or the MAC CE) CE may provide information related to one or more sidelink HARQ feedbacks. In some examples, the first UE may perform the transmission of the sidelink HARQ feedback (e.g., on the 1-st stage SCI, the 2-nd stage SCI, or the MAC CE) CE in response to a request and/or in response to a condition associated with a timer, a counter and/or a window being met (e.g., the condition may be met upon the timer expiring, the counter reaching a threshold value, the window beginning or ending, etc.). In some examples, there may be a Logical Channel Identifier (LCID) (e.g., a specific LCID) for the MAC CE carrying one or more sidelink HARQ feedbacks. In some examples, a number of sidelink HARQ feedbacks of the one or more sidelink HARQ feedbacks may be based upon a fixed and/or predefined number. In some examples, a number of sidelink HARQ feedbacks of the one or more sidelink HARQ feedbacks may be based upon a higher layer signaling and/or configuration. In some examples, a number of sidelink HARQ feedbacks of the one or more sidelink HARQ feedbacks may be based upon a request UE’s number of HARQ processes (e.g., a number of HARQ processes associated with the request UE, which may correspond to the different UE that transmits the request indicating to the first UE to transmit the one or more sidelink HARQ feedbacks) or a Transmitter UE’s (TX UE) number of HARQ processes (e.g., a number of HARQ processes associated with the TX UE), wherein the transmitter UE corresponds to the UE transmitting sidelink transmission that is associated with (e.g., requesting and/or having) one or more sidelink HARQ feedbacks. In some examples, the first UE and one or more UEs comprising the TX UE and/or the request UE may exchange (e.g., initially exchange) information indicating a number of sidelink HARQ feedbacks of the one or more sidelink HARQ feedback (e.g., the first UE may transmit and/or receive the information to and/or from the TX UE and/or the request UE). In some examples, the exchange (e.g., the transmission and/or reception of the information) may be based upon PC5 Radio Resource Control (RRC) signaling. In an example, assuming TX UE or request UE has X number of sidelink HARQ processes, TX UE or request UE may indicate, to the first UE, that the number of sidelink HARQ feedbacks is at most X (e.g., the TX UE or request UE tells the first UE that the number of sidelink HARQ feedbacks can be a number up to X). When the first UE transmits the one or more sidelink HARQ feedbacks, the number of the one or more sidelink HARQ feedbacks may be X. In some examples, X=16, and thus the first UE may transmit 16 bits corresponding to sidelink HARQ process numbers of TX UE or request UE. In some examples, the one or more sidelink HARQ feedbacks (transmitted in a MAC CE, such as one MAC CE, for example) may be transmitted with data associated with the TX UE or the request UE. In some examples, the data associated with the TX UE or the request UE may correspond to available data associated with one or more logical channels having a destination corresponding to the TX UE or the request UE. In some examples, the first UE may transmit the MAC CE (e.g., the one MAC CE) carrying the one or more sidelink HARQ feedbacks without including other data associated with a logical channel. In some examples, the first UE may transmit the MAC CE (e.g., the one MAC CE)carrying the one or more sidelink HARQ feedbacks without including other MAC CE (e.g., merely the one MAC CE carrying the one or more sidelink HARQ feedbacks may be transmitted in a transmission without transmitting any other MAC CE in the transmission). In some examples, the first UE may transmit the MAC CE (e.g., the one MAC CE) carrying the one or more sidelink HARQ feedbacks with other MAC CE (e.g., Sidelink (SL) Discontinuous Reception (DRX) MAC CE and/or SL Channel State Information (CSI) reporting MAC CE). For example, one or more other MAC CEs (in addition to the one MAC CE, for example) may be included in a transmission of the one MAC CE carrying the one or more sidelink HARQ feedbacks.

In some examples, a parameter (in pool configuration and/or PC5 RRC configuration, for example) may indicate whether or not retransmission of one or more sidelink HARQ feedbacks is supported. In some examples, if the parameter indicates retransmission of one or more sidelink HARQ feedbacks is not supported, the first UE cannot retransmit sidelink HARQ feedback on a pool (e.g., a sidelink resource pool associated with the parameter). In some examples, Channel Busy Ratio (CBR) may be used for enabling and/or disabling the feature of retransmission of sidelink HARQ feedback. In some examples, if CBR is higher than a threshold (and/or if the CBR indicates a level of congestion higher than a congestion threshold), the first UE is not allowed to retransmit the one or more sidelink HARQ feedbacks.

In an example, the first UE receives a PSCCH1, a PSSCH1 and/or a PSFCH from a second UE. The first UE may determine to transmit sidelink HARQ feedback on PSFCH in response to the PSCCH1, the PSSCH1 and/or the PSFCH. However, the first UE is not available to transmit sidelink HARQ feedback on PSFCH. In some examples, the first UE may prioritize PSFCH reception and/or UL transmission rather than performing PSFCH transmission (e.g., the first UE may prioritize the PSFCH reception and/or the UL transmission over the PSFCH transmission). In some examples, the first UE may fail to perform LBT for access channel for transmitting the sidelink HARQ feedback on PSFCH. In some examples, for contention window size adjustment, sidelink HARQ feedback for the second UE may be beneficial for adjusting contention window size (e.g., the second UE may use the sidelink HARQ feedback for adjusting contention window size). In some examples, the first UE may transmit the sidelink HARQ feedback on a PSCCH2, a PSSCH2 and/or the PSFCH. In some examples, the PSCCH2 is different than the PSCCH1 and/or the PSSCH2 is different than the PSSCH1. In some examples, PSSCH2 may deliver/transmit/comprise the sidelink HARQ feedback with or without data from one or more logical channels (e.g., one or more other logical channels). In the present disclosure, the term “deliver/transmit/comprise” may refer to deliver, transmit and/or comprise. In some examples, the one or more logical channels may comprise Sidelink Control Channel (SCCH) and/or Sidelink Traffic Channel (STCH). In some examples, PSSCH2 may deliver/transmit/comprise the sidelink HARQ feedback with or without: (i) MAC CE comprising SL CSI reporting, (ii) MAC CE comprising SL DRX related signaling, (iii) MAC CE comprising inter-UE coordination information (e.g., information indicating one or more preferred resources and/or one or more non-preferred resources), and/or (iv) a request. In some examples, PSSCH2 may deliver/transmit/comprise a new transmission of a TB/MAC PDU. In the present disclosure, the term “TB/MAC PDU” may refer to a Transport Block (TB) and/or a MAC Packet Data Unit (PDU) (MAC PDU). In some examples, PSSCH2 may be a retransmission of a TB/MAC PDU. In some examples, PSCCH2 may schedule a new transmission or a retransmission. In some examples, New Data Indicator (NDI) for the PSCCH2, the PSSCH2 and/or the PSFCH may be toggled or non-toggled.

In some examples, the first UE may transmit sidelink HARQ feedback on PSCCH/PSSCH/PSFCH in response to a timer, a counter and/or a window meeting (e.g., reaching and/or satisfying) a condition. In the present disclosure, the term “PSCCH/PSSCH/PSFCH” may refer to PSCCH, PSSCH and/or PSFCH. In some examples, the condition may be a condition that the timer expires, the counter exceeds a threshold and/or a timing exceeds a window that may start from an original timing of a PSFCH or from a time (e.g., a timing) of an original PSCCH/PSSCH/PSFCH which the sidelink HARQ feedback is in response to. In some examples, the first UE may transmit sidelink HARQ feedback on PSCCH/PSSCH/PSFCH without a request from the second UE.

In some examples, the first UE may reset and/or restart the timer when (e.g., in response to and/or upon) the first UE receives a PSCCH/PSSCH/PSFCH (e.g., a retransmission of the PSCCH/PSSCH/PSFCH) from the second UE. In some examples, the first UE may decrease the timer by a value (e.g., 1) when (e.g., in response to and/or upon) the first UE does not detect or receive a PSCCH/PSSCH/PSFCH (e.g., a retransmission of the PSCCH/PSSCH/PSFCH) from the second UE in a time unit. In some examples, the time unit may be at least one of a slot (e.g., one slot) in a sidelink resource pool, 1 millisecond (ms), 1 reserved period value, 1 physical slot (regardless of whether or not the slot belongs to sidelink resource pool, for example). Alternatively and/or additionally, whether or not the first UE performs an action comprising resetting or restarting the timer may be based upon whether or not the first UE transmits the sidelink HARQ feedback on another PSFCH resource (e.g., a PSFCH resource that is different than the PSCCH/PSSCH/PSFCH). In some examples, if the first UE can transmit a second sidelink HARQ feedback in response to a retransmission of PSCCH/PSSCH/PSFCH (e.g., the first UE is able to transmit the second sidelink HARQ feedback due to LBT success), the first UE may reset and/or restart the timer. In some examples, if the first UE cannot transmit a second sidelink HARQ feedback in response to a retransmission of PSCCH/PSSCH/PSFCH (e.g., the first UE is not able to transmit the second sidelink HARQ feedback due to LBT failing again, or due to no retransmission of PSCCH/PSSCH/PSFCH), the first UE does not start or restart the timer. In some examples, retransmission of PSCCH/PSSCH/PSFCH may be with the same HARQ process number of the second UE and NDI may not be toggled for the retransmission (e.g., whether NDI is toggled or not is based on NDI field in SCI scheduling retransmission and NDI field in SCI scheduling an initial/new transmission of PSCCH/PSSCH/PSFCH for a same TB/MAC PDU). An initial/new transmission may correspond to an initial and/or new transmission, such as a transmission that is not a retransmission.

In some examples, the first UE may set the counter to 0, set the counter to a start value or decrease a value of the counter when (e.g., in response to and/or upon) the first UE receives a PSCCH/PSSCH/PSFCH (e.g., a retransmission of the PSCCH/PSSCH/PSFCH) from the second UE. In some examples, the first UE increase the counter by a value (e.g., 1) once the first UE does not detect or receive a PSCCH/PSSCH/PSFCH (e.g., a retransmission of the PSCCH/PSSCH/PSFCH) from the second UE in a time unit. In some examples, the time unit may be at least one of a slot (e.g., one slot) in a sidelink resource pool, 1 ms, 1 reserved period value, 1 physical slot (regardless of whether or not the slot belongs to sidelink resource pool, for example). Alternatively and/or additionally, whether or not the first UE performs an action comprising setting the counter to 0, setting the counter to a start value or decreasing a value of the counter may be based upon whether or not the first UE transmits the sidelink HARQ feedback on another PSFCH resource. In some examples, if the first UE can transmit a second sidelink HARQ feedback in response to a retransmission of PSCCH/PSSCH/PSFCH (e.g., the first UE is able to transmit the second sidelink HARQ feedback due to LBT success), the first UE may perform an action comprising setting the counter to 0, setting the counter to a start value or decreasing a value of the counter. In some examples, if the first UE cannot transmit a second sidelink HARQ feedback in response to a retransmission of PSCCH/PSSCH/PSFCH (e.g., the first UE is not able to transmit the second sidelink HARQ feedback due to LBT failing again, or due to no retransmission of PSCCH/PSSCH/PSFCH), the first UE (i) may not set the counter to 0 or a start value, and/or (ii)may increase the counter by one. In some examples, the threshold is 32 (e.g., 32 slots). In some examples, the threshold is a predetermined and/or preconfigured value. In some examples, retransmission of PSCCH/PSSCH/PSFCH may be with the same HARQ process number of the second UE and NDI may not be toggled for the retransmission.

In some examples, the first UE determines a window from a timing of an original PSCCH/PSSCH/PSFCH that the sidelink HARQ feedback is in response to (e.g., the window starts from the timing of the original PSCCH/PSSCH/PSFCH). The timing of the original PSCCH/PSSCH/PSFCH may correspond to (i) an initial timing of a PSCCH and/or PSSCH transmission or (ii) a timing of a PSFCH that is in response to the initial timing of PSCCH/PSSCH transmission (e.g., a timing of a PSFCH comprising sidelink HARQ feedback that is in response to the PSCCH/PSSCH transmission). For example, the first UE may receive a PSCCH1 and/or a PSSCH1 from a second UE in slot n. The first UE may determine to transmit sidelink HARQ feedback on PSFCH in slot m, wherein the sidelink HARQ feedback is in response to the PSCCH1 and/or the PSSCH1. In some examples, the window starts from a starting symbol of (one of) slot n, slot m, slot n+1, or slot m+1 (e.g., a starting timing of the window may be one of slot n, slot m, slot n+1, or slot m+1). In some examples, before an end of the window (e.g., before an ending timing of a period of time corresponding to the window), if the first UE receives and/or detects a PSCCH/PSSCH/PSFCH (e.g., a retransmission of the PSCCH/PSSCH/PSFCH) from the second UE, the first UE may determine (e.g., re-determine) a starting timing of the window (e.g., an updated starting timing of the window). In some examples, before an end of the window, if the first UE can transmit the sidelink HARQ feedback on another PSFCH resource (e.g., in slot k different than slot n and slot m), the first UE may determine (e.g., re-determine) a starting timing of the window (e.g., an updated starting timing of the window). In some examples, a window length of the window is 32 slots. In some examples, the window length is a predetermined and/or preconfigured value. In some examples, before an end of the window, the first UE may retransmit the sidelink HARQ feedback on another PSFCH resource (e.g., a PSFCH resource different than the PSFCH associated with the original timing and/or the original PSCCH/PSSCH/PSFCH that the sidelink HARQ feedback is in response to). In some examples, retransmission of PSCCH/PSSCH/PSFCH may be with the same HARQ process number of the second UE and NDI may not be toggled for the retransmission. In some examples, the first UE may transmit the sidelink HARQ feedback on a PSCCH/PSSCH/PSFCH at and/or after a time and/or slot corresponding to a sum of the window length and one of slot n, n+1, m, or m+1 (e.g., if the window length is 32 slots and the starting timing of the window is slot n, the first UE may transmit the sidelink HARQ feedback on a PSCCH/PSSCH/PSFCH at and/or after slot n+32).

In some examples, in response to expiration of a timer, a counter reaching a threshold and/or reaching an end of a window (and/or after the window), the first UE may trigger resource selection for transmitting the sidelink HARQ feedback on PSCCH/PSSCH/PSFCH. In mode-1 (e.g., sidelink resource allocation mode 1), the first UE may transmit a request, to a network node, for requesting one or more sidelink resources. In mode-2 (e.g., sidelink resource allocation mode 2), the first UE may select, based upon a sensing result (regardless of whether the sensing result is determined via full sensing, partial sensing, or no sensing, for example), one or more resources (e.g., one or more PSCCH/PSSCH/PSFCH resources) for transmitting the sidelink HARQ feedback.

In some examples, transmitting sidelink HARQ feedback on PSCCH/PSSCH/PSFCH may be for a sidelink resource pool without PSFCH (e.g., the first UE may use PSCCH and/or PSSCH for transmitting sidelink HARQ feedback in accordance with the techniques herein when the first UE is configured with a sidelink resource pool without PSFCH). Alternatively and/or additionally, transmitting sidelink HARQ feedback on PSCCH/PSSCH/PSFCH (rather than only using PSFCH to transmit sidelink HARQ feedback, for example) may be performed for a sidelink resource pool with PSFCH (e.g., the first UE may use PSCCH/PSSCH/PSFCH for transmitting sidelink HARQ feedback in accordance with the techniques herein when the first UE is configured with a sidelink resource pool with PSFCH). In some examples, transmitting sidelink HARQ feedback on PSCCH/PSSCH/PSFCH may be a hybrid of blind retransmission and HARQ-based retransmission (e.g., the first UE may transmit sidelink HARQ feedback on PSCCH/PSSCH/PSFCH using one or more features of blind retransmission and one or more features of HARQ-based retransmission). In Rel-16 NR V2X, there may be a PSFCH occasion, in a sidelink resource pool, within a time gap between two sidelink slots for PSSCH carrying the same TB. For example, when TB is associated with enabled sidelink HARQ feedback, Rel-16 UE may not perform sidelink transmission on both of the two sidelink slots if a restriction on PSFCH occasion and/or time gap is not satisfied. However, according to some embodiments of the present disclosure, PSCCH/PSSCH/PSFCH may be used to transmit sidelink HARQ feedback, and the restriction may not be applicable (e.g., the restriction may not prevent the first UE from using PSCCH/PSSCH/PSFCH to transmit the sidelink HARQ feedback). In some examples, transmitting sidelink HARQ feedback on PSCCH/PSSCH/PSFCH may be for UE not prioritizing transmitting PSFCH (e.g., prioritizing UL or PSFCH reception). For example, the first UE may use PSCCH/PSSCH/PSFCH for transmitting sidelink HARQ feedback in accordance with the techniques herein when the first UE prioritizes UL transmission and/or PSFCH reception over PSFCH transmission. In some examples, transmitting sidelink HARQ feedback on PSCCH/PSSCH/PSFCH may be for UE performing sidelink transmission on unlicensed spectrum (e.g., band n46/n96/n102). For example, the first UE may use PSCCH/PSSCH/PSFCH for transmitting sidelink HARQ feedback in accordance with the techniques herein when the first UE performs sidelink transmission on unlicensed spectrum. In some examples, one rationale is that there may be no idle duration of a previous FFP before a PSFCH (e.g., each PSFCH) since the PSFCH may be in a middle portion of FFP.

In some examples, SCI (1-st stage SCI or 2-nd stage SCI) may provide information that indicates whether to use PSSCH and/or PSFCH for delivering and/or transmitting sidelink HARQ feedback.

In some examples, SCI (1-st stage SCI or 2-nd stage SCI) may provide information that indicates whether or not the SCI and/or a sidelink assignment comprise information related to one or more sidelink HARQ feedbacks. In some examples, in response to a TX UE receiving the SCI (e.g., the TX UE may be different than the first UE), the TX UE may identify a HARQ process associated with the SL HARQ feedback (e.g., the TX UE may determine which HARQ process is associated with the SL HARQ feedback). Association of one or more sidelink HARQ feedbacks (e.g., sidelink HARQ feedbacks in SCI and/or sidelink assignment) with one or more HARQ processes of the TX UE may be based upon explicit indication and/or implicit indication. For example, the explicit indication and/or implicit indication may indicate which HARQ process (of the TX UE, for example) is associated with a sidelink HARQ feedback (in SCI and/or sidelink assignment). In an example of the explicit indication, the first UE may indicate a HARQ process number for SL HARQ feedback (e.g., the first UE may indicate which HARQ process number is for SL HARQ feedback). In some examples, the HARQ process number for the SL HARQ feedback is based upon the first UE’s HARQ process number. Alternatively and/or additionally, the HARQ process number for the SL HARQ feedback may be based upon the TX UE’s HARQ process number and/or based upon a HARQ process number indicated by a first SCI, which schedules a sidelink transmission (from the TX UE, for example) that the sidelink HARQ feedback is in response to. In an example of the implicit indication, the first UE may transmit a plurality of sidelink HARQ feedbacks associated with a plurality of HARQ process numbers. For example, the plurality of sidelink HARQ feedbacks may comprise X sidelink HARQ feedbacks, which may be indicated by X bits associated with X HARQ process numbers. The first UE may transmit the X bits. An order of the X bits may be based upon increasing or decreasing order, and/or may be based upon one or more HARQ process numbers (e.g., the X HARQ process numbers). For example, the order of the X bits may be based upon increasing or decreasing order of the X HARQ process numbers. In some examples, the HARQ process number is based upon the TX UE’s HARQ process number and/or based upon HARQ process number indicated by a first SCI, which schedules a sidelink transmission (from the TX UE, for example) that the sidelink HARQ feedback is in response to. Alternatively and/or additionally, the HARQ process number may be based upon the first UE’s HARQ process number. In an example, the first UE may receive a first SCI scheduling a sidelink transmission associated with HARQ Process Number (HPN)=2. In the example, HPN=2 indicated by the first SCI may be associated with TX UE’s HARQ process number (rather than being associated with the first UE’s HARQ process number, for example). It may be appreciated that the first UE may select a HARQ process number of the first UE, for example, a HARQ process number corresponding to HPN=3. In some examples, the first UE knows HPN=3 of itself is associated with HPN=2 of the TX UE. In some examples, based upon the association (between HPN=3 associated with the first UE and HPN=2 associated with the TX UE, for example), when the first UE transmits one or more sidelink HARQ feedbacks, the first UE would set (and/or determine) HPN=2 of the TX UE based upon a result of HPN=3 of the first UE (itself). In some examples, for one or more other locations/occasions other than HPN=2 (e.g., one or more other HPNs other than HPN=2), if the first UE does not have a received sidelink transmission from the TX UE, the first UE may set Negative Acknowledgement (NACK) or none on the one or more other locations/occasions (e.g., the UE may set the one or more other locations/occasions to NACK and/or none). In the present disclosure, the term “locations/occasions” may refer to locations and/or occasions. In some examples, for one or more other locations/occasions other than HPN=2 (e.g., one or more other HPN other than HPN=2), if the first UE does not have a received sidelink transmission from a UE that transmitted a request for sidelink HARQ feedback on PSCCH and/or PSSCH or that transmitted a request for retransmission of sidelink HARQ feedback, the first UE may set NACK or none on the one or more other locations/occasions (e.g., the UE may set the one or more other locations/occasions to NACK and/or none).

In some examples, TX UE and the first UE may have a common understanding about a size of X. In some examples, for unicast, TX UE and the first UE may have PC5-RRC signaling to have a size of X (e.g., the PC5-RRC signaling may be generated to have a size corresponding to X). In some examples, for groupcast, TX UE and the first UE may have a group-specific signaling to have a size of X (e.g., the group-specific signaling may be generated to have a size corresponding to X). In some examples, size of X may be associated with at least one of a pool, a BandWidth Part (BWP), one or more LBT bands, a carrier, a cast type, etc. (e.g., the size of X may be at least one of pool-specific, BWP-specific, LBT bands-specific, carrier-specific, cast type-specific, etc.).

In some examples, a first SCI (1-st stage SCI or 2-nd stage SCI) from TX UE may provide information that indicates whether or not to request a previous and/or pending sidelink HARQ feedback. In response to the first UE receiving the first SCI, the first UE may transmit one or more sidelink HARQ feedbacks (on PSSCH and/or PSCCH and/or PSFCH, for example) associated with one or more sidelink HARQ processes. In response to receiving the first SCI, the first UE may transmit one or more NDIs associated with the one or more sidelink HARQ processes. Before sidelink transmission, the TX UE may perform sensing on the channel. In some examples, the first SCI schedules sidelink transmission and the request.

In some examples, one or more sidelink HARQ feedbacks in response to one or more sidelink transmissions may be transmitted together. In some examples, one or more sidelink HARQ feedbacks transmitted in a same PSCCH and/or a same PSSCH are associated with (e.g., in response to) one or more sidelink transmissions from a same TX UE. Alternatively and/or additionally, one or more sidelink HARQ feedbacks transmitted in a same PSCCH and/or a same PSSCH may be associated with a same source ID (source identity) (e.g., the one or more sidelink HARQ feedbacks may be associated with the same layer-2 source ID). In some examples, one or more sidelink HARQ feedbacks transmitted in a same PSCCH and/or a same PSSCH may not be allowed to be associated with (e.g., in response to) one or more sidelink transmissions from different TX UEs and/or may not be allowed to be associated with different source IDs (e.g., different layer-2 source IDs).

In some examples, one or more sidelink HARQ feedbacks may be associated with a plurality of sidelink HARQ processes (in a MAC entity, for example). The plurality of sidelink HARQ processes may correspond to a plurality of HARQ process for sidelink (in a MAC entity, for example). In some examples, one or more sidelink HARQ feedbacks transmitted in a same PSCCH and/or a same PSSCH may be associated with (e.g., in response to) a plurality of sidelink HARQ processes associated with a same source ID (e.g., a same layer-2 source ID). In some examples, one or more sidelink HARQ feedback transmitted in a same PSCCH and/or a same PSSCH may not be (and/or may not be allowed to be) not allowed to be associated with (and/or in response to) sidelink HARQ processes associated with different source IDs (e.g., different layer-2 source IDs).

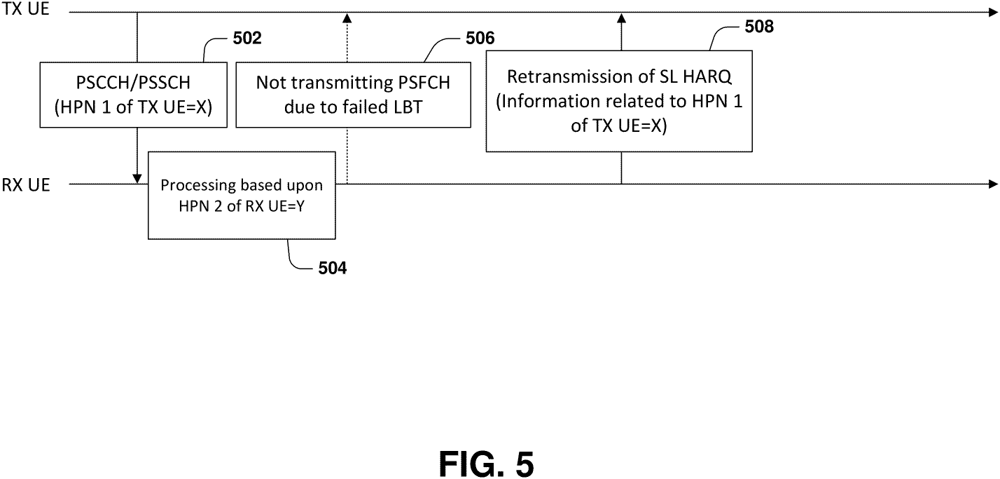

FIG. 5 illustrates an example scenario in which a RX UE receives a PSCCH/PSSCH 502 (e.g., a PSCCH and/or a PSSCH) from a TX UE. A first HPN (e.g., “HPN 1” in FIG. 5) of the TX UE is equal to X (e.g., HPN 1 = X may be the TX UE’s HPN for the PSCCH/PSSCH 502). A second HPN (e.g., “HPN 2” in FIG. 5) of the RX UE is equal to Y (e.g., HPN 2 = Y may be the RX UE’s HPN for the PSCCH/PSSCH 502). In some examples, the TX UE may transmit an indication of HPN 1 = X of the TX UE to the RX UE (e.g., the PSCCH/PSSCH 502 may comprise the indication). The RX UE may process 504 the PSCCH/PSSCH 502 based upon HPN 2 = Y of the RX UE. In some examples, at 506, the RX UE may fail to pass LBT (e.g., a sensing result of the LBT may indicate busy) for transmitting SL HARQ feedback on a first PSFCH in response to the PSCCH/PSSCH 502 from TX UE (e.g., the SL HARQ feedback may be indicative of whether or not the PSCCH/PSSCH 502 is successfully received by the RX UE). In some examples, the RX UE may perform a retransmission 508 of the SL HARQ feedback to the TX UE. In some examples, the RX UE may perform the retransmission 508 in response to a request from the TX UE. In some examples, the SL HARQ feedback is carried by 1-st stage SCI, 2-nd stage SCI, MAC CE and/or a second PSFCH (different than the first PSFCH). In some examples, the RX UE transmits Z SL HARQ feedbacks to the TX UE (e.g., the Z SL HARQ feedbacks may be transmitted via the retransmission 508). In some examples, Z may be 16, and the Z SL HARQ feedbacks may comprise 16 SL HARQ feedbacks associated with 16 of a plurality of HARQ processes of the TX UE. In some examples, in a scenario in which there is no other transmission with other HPNs other than HPN 1 = X from the TX UE, the RX UE may set NACK for the other HPNs. In some examples, the RX UE may set information for HPN 1 = X based upon a processing result (e.g., a result of processing 504 the PSCCH/PSSCH 502) which may be Acknowledgement (ACK) (indicating acknowledgment of reception of the PSCCH/PSSCH 502) or NACK (indicating negative acknowledgment of reception of the PSCCH/PSSCH 502). The retransmission 508 may be based upon HPN 1 = X of the TX UE (instead of HPN 2 = Y of the RX UE, for example). For example, the retransmission 508 may indicate that the SL HARQ feedback associated with the PSCCH/PSSCH 502 corresponds to HPN 1 = X of the TX UE. In this way, based upon the retransmission 508, the TX UE may correlate the SL HARQ feedback to the PSCCH/PSSCH 502 associated with the TX UE’s HPN 1 = X (and/or the TX UE may determine, using the retransmission 508, whether or not the PSCCH/PSSCH 502 was successfully received by the RX UE).

A concept of the present disclosure may be to have an exemption for PSFCH in unlicensed spectrum. A network node may provide a configuration that configures an occupying time duration for PSFCHs during an interval to not be larger than a threshold. For example, the configuration may satisfy a condition that an occupying time duration for PSFCHs during the interval is not larger than the threshold. In an example, the interval may be 100 ms, and the threshold may be 10 ms. In the example, the configuration may satisfy a condition that an occupying time duration for PSFCHs does not exceed 10 ms during a 100 ms interval. Other values of the interval and/or the threshold are within the scope of the present disclosure. An exemption configuration (e.g., a configuration for the network node to have exemption) for PSFCH may depend on (i) a configuration of PSFCH periodicity (e.g., the PSFCH periodicity may be in units of sidelink slots) in a sidelink resource pool, and/or (ii) a bit-map indicating sidelink slots in a sidelink resource pool. Based upon the bit-map, a number of sidelink slots belonging to a sidelink resource pool during the interval may be determined. Based upon the PSFCH periodicity, a number of sidelink slots comprising PSFCH during the interval may be determined. An exemption configuration associated with the network node and PSFCH (e.g., a configuration for the network node to have exemption for PSFCH) may satisfy the following equation

$$\frac{2}{14} \times 100 \times S \% \times \frac{1}{P} \leq 10.$$

Alternatively and/or additionally, an exemption configuration associated with the network node and PSFCH (e.g., a configuration for the network node to have exemption for PSFCH) may satisfy the following equation

$$\frac{2}{14} \times 100 \times \frac{Z}{Y} \times \frac{1}{P} \leq 10.$$

In some examples, P corresponds to a PSFCH periodicity. In some examples, S corresponds a number of sidelink slots belonging to a sidelink resource pool during an interval (e.g., a 100 ms interval). In some examples, Z may correspond to a number of bits with value 1 in the bit-map (e.g., Z bits). In some examples, a size of the bit-map is Y bits. In some examples, S% may be based upon Z and Y (and/or one or more other values). In some examples, S% may be equal to

$$\frac{Z}{Y} .$$

In some examples, S% may be smaller than Z/Y. In some examples, there may be one or more candidate values of S and/or S%. Preferable, S and/or S% may be configured (e.g., preconfigured). In some examples, S and/or S% may be configured as (and/or provided with) thesmallest candidate value, of one or more candidate values of S and/or S%, that is larger than

$$\frac{Z}{Y}$$

(e.g., when the one or more candidate values include one or more candidate values that are larger than

$$\frac{Z}{Y} ,$$

S and/or S% may be set to the smallest value of the one or more candidate values). In some examples, a value of S is a smallest integer value larger than Z/Y ×100. In some examples, for exempted PSFCH transmission, configuration (e.g., an exemption configuration) for a sidelink resource pool would satisfy above equation.

In a first example, a 10 bit bit-map (e.g., a bit-map consisting of 10 bits) with 6 bits with value 1 (e.g., 6 bits of the bit-map are set to 1) may be used for configuring and/or determining sidelink slots for a sidelink resource pool. In the first example, when 100 mscomprises 100 slots, and there are 60 sidelink slots for the sidelink resource pool, S may be 60 (e.g., S% may correspond to

$$\frac{Z}{Y} ,$$

which may correspond to 60/100 = 60%). In some examples, PSFCH periodicity may be at least one of 1, 2, 4

$$\left(\text{since P} \geq \frac{60 \%}{0.7} , \text{for example}\right) .$$

In a second example, PSFCH periodicity may be 1 (i.e. P=1). In some examples, an exemption configuration associated with PSFCH (e.g., configuration for exempted PSFCH) would be based upon a number of PSFCH slots during a 100 ms interval (or other size interval). In some examples, a number of bits with value 1 (i.e. Z) over a number of bits of a bit-map (i.e. Y) shall satisfy the following equation

$$\frac{2}{14} \times 100 \times \frac{z}{y} \times 1 \leq 10.$$

If Z and Y cannot satisfy the equation with the PSFCH periodicity of 1, LBT for PSFCH may be performed when a UE needs to transmit PSFCH (e.g., the PSFCH transmission may not be exempted from sensing requirement since the equation is not satisfied).

In some examples, a number of sidelink slots S (e.g., a number of sidelink slots, belonging to a sidelink resource pool, during a 100 ms interval) may be smaller than

$$100 \times \frac{z}{y} .$$

In an example, S may correspond to 90 (e.g., 90 slots for sidelink). In some examples, the bit-map for configuring and/or determining sidelink slot for a sidelink resource pool includes 6 bits of value 1 over 10 total bits (e.g., 6 bits of the 10 bit bit-map are set to 1). In some examples, the 100 ms interval may comprise one or more DL and/or UL slots (e.g., the one or more DL and/or UL slots may not be used for sidelink transmission). In an example,

$$100 m i l l i s e c o n d s \times \frac{Z}{Y}$$

may be replaced by a number of sidelink slots (e.g., sidelink slots for the sidelink resource pool)during a 100 ms interval. In the example in which S is equal to 90 (e.g., there are 90 sidelink slots, belonging to the sidelink resource pool, during the 100 ms interval), the PSFCH periodicity may satisfy the following equation

$$\frac{2}{14} \times 90 \times 0.6 \times \frac{1}{P} \leq 10$$

(e.g., based upon the equation,

$$\text{P} \geq \frac{10.8}{14}$$

). In some examples, PSFCH periodicity P may be 1, 2, 4.

In some examples, in accordance with one or more regulations for unlicensed spectrum, an exemption for transmission in unlicensed spectrum is applicable to at most S% time for the transmission during a time interval/duration. In one example, a device is not allowed to occupy more than 10 ms, over a 100 mstime interval, for transmitting an exempted transmission (e.g., a transmission exempted from sensing requirement).

In some examples, exempted PSFCH may be configured in one or more sidelink slots. In some examples, the one or more sidelink slots are configured (e.g., pre-configured). In some examples, the one or more sidelink slots are for exempted PSFCH. In some examples, the one or more sidelink slots are periodic (e.g., one or more sidelink slots for exempted PSFCH occur periodically according to a period). In some examples, the one or more sidelink slots are cluster-wise periodic (e.g., in every period with periodicity of L slots, there are Q consecutive sidelink slots that are LBT exempted for PSFCH transmission). In some examples, a slot which is available for sidelink (in a carrier and/or in a sidelink BWP, for example) may be denoted with logical slot index i. In some examples, slot i modulo W=offset may be configured as the one or more (exempted) sidelink slots (e.g., the one or more sidelink slots may correspond to slot i modulo W=offset). In some examples, slot i modulo W=offset may be reset periodically (e.g., every 100 ms). In some examples, W and/or offset may be configured (e.g., pre-configured) based upon carrier signaling (e.g., carrier-specific signaling) and/or sidelink BWP signaling (e.g., sidelink BWP-specific signaling). For example, W and/or offset may be configured for a carrier and/or a sidelink BWP. In an example, in a 100 ms interval, a slot of every 4 slots that are available for sidelink is indicated and/or configured as an exempted PSFCH slot. In another example, if there are 90 slots (i=0,1...89) that are available for sidelink transmission in a 100 ms interval, considering i modular 4 = 1 may be an exempted PSFCH slot (e.g., slot i=1, 5, 9...89 may be exempted PSFCH slots). In some examples, a slot which is available for sidelink transmission is for a PSCCH sidelink transmission, a PSSCH sidelink transmission, a PSFCH sidelink transmission and/or a SL CSI-RS sidelink transmission. In some examples, a slot which is available for sidelink transmission does not comprise a slot for Sidelink Synchronization Signal (SL-SS) transmission, PBCH transmission or Physical Sidelink Broadcast Channel (PSBCH) transmission.

In some examples, the one or more sidelink slots may be based upon sidelink slot allowed for a carrier or a sidelink BWP. In some examples, the one or more sidelink slots may be based upon a periodicity (e.g., W) and an offset (e.g., offset). In some examples, the one or more sidelink slots may be based upon a first bit-map (e.g., a specific bit-map). In some examples, the first bit-map may indicate a slot that is available for sidelink and that may have exempted PSFCH (e.g., a transmission performed in the slot may be exempted from sensing requirement). In some examples, a first sidelink resource pool with one or more configured and/or enabled PSFCH resources comprises a first slot and a second slot. In some examples, if the first slot, based upon a configuration of the first sidelink resource pool, has a PSFCH resource, whether or not the PSFCH resource in the first slot is exempted from LBT is based upon whether or not the first slot is configured and/or indicated as an exempted slot (e.g., if at least one of a signal, a configuration, etc. indicates that the first slot is an exempted slot and/or configures the first slot to be an exempted slot, one or more PSFCH resources in the first slot may be exempted from LBT). In some examples, if the first slot is configured and/or indicated as an exempted slot (e.g., if at least one of a signal, a configuration, etc. indicates that the first slot is an exempted slot and/or configures the first slot to be an exempted slot), the UE may transmit PSFCH in the first slot without performing LBT. In some examples, if the first slot is not configured and/or indicated as an exempted slot (e.g., if at least one of a signal, a configuration, etc. indicates that the first slot is not an exempted slot and/or configures the first slot not to be an exempted slot), the UE may perform LBT for accessing a channel for transmitting PSFCH in the first slot. In some examples, if the second slot, based upon configuration of the first sidelink resource pool, does not have PSFCH resource (e.g., if the configuration of the first sidelink resource pool does not configure PSFCH resource in the second slot), even if the second slot is configured and/or indicated as an exempted slot, the UE may not apply exemption in the second slot since there is no PSFCH resource in the second slot.

From network node point of view, a network node may configure one or more sidelink slots in an interval for PSFCH exemption (e.g., an interval with one or more exempted slots in which PSFCH transmission may be performed without performing LBT) such that the one or more sidelink slots satisfy a condition that PSFCH in (each of) the one or more sidelink slots in the interval does not span a duration of time that exceeds a threshold (e.g., 10 ms). In some examples, each of the one or more sidelink slots is considered as there are PSFCH transmission (regardless of whether or not there are actual PSFCH location based upon pool configuration, for example). In some examples, if there is PSFCH configured in a sidelink resource pool in a sidelink slot which is also from the one or more sidelink slot, PSFCH transmission in the slot may be exempted from LBT.

In some examples, a carrier-specific slot (e.g., a slot used in association with a carrier) and/or a sidelink BWP-specific slot (e.g., a slot used in association with a sidelink BWP) may be exempted from LBT for PSFCH transmission.

From PSFCH transmitter point of view, a UE may, at least based upon a configuration of a carrier-specific slot or sidelink BWP-specific slot, determine whether or not to perform LBT for transmitting PSFCH.

In some example, when a network node configures one or more sidelink slots in an interval for PSFCH exemption, the network node would consider (e.g., take into account) a Uu slot comprising a signaling being allowed for exempted. In some examples, the network would combine that time to have more conservative or a lower number of one or more sidelink slots in an interval for PSFCH exemption. For example, the network node may determine whether or not the interval for PSFCH exemption comprises a Uu slot that is associated with LBT exemption (e.g., the Uu slot may comprise a signaling that is exempted from LBT), and/or a number of Uu slots, in the interval, that are associated with LBT exemption). In an example, a number of sidelink slots configured by the network node in the interval may be lower if the interval for PSFCH exemption comprises a Uu slot compared to the interval for PSFCH exemption not comprising a Uu slot. Alternatively and/or additionally, a higher number of Uu slots in the interval may correspond to a lower number of sidelink slots configured by the network node in the interval.

In some examples, a pool configuration for a sidelink resource pool may be configured and/or enabled with PSFCH exemption, or PSFCH exemption may be disabled for the pool configuration and/or the sidelink resource pool (e.g., the pool configuration may configure and/or enable PSFCH exemption for the sidelink resource pool, or may disable PSFCH exemption for the sidelink resource pool). In some examples, for a sidelink resource pool which is configured and/or enabled with PSFCH exemption, a network node and/or the pool configuration may configure one or more pool-specific locations (e.g., pool-specific timings) for PSFCH exemption for the sidelink resource pool. In some examples, for a sidelink resource pool which is not configured and/or enabled with PSFCH resource (e.g., PSFCH periodicity is 0), a network node and/or the pool configuration may not be allowed to provide and/or configure pool-specific location for PSFCH exemption for the sidelink resource pool (e.g., a parameter for configuring pool-specific location for PSFCH exemption may be absent in the pool configuration). In some examples, a pool-specific location for PSFCH exemption may not be associated with (e.g., may not be used for) all PSFCH (e.g., all PSFCH transmissions and/or resources) in the sidelink resource pool. In some examples, a pool-specific location for PSFCH exemption may be associated with (e.g., may be used for) a subset of PSFCH (e.g., a subset of PSFCH transmissions and/or resources) in the sidelink resource pool. In some examples, a pool-specific location for PSFCH exemption may be associated with (e.g., may be used for) all PSFCH (e.g., all PSFCH transmissions and/or resources) in the sidelink resource pool. In some examples, a pool-specific location for PSFCH is not applied for another sidelink resource pool (e.g., the pool-specific location for PSFCH configured by the pool configuration may only be applied for the sidelink resource pool associated with the pool configuration).

In some examples, a pool-specific location for PSFCH exemption may be based upon a sidelink slot in the sidelink resource pool comprising a PSFCH resource. In some examples, a sidelink slot in the sidelink resource pool may be denoted as a logical slot index t. In some examples, t=0, P, 2P, 3P, 4P for (every, for example) P sidelink slots in the sidelink resource pool comprising PSFCH resource in that sidelink resource pool. For example, each set of P sidelink slots in the sidelink resource pool may comprise a PSFCH resource of the sidelink resource pool, wherein the PSFCH resource may be located in a g-th sidelink slot of the set of P sidelink slots. In an example in which g is P (e.g., corresponding to a last sidelink slot of a set of P sidelink slots), and P is 100, the sidelink resource pool may comprise a PSFCH resource at a 100th sidelink slot (e.g., 100 = 1×P) in the sidelink resource pool, a PSFCH resource at a 200th sidelink slot (e.g., 200 = 2×P) in the sidelink resource pool, a PSFCH resource at a 300th sidelink slot (e.g., 300 = 3×P) in the sidelink resource pool, etc. In some examples, a pool-specific location for PSFCH exemption may be an integer (or non-integer) multiple of P. In some examples, there may be a pool-specific location for PSFCH exemption every M×P sidelink slots in the sidelink resource pool. For example, each set of M×P sidelink slots in the sidelink resource pool may comprise a pool-specific location for PSFCH exemption, wherein the pool-specific location for PSFCH exemption may be located at a v-th sidelink slot of the set of P sidelink slots. In an example in which v is M×P (e.g., corresponding to a last sidelink slot of a set of M×P sidelink slots), is 3, and P is 100, the sidelink resource pool may comprise a pool-specific location for PSFCH exemption at a 300th sidelink slot (e.g., 300 = 1×M×P) in the sidelink resource pool, a pool-specific location for PSFCH exemption at a 600th sidelink slot (e.g., 600 = 2×M×P) in the sidelink resource pool, a pool-specific location for PSFCH exemption at a 900th sidelink slot (e.g., 900 = 3×M×P) in the sidelink resource pool, etc. In some examples, there may be a pool-specific location for PSFCH exemption every M PSFCH slots in the sidelink resource pool. For example, each set of M PSFCH slots in the sidelink resource pool may comprise a pool-specific location for PSFCH exemption, wherein the pool-specific location for PSFCH exemption may be located at a u-th PSFCH slot of the set of P PSFCH slots. In an example in which v is M (e.g., corresponding to a last PSFCH slot of a set of M PSFCH slots), and M is 3, the sidelink resource pool may comprise a pool-specific location for PSFCH exemption at a 3rd PSFCH slot (e.g., 3 = 1×M) in the sidelink resource pool, a pool-specific location for PSFCH exemption at a 6th PSFCH slot (e.g., 6 = 2×M) in the sidelink resource pool, a pool-specific location for PSFCH exemption at a 9th PSFCH slot (e.g., 9 = 3×M) in the sidelink resource pool, etc. In some examples, for every M×P sidelink slots in the sidelink resource pool, there may be pool-specific locations for PSFCH exemption at Q×P sidelink slots. For example, each set of M×P sidelink slots in the sidelink resource pool may comprise Q×P sidelink slots that each comprise a pool-specific location for PSFCH exemption. In some examples, for every M PSFCH slots in the sidelink resource pool, there may be pool-specific locations for PSFCH exemption at Q PSFCH slots (e.g., cluster-wise periodic indication). For example, each set of M PSFCH slots in the sidelink resource pool may comprise Q PSFCH slots that each comprise a pool-specific location for PSFCH exemption. In the present disclosure, a PSFCH slot in the sidelink resource pool may correspond to a sidelink slot, in the sidelink resource pool, that comprises (e.g., is configured with) one or more PSFCH resources. In some examples, a pool-specific location for PSFCH exemption may be indicated by a bit-map. In some examples, the bit-map may be applicable to PSFCH slots in the sidelink resource pool. For example, a bit-map of “10010” may indicate that each set of 5 PSFCH slots in a sidelink resource pool comprises 2 PSFCH slots associated with PSFCH exemption (e.g., PSFCH may be exempted for LBT in the 2 PSFCH slots), wherein locations of the 2 PSFCH slots may correspond to the first (e.g., initial and/or starting) slot of the set of 5 PSFCH slots and the fourth slot (e.g., 3 PSFCH slots after the first slot) of the set of 5 PSFCH slots.

In some examples, a SL BWP-specific slot format is applied for a SL BWP and/or a carrier-specific slot format is applied for a carrier. In some examples, a symbol location of PSFCH in each slot that is available for the SL BWP is the same (e.g., each slot available for the SL BWP may have PSFCH at the same symbol location). In some examples, a symbol location of PSFCH in each slot that is available for the carrier is the same (e.g., each slot available for the carrier may have PSFCH at the same symbol location). In some examples, for each slot that is available for the SL BWP or the carrier, a symbol location of PSFCH in the slot may be denoted as symbol index j and j+1 (e.g., j=11 within a 14 symbol slot with symbol indexes 0~13). In some examples, a SL BWP or a carrier may comprise one or more sidelink resource pools. In some examples, different sidelink resource pools may have different pool-specific locations for PSFCH exemption. In some examples, a slot may belong to a first sidelink resource pool and a second sidelink resource pool. In some examples, different sub-channels and/or Physical Resource Blocks (PRBs) in this slot may belong to different sidelink resource pools. In some examples, based upon a pool configuration of each sidelink resource pool, there are PSFCH resources in the slot belonging to both the first sidelink resource pool and the second sidelink resource pool. In some examples, based upon pool configurations of the first sidelink resource pool and/or the second sidelink resource pool, the slot in the first sidelink resource pool may be associated with PSFCH exemption (e.g., PSFCH in the slot in the first sidelink resource pool may be exempted from LBT requirement according to a pool configuration of the first sidelink resource pool) while the slot in the second sidelink resource pool may not be associated with PSFCH exemption (e.g., PSFCH in the slot in the second sidelink resource pool may not be exempted from LBT requirement according to a pool configuration of the second sidelink resource pool). Alternatively and/or additionally, in an example, the UE may determine (e.g., consider and/or derive) that a slot in a pool is associated with PSFCH exemption (e.g., is exempted from LBT requirement) due to another pool’s configuration (e.g., the slot in the second sidelink resource pool may be determined to be exempted from LBT requirement according to the pool configuration of the first sidelink resource pool), which may satisfy regulation in carrier-specific level. In other words, in some examples, once a sidelink resource pool in a carrier includes one or more slots (and/or locations and/or occasions) for PSFCH exemption, PSFCH exemption may be applied to the same one or more slots (and/or locations and/or occasions) in another sidelink resource pool in the carrier. In some examples, the first sidelink resource pool and the second sidelink resource pool are in the same carrier. In some examples, the first sidelink resource pool and the second sidelink resource pool are in same band. In some examples, the first sidelink resource pool and the second sidelink resource pool are in a same LBT band (e.g., 20 MHz). A PSFCH exemption associated with a slot in the first sidelink resource pool (e.g., the PSFCH exemption associated with the slot may be indicated by a pool configuration of the first sidelink resource pool) may be applied to the same slot in the second sidelink resource pool based upon based upon the first sidelink resource pool and the second sidelink resource pool being in the same carrier, the same band and/or the same LBT band. In some examples, when the first sidelink resource pool and the second sidelink resource pool are in different carriers, in different bands, and/or in different LBT bands, PSFCH exemption from another pool may be forbidden (e.g., the first UE may not be allowed to apply PSFCH exemption associated with the first sidelink resource pool to a slot in the second sidelink resource pool if the first sidelink resource pool and the second sidelink resource pool are in different carriers, in different bands, and/or in different LBT bands).

In some examples, signaling for inter-UE coordination information scheme 2 (and/or conflict indication) may be transmitted (i) in the same symbol location of PSFCH (e.g., a location of a symbol for PSFCH in a slot), and/or (ii) in different frequency resources. In some examples, PSFCH occasions for inter-UE coordination information scheme 2 (and/or conflict indication) may be in the same symbol(s) as PSFCH occasions for sidelink HARQ feedback in a same sidelink resource pool. In some examples, if a slot is configured (and/or indicated) as exempted PSFCH, a signal and/or PSFCH for inter-UE coordination information scheme 2 (and/or conflict indication) that is in the same slot (and/or the same symbol) may be exempted from LBT (based upon the slot being configured as exempted PSFCH, for example). In other words, in some examples, the UE may transmit the signal and/or PSFCH for inter-UE coordination information scheme 2 (and/or conflict indication) without performing LBT in the slot configured (and/or indicated) as exempted PSFCH.

In some examples, a location and/or occasion for PSFCH exemption (regardless of whether or not the location and/or occasion for the PSFCH exemption are pool-specific, carrier-specific, and/or SL BWP-specific, for example) may correspond to (and/or imply) a slot for PSFCH exemption. In some examples, a location and/or occasion for PSFCH exemption (regardless of whether or not the location and/or occasion for the PSFCH exemption are pool-specific, carrier-specific, and/or SL BWP-specific, for example) may correspond to (and/or imply) symbol j and j+1 in a slot for PSFCH exemption. In some examples, a location and/or occasion for PSFCH exemption (regardless of whether or not the location and/or occasion for the PSFCH exemption are pool-specific, carrier-specific, and/or SL BWP-specific, for example) does not correspond to (and/or does not imply or allow) a symbol other than j and j+1 (which is configured for PSFCH, for example) in the slot for PSFCH exemption. In some examples, a location and/or occasion for PSFCH exemption (regardless of whether or not the location and/or occasion for the PSFCH exemption are pool-specific, carrier-specific, and/or SL BWP-specific, for example) does not correspond to (and/or does not imply or allow) (i) a channel other than PSFCH, and/or (ii) a channel that does not overlap with PSFCH (e.g., signaling signal and/or PSFCH for inter-UE coordination information scheme 2 signaling) in symbols j and j+1 in the slot for exemption. For a slot that is available for sidelink and is associated with PSFCH exemption, if there are PSFCH resources in the slot, the UE may transmit PSFCH in the slot without performing LBT. For a slot that is available for sidelink and is associated with PSFCH exemption, if there are one or more PSCCH, PSSCH, CSI-RS and/or SS-PBCH resources in the slot, the UE may perform LBT for accessing channel for transmission on the one or more resources.

In some examples, based upon the PSFCH exemption discussed in the foregoing description, a UE, which may transmit PSFCH (and/or inter-UE coordination information scheme 2 and/or conflict indication), may transmit PSFCH (in a slot associated with the PSFCH exemption, for example) without performing LBT.

In some examples, based upon the PSFCH exemption discussed in the foregoing description, a UE, which may transmit PSFCH (and/or inter-UE coordination information scheme 2 and/or conflict indication), may not be configured (and/or allowed) to transmit (and/or may not transmit) PSCCH/PSSCH/SL SS/PBCH/CSI-RS in the same slot associated with the PSFCH exemption without performing LBT. In some examples, the UE shall perform LBT for transmitting the PSCCH/PSSCH/SL SS/PBCH/CSI-RS. In the present disclosure, the term “PSCCH/PSSCH/SL SS/PBCH/CSI-RS” may refer to PSCCH, PSSCH, SL SS, PBCH and/or CSI-RS.

Alternatively and/or additionally, if a PSFCH exemption (discussed in the foregoing description, for example) is applied for a slot associated with transmitting SL SS, PBCH and/or PSBCH, the UE may transmit the SL SS, the PBCH and/or PSBCH (in the slot associated with the PSFCH exemption, for example) without performing LBT. In some examples, transmission of SL SS, PBCH and/or PSBCH may comprise more than 2 symbols in the slot. In some examples, a requirement that a duration (e.g., an occupying time duration) for transmitting one or more exempted signals and/or channels in an interval be at most a threshold may be taken into account when determining whether or not to transmit the SL SS, the PBCH and/or the PSBCH without performing LBT (in the slot associated with the PSFCH exemption, for example).

A concept of the present disclosure may be that there is a period (e.g., FFP) for PSFCH. The period for PSFCH may include one or more PSFCHs (e.g., one or more PSFCH occasions/resources), such one or more periodic PSFCHs. The period for PSFCH may comprise an idle duration, which may be at the end of the period for PSFCH. The idle duration at the end of a current period for PSFCH may be used for sensing. When idle duration at the end of a current period for PSFCH is sensed as idle (e.g., in response determining a sensing result indicating the idle duration is idle), a UE (that performed sensing during the idle duration) may be allowed to perform (and/or may perform) PSFCH transmission in a next (consecutive) period for PSFCH. When idle duration at the end of a current period for PSFCH is sensed as busy (e.g., in response determining a sensing result indicating the idle duration is busy), the UE may not be allowed to perform (and/or may not perform) PSFCH transmission in a next (consecutive) period for PSFCH. When a first UE receives a sidelink transmission from a second UE, wherein the sidelink transmission is indicative of enabled sidelink HARQ feedback, the first UE may determine (e.g., derive) a slot to use for transmitting sidelink feedback (e.g., SL HARQ on PSFCH, or SL HARQ on PSSCH) based upon an association between a slot carrying the sidelink transmission and the slot to use for transmitting (and/or carrying) the sidelink feedback. The sidelink feedback is in response to the sidelink transmission from the second UE. The first UE may perform sensing on an idle duration of a first period (e.g., a first FFP) for the sidelink feedback, wherein the first period (and/or the idle duration of the first period) is before a second period (e.g., a second FFP) that includes a derived timing for transmitting the sidelink feedback (e.g., the derived timing may correspond to the slot the first UE determines to use for transmitting the sidelink feedback). Based upon a sensing result of the sensing performed on the idle duration of the first period (and/or based upon other information in addition to the sensing result, for example), the first UE may determine whether or not to transmit PSFCH via the derived timing in the second period.

The first UE may be provided with information related to a Channel Occupancy Time (COT) initiator for the sidelink feedback and/or the PSFCH.

When the first UE is provided (by the second UE, for example) with information indicating that a COT initiator for the sidelink feedback corresponds to (e.g., is based upon) other UE different than the first UE (e.g., the other UE may be the second UE), the first UE may determine (e.g., verify and/or validate) whether or not there is a second sidelink transmission from the second UE in the slot the first UE determines (e.g., derives) for transmitting the sidelink feedback (e.g., the first UE determines to transmit the sidelink feedback in the slot). In some examples, the second sidelink transmission is transmitted by the second UE (and/or by one or more other UEs in addition to the second UE). In some examples, one or more destination UEs of the second sidelink transmission comprise the first UE (and/or one or more other UEs in addition to the first UE). In some examples, the second sidelink transmission may be unicast, groupcast, or broadcast.

When the first UE is provided (by the second UE, for example) with information indicating that a COT initiator for the sidelink feedback corresponds to (e.g., is based upon) the first UE, the first UE may determine (e.g., verify and/or validate) whether or not there is a COT that is initiated by the first UE and that includes a timing for transmitting the sidelink feedback. If the first UE has initiated COT covering (e.g., overlapping with, such as fully overlapping with) the timing for transmitting the sidelink feedback, the first UE may perform (e.g., further perform) short sensing (e.g., sensing over a duration of time that is smaller than a threshold duration) if a gap between timing for transmitting the sidelink feedback and timing of a sidelink burst from the first UE is larger than a threshold. In some examples, the sidelink burst corresponds to one or more sidelink transmissions from the first UE, wherein gaps in time domain between each pair of (consecutive) sidelink transmissions of the one or more sidelink transmissions is at most a threshold (e.g., there may be a gap of at most 16 microseconds between any two consecutive sidelink transmission in a sidelink burst). If the first UE does not have an initiated COT covering (e.g., overlapping with, such as fully overlapping with) timing for transmitting the sidelink feedback, the first UE may perform (e.g., further perform) short sensing during idle duration of a preceding period (e.g., a preceding FFP) for PSFCH (e.g., the preceding period may be before the timing for transmitting the sidelink feedback). Once the first UE determines (e.g., detects and/or checks) the channel is idle during the idle duration of the preceding period for PSFCH (e.g., in response to the determination that the channel is idle), the first UE may transmit the sidelink feedback. In some examples, if the first UE has initiated COT in a period (e.g., a period, such as FFP, for PSSCH) but the timing of the sidelink feedback is within idle duration of the period, the first UE may not be allowed to transmit (and/or the first UE may not transmit) the sidelink feedback. In some examples, the first UE not transmitting the sidelink feedback may correspond to the first UE dropping (transmission of) the sidelink feedback. In some examples, however, the first UE is provided with information indicating that the COT initiator is different than the first UE, even if the timing of the sidelink feedback overlaps with the first UE’s idle duration of the first UE’s period (e.g., a period, such as FFP, for PSSCH), the first UE may perform sensing and the first UE may transmit the sidelink feedback (if the sensing result is idle, for example).

A length (e.g., a duration) of the period (e.g., FFP) for PSFCH may be based upon a periodicity of PSFCH (e.g., periodicity of PSFCH for sidelink HARQ feedback) and/or based upon other information in addition to the periodicity of PSFCH. The length of the period for PSFCH may be an integer and/or may correspond to a periodicity of PSFCH (e.g., the length may correspond to an integer number of periodicity of PSFCH). A symbol offset applied to the period for PSFCH may be based upon a symbol location of PSFCH (e.g., a symbol location of PSFCH in a slot) and/or based upon other information in addition to the symbol location. A beginning of the period for PSFCH (e.g., a starting time of the period, a starting slot of the period, a starting symbol of the period) may be based upon the symbol offset (and/or based upon other information in addition to the symbol offset). The symbol offset may be not configured by gNB. The symbol offset may be determined (e.g., implicitly determined and/or derived) by a UE based upon a symbol location of PSFCH (e.g., a symbol location of PSFCH in a slot). In some examples, the slot is the earliest slot (in a sidelink resource pool) with respect to a subframe (and/or a slot) with even index of System Frame Number (SFN)=0 and/or Direct Frame Number (DFN)=0. The UE may determine (e.g., derive) the beginning of the period for PSFCH based upon the symbol offset (and/or based upon other information in addition to the symbol offset). For example, the symbol offset may be implicitly determined (e.g., implicitly derived) by the UE based upon a symbol location of PSFCH in a slot. In some examples, the slot is the earliest slot (in a sidelink resource pool) with respect to a subframe (and/or a slot) with even index of SFN and/or DFN. The UE may determine (e.g., derive) the beginning of the period for PSFCH based upon the symbol offset (and/or based upon other information in addition to the symbol offset).

In some examples, a length of the period for PSFCH may be 1 ms (e.g., the length of the period may always be 1 ms, such as where periods for PSFCH each have a fixed length of 1 ms).

In some examples, a length of the period for PSFCH may be 1 slot (e.g., the length of the period may always be 1 slot, such as where periods for PSFCH each have a fixed length of 1 slot).

In some examples, Subcarrier Spacing (SCS) for the 1 slot may be based upon SCS of a SL carrier, a SL BWP and/or a SL resource pool.

In some examples, SCS for the 1 slot may be based upon a smallest SCS associated with one or more serving SL carriers.

In some examples, SCS for the 1 slot may be based upon a smallest SCS associated with one or more unlicensed serving SL carriers.

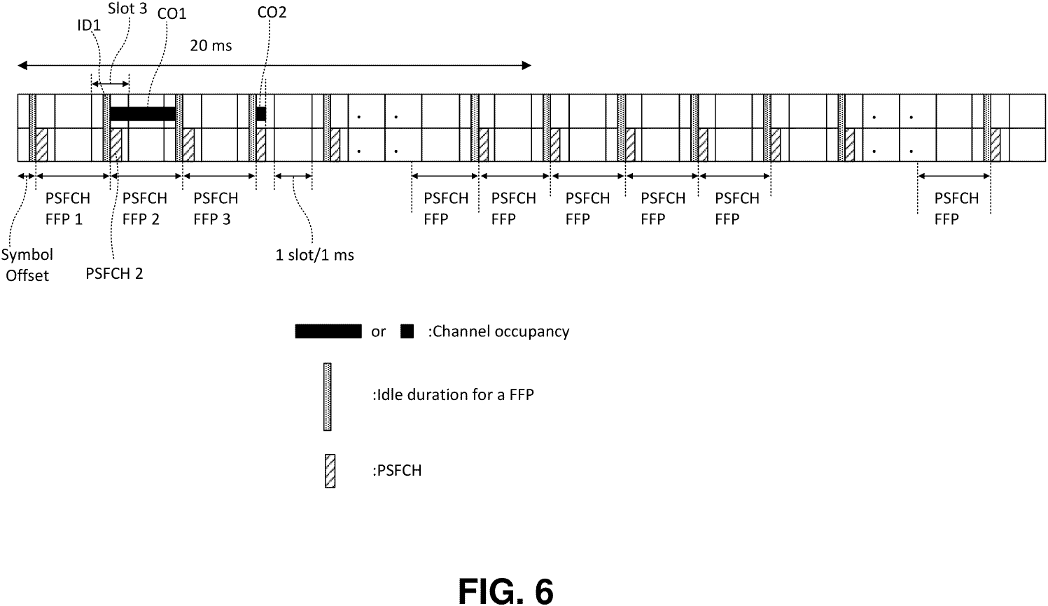

FIG. 6 illustrates a diagram showing periods for PSFCH (e.g., PSFCH FFPs). FIG. 6 illustrates PSFCH (e.g., PSFCH resource) with diagonal line-filled rectangles, idle durations of periods (e.g., FFPs) with dot-filled rectangles, and channel occupancy with black-filled rectangles and/or squares. In the example shown in FIG. 6, a symbol offset may correspond to a PSFCH location in a slot (e.g., a timing of PSFCH in the slot). For example, based upon PSFCH starting from symbol 11 of a slot, the symbol offset may be 11. A length of a period for PSFCH (e.g., length of PSFCH FFP) may be based upon (e.g., may be equal to) a periodicity of PSFCH, which is 2 slots in FIG. 6. In the example shown in FIG. 6, if a RX UE needs to transmit PSFCH in a slot “slot 3” in response to a sidelink transmission, the RX UE may perform sensing (during idle duration “ID1”, for example) before the FFP “PSFCH FFP 2” (e.g., FFP for PSFCH) in slot 3. If a sensing result of the sensing performed by the RX UE is idle, the RX UE may transmit PSFCH in slot 3 (e.g., the PSFCH may be transmitted in a PSFCH resource “PSFCH 2” in slot 3). In some examples, a maximum channel occupancy may correspond to channel occupancy (e.g., channel occupancy “CO1” in FIG. 6 shown as a black rectangular) occupying 95% (or other amount) of the length of PSFCH FFP. In some examples, a maximum channel occupancy may correspond to channel occupancy (e.g., channel occupancy “CO2” in FIG. 6 shown as a black rectangular) aligning symbols occupied by PSFCH (e.g., 2 symbols in a slot). In some examples, an ending (e.g., ending time position) of channel occupancy (for PSFCH, for example) is limited to ending slot boundary. Alternatively and/or additionally, an ending (e.g., ending time position) of channel occupancy (for PSFCH, for example) may be limited to an ending symbol (e.g., last symbol, such as second symbol) of PSFCH (in a slot, for example). In some examples, a beginning (e.g., starting time position) of channel occupancy (for PSFCH, for example) may be limited to an initial symbol (e.g., starting symbol preceding the second symbol) of PSFCH (in a slot, for example).

In some examples, a length of the period (e.g., FFP) for PSFCH may be 1 ms, 2 ms, 2.5 ms, 4 ms, 5 ms, or 10 ms.

In some examples, the period (e.g., FFP) for PSFCH is fixed and/or specified.

In some examples, the period (e.g., FFP) for PSFCH may correspond to (e.g., may be based upon) a timing of PSFCH to an ending slot boundary of a slot or to last symbol (e.g., gap symbol) for sidelink.

In some examples, the period (e.g., FFP) for PSFCH is configured by gNB and/or is based upon a pre-configuration.

In some examples, configuration for the period (e.g., FFP) for PSFCH may be associated with sidelink resource pool configuration.

In some examples, configuration for the period (e.g., FFP) for PSFCH may be associated with SL BWP and/or SL carrier configuration.

In some examples, configuration for the period (e.g., FFP) for PSFCH may be common for UEs in a sidelink resource pool (e.g., the UEs in the sidelink resource pool may share the same period).

In some examples, configuration for the period (e.g., FFP) for PSFCH may be common for UEs in a SL BWP and/or a SL carrier (e.g., the UEs in the SL BWP and/or the SL carrier may share the same period).

A first UE may have multiple (e.g., two) types of UE FFP. The multiple types of UE FFP comprises a first type of UE FFP and a second type of UE FFP. The first type of UE FFP (e.g., period for PSFCH) is associated with PSFCH. The second type of UE FFP (e.g., period for PSSCH) is associated with PSSCH.

The first UE may have sidelink communication with a second UE. Sidelink communication may be unicast sidelink transmission, groupcast sidelink transmission (including the second UE within a group of destination UEs, for example), or broadcast sidelink transmission. The first UE may receive and/or detect a sidelink transmission (e.g., PSCCH and/or PSSCH) from the second UE. The sidelink transmission (e.g., SCI in PSCCH) may indicate to (e.g., instruct and/or require) the first UE to transmit sidelink feedback (e.g., sidelink HARQ feedback) in response to the sidelink transmission. The sidelink transmission may further indicate information associated with (e.g., indicative of) whether or not the first UE initiates COT for transmitting PSFCH (and/or whether or not the first UE is a COT initiator for transmitting PSFCH). The first UE may determine a timing (e.g., a slot) of PSFCH based upon PSFCH configuration (e.g., periodicity of PSFCH) and/or based upon an association between PSSCH and PSFCH (e.g., the association may correspond to a time gap for processing and/or HARQ Round Trip Time (RTT) between PSSCH and corresponding PSFCH).

In an example scenario, the first UE may be indicated (e.g., instructed) to initiate COT for transmitting PSFCH. In some examples, such as in the example scenario in which the first UE is indicated (e.g., instructed) to initiate COT for transmitting PSFCH, if the first UE has initiated COT (in a FFP associated with the second type of UE FFP, for example), the first UE may perform CAT2-LBT for performing PSFCH transmission after sensing the channel is idle (e.g., after sensing the channel is idle via the CAT2-LBT performed by the first UE). In some examples, such as in the example scenario in which the first UE is indicated (e.g., instructed) to initiate COT for transmitting PSFCH, if the first UE has initiated COT (in a FFP associated with the first type of UE FFP, for example), the first UE may perform CAT2-LBT for performing PSFCH transmission after sensing the channel is idle (e.g., after sensing the channel is idle via the CAT2-LBT). In some examples, if the channel is sensed as busy (by performing the CAT2-LBT, for example), the first UE (i)may not transmit PSFCH in response to the sidelink transmission, (ii) may drop PSFCH and/or (iii) may store sidelink feedback. In some examples, the first UE may not transmit PSFCH in response to the sidelink transmission, wherein the first UE may receive a retransmission of a TB and/or MAC PDU transmitted in the sidelink transmission. In some examples, if there is a second PSFCH in response to the retransmission of the TB and/or MAC PDU, the first UE may transmit the stored sidelink feedback via the second PSFCH. In some examples, the first UE may consider (e.g., further consider) whether or not a (previous) initiated COT includes a determined timing of the (second) PSFCH. In some examples, when a timing of the (second) PSFCH transmission is within the first UE’s (previous) initiated COT, the first UE may not initiate a (additional) COT for transmitting the (second) PSFCH. In some examples, if a time gap between a timing of the determined (second) PSFCH and a previous sidelink transmission from the first UE is larger than a threshold (e.g., 16us), the first UE may transmit the (second) PSFCH in response to (e.g., upon) sensing the channel to be idle. In some examples, in the example scenario in which the first UE is indicated (e.g., instructed) to initiate COT for transmitting PSFCH, the first UE would determine (e.g., consider and/or derive) that the determined (second) PSFCH is performed using a COT initiated by (previous) initiated COT (initiated by the first UE, for example). In some examples, the previous initiated COT is based upon the first type of UE FFP or based upon the second type of UE FFP. When timing of the (second) PSFCH transmission is not within the first UE’s (previous) initiated COT, the first UE may initiate (additional) COT for transmitting the (second) PSFCH. Since timing of one or more PSFCHs is from the beginning of one or more of the first type of UE FFP, once the first UE senses the channel to be idle (during idle duration of previous consecutive FFP, for example), the first UE may transmit PSFCH.

In an example scenario, the first UE may be indicated (e.g., instructed) to use a shared COT from the second UE (e.g., a COT shared by the second UE). In some examples, such as in the example scenario in which the first UE is indicated (e.g., instructed) to use the shared COT, the first UE may not initiate COT associated with the first or the second type of UE FFP. The first UE may determine (e.g., verify and/or validate) whether or not there is a COT from the second UE in a slot including the determined PSFCH (e.g., the PSFCH may be determined in response to the sidelink transmission and/or may be determined for use in transmitting sidelink HARQ feedback in response to the sidelink transmission). In some examples, if the first UE cannot determine (e.g., cannot verify and/or validate) that there is a COT from the second UE (e.g., the UE cannot identify a COT from the second UE in the slot including the determined PSFCH), the first UE does not transmit PSFCH in response to the sidelink transmission and/or the first UE may drop PSFCH. In some examples, determination (e.g., verification and/or validation) of whether or not there is a COT from the second UE may be based upon a determination of whether or not there is a sidelink transmission (e.g., a specific sidelink transmission, such as SCI, PSCCH, PSSCH and/or PSFCH) from the second UE. For example, if the first UE determines to transmit PSFCH in slot n in response to the sidelink transmission, the first UE may determine (e.g., verify and/or validate) whether or not there is a PSSCH or SCI from the second UE in slot n. If the first UE has detected a specific sidelink transmission (e.g., SCI or PSSCH) from the second UE (in slot n, for example), the first UE may determine (e.g., verify and/or validate) that there is COT initiated by the second UE. In some examples, the first UE may transmit PSFCH in response to (e.g., upon) the first UE sensing the channel to be idle.

In some examples, a second UE may transmit a SCI to a first UE. In some examples, a time resource assignment (indicated by a time resource assignment field in the SCI, for example) in the SCI and/or frequency resource assignment (indicated by a time resource assignment field in the SCI, for example) in the SCI may indicate up to 3 sidelink resources in different slots for one TB. In some examples, a reserved period field in the SCI may indicate one or more future resources based upon an indicated reserved period (indicated by the reserved period field, for example). In some examples, a first UE may receive the SCI in slot n. In some examples, according to the SCI, the first UE may need to perform sidelink transmission in slot m which is indicated by (and/or derived using) the SCI. In some examples, when the first UE performs PSFCH in slot m on one or more symbols that are different than one or more reserved sidelink resources in slot m from the second UE (e.g., one or more sidelink resources in slot m reserved by the second UE), the first UE may transmit PSFCH in slot m in response to (e.g., upon) the first UE detecting and/or receiving the reserved sidelink resource from the second UE in slot m. In some examples, the first UE determines (e.g., verify and/or validate) whether or not there is COT initiated by the second UE in slot m based upon whether or not the first UE detects and/or receives a sidelink transmission (e.g., SCI, PSCCH, PSSCH and/or PSFCH) from the second UE. In some examples, information provided by the SCI in slot n may not guarantee there is a COT, initiated by the second UE, that covers slot m. In some examples, validation for COT initiated by the second UE in slot m is based upon at least whether or not there is a sidelink transmission (e.g., a specific sidelink transmission) from the second UE (e.g., the UE may not determine whether or not there is a COT initiated by the second UE in slot m based upon the SCI received in slot n). In some examples, a destination of the sidelink transmission (e.g., the specific sidelink transmission) from the second UE comprises the first UE (and/or one or more other UEs in addition to the first UE). In some examples, the sidelink transmission (e.g., the specific sidelink transmission) from the second UE for determining (e.g., verifying and/or validating) COT from the second UE may be unicast, groupcast, or broadcast. In some examples, a destination of the sidelink transmission (e.g., the specific sidelink transmission) from the second UE may not comprise the first UE.

In some examples, the first UE would check whether or not there is a COT in slot m from the second UE based upon a maximum time duration of COT in a FFP that covers slot m. In some examples, in accordance with one or more of the techniques provided herein, a COT covering slot m and/or a COT in slot m may correspond to (and/or may be replaced with) a COT that covers one or more symbols in slot m. In some examples, the first UE may check that there is a shared COT from the second UE (for transmitting one or more symbols, for example) based upon one or more symbols for sidelink in slot m (e.g., the one or more symbols may correspond to one or more earlier and/or initial symbols for sidelink in slot m or one or more last symbols for sidelink in slot m). For example, the first UE may just determine (e.g., verify and/or validate) that there is a COT from the second UE covering (e.g., overlapping with, such as fully overlapping with) the one or more symbols. In some examples, if the first UE cannot determine (e.g., cannot verify and/or validate) that there is a COT from the second UE covering (e.g., overlapping with, such as fully overlapping with) the one or more symbols, the first UE does not transmit PSFCH in response to the sidelink transmission received from the second UE and/or the first UE may drop PSFCH.

In some examples, from the first UE’s perspective, once the first UE knows which initiator’s COT (e.g., COT initiated by the first UE or COT initiated by the second UE) to use for a sidelink transmission (transmitted by the first UE), the first UE may know whether or not performing sidelink transmission on idle duration of FFP for the initiator’s COT is allowed. For example, if the first UE transmits PSFCH on COT initiated by the second UE, the first UE may not allowed be allowed to transmit (and/or does not transmit) sidelink transmission (e.g., any sidelink transmission) during idle duration of FFP for the COT associated with the second UE. In some examples, if the first UE transmits PSFCH on COT initiated by the second UE, the first UE may transmit sidelink transmission during idle duration of FFP for the COT associated with the first UE. For example, if the first UE transmits PSFCH on COT initiated by the first UE, the first UE may not allowed be allowed to transmit (and/or does not transmit) sidelink transmission (e.g., any sidelink transmission) during idle duration of FFP for the COT associated with the first UE. In some examples, if the first UE transmits PSFCH on COT initiated by the first UE, the first UE may transmit sidelink transmission during idle duration of FFP for the COT associated with the second UE.

In some examples, the first UE may determine (e.g., verify and/or validate) whether or not there is a COT initiated by the second UE based upon a time gap between slot n and slot m (and/or based upon other information in addition to the time gap). In some examples, when time gap between slot n and slot m is larger than a time gap threshold (e.g., length of FFP), the first UE may not be able to validate COT initiated by the second UE for slot m based upon the SCI detected in slot n. In some examples, when a time gap between slot n and slot m is smaller than or equal to the time gap threshold, the first UE can validate COT initiated by the second UE for slot m based upon the SCI detected in slot n. In some examples, for the time gap between slot n and slot m being smaller than or equal to the time gap threshold, detecting the SCI in slot n may assist the first UE to determine (e.g., verify and/or validate) that there is COT initiated by the second UE in slot m. In some examples, sensing for the channel in that COT initiated by the second UE may be based upon CAT 2 LBT.

In some examples, the first UE may determine (e.g., verify and/or validate) whether or not there is COT initiated by the second UE based upon whether or not slot n and slot m are in the same FFP or in different FFPs (and/or based upon other information in addition to whether or not slot n and slot m are in the same FFP or in different FFPs). In some examples, when both slot n and slot m are in same FFP (of the second UE, for example), in response to (e.g., upon) the first UE receiving and/or detecting the SCI in slot n, the first UE may determine (e.g., verify and/or validate) there is COT initiated by the second UE that covers (e.g., overlaps with, such as fully overlaps with) slot m. In some examples, when slot n and slot m are in different FFPs (of the second UE, for example), in response to (e.g., upon) the first UE receiving and/or detecting the SCI in slot n, the first UE cannot determine (e.g., cannot verify and/or validate) there is COT initiated by the second UE that covers (e.g., overlaps with, such as fully overlaps with) slot m based upon the SCI detected in slot n. In some examples, the SCI may further indicate whether or not there is COT initiated by the second UE. In some examples, the SCI may indicate information of COT initiator for one or more resources associated with time resource assignment, frequency resource assignment and/or reserved period field.

In some examples, symbol level offset for a FFP of a sidelink UE may be based upon a starting symbol for sidelink in a slot belonging to a sidelink resource pool. In some examples, the starting symbol for sidelink in a slot may be configured (e.g., pre-configured) via parameter sl-StartSymbol-r16. In some examples, StartSymbol-r16 may be provided and/or (e.g., pre-configured) as sym0, sym1, sym2, sym3, sym4, sym5, sym6, or sym7.

A concept of the present disclosure may be that there is association between FFP and sidelink slot in a sidelink resource pool. Since a configuration (e.g., a pre-configuration) may provide bit-map for indicating sidelink slots in the sidelink resource pool, sidelink slots in the sidelink resource pool may physically not be contiguous (and/or may physically not be consecutive) in time domain.

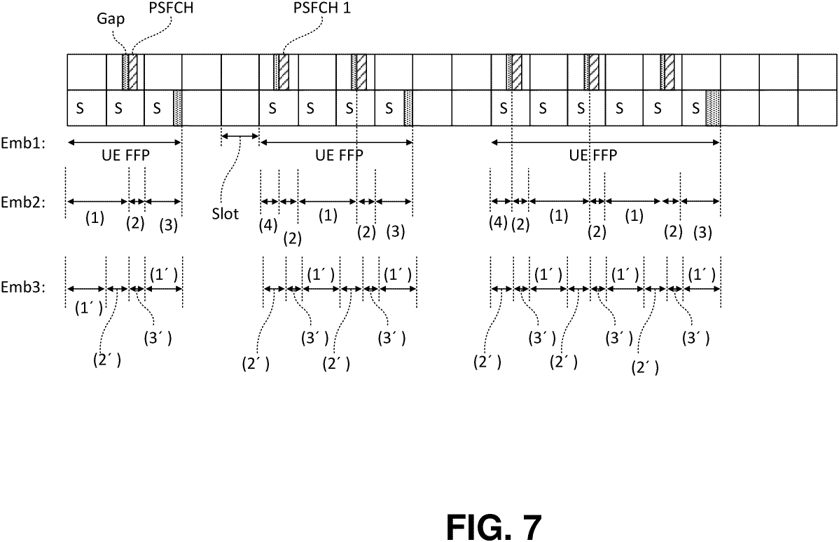

In a first embodiment, a length of FFP is based upon a number of slots of a plurality of consecutive slots (e.g., plurality of consecutive physical slots). In some examples, length of FFP may be a minimum value or a maximum value among (i) a FFP length (e.g., a fixed FFP length, a specified FFP length and/or a configured, such as pre-configured, FFP length) and (ii) a length (e.g., time duration) of the plurality of consecutive (physical) slots. In some examples, length of FFP may be a minimum value or maximum value among (i) a defined number of slots (e.g., a fixed number of slots, a specified number of slots and/or a configured, such as pre-configured, number of slots) and (ii) a number of slots of the plurality of consecutive (physical) slots. In some examples, the plurality of consecutive (physical) slots are associated with (e.g., belong to) the sidelink resource pool (e.g., the plurality of consecutive slots may correspond to sidelink slots of the sidelink resource pool). In some examples, according to the bit-map (provided by the configuration, for example), one cluster may correspond to a number of consecutive 1s in the bit-map and each cluster may comprise a same or different number of consecutive 1s. FIG. 7 illustrates a diagram showing a configuration of FFPs and/or slots. For example, in Emb1 (corresponding to the first embodiment, for example) in FIG. 7, there is a 20 bits bit-map being {11100111100111111000}. The bit-map may indicate (and/or may be used to determine, such as derive) which physical slots are associated with (e.g., belong to) the sidelink resource pool (e.g., the bit-map may indicate which physical slots are sidelink slots of the sidelink resource pool). In the example shown in FIG. 7, physical slots corresponding to sidelink slots of the sidelink resource pool are indicated with an “S”. Thus, according to the bit-map being {11100111100111111000}, the physical slots may include a cluster of three sidelink slots (marked with “S”) belonging the sidelink resource pool, followed by two slots that are not sidelink slots belonging to the sidelink resource pool, followed by a cluster of four sidelink slots belonging to the sidelink resource pool, followed by two slots that are not sidelink slots belonging to the sidelink resource pool, followed by a cluster of six sidelink slots belonging to the sidelink resource pool, followed by three slots that are not sidelink slots belonging to the sidelink resource pool. In some examples, PSFCH resource in the sidelink resource pool may occur every 2 sidelink slots of the sidelink resource pool (e.g., there may be a PSFCH resource in each set of 2 sidelink slots of the sidelink resource pool). The first UE FFP may comprise 3 (physical) slots. The second UE FFP may comprise 4 (physical) slots. The third UE FFP may comprises 6 (physical) slots. Alternatively and/or additionally, the last 6 (physical) slots in FIG. 7 may be dividable into two UE FFP comprising 4 (physical) slots and 2 (physical) slots due to a defined maximum length of FFP (e.g., a fixed maximum length of FFP, a specified maximum length of FFP and/or a configured, such as pre-configured, maximum length of FFP), which may correspond to 4 slots. A first UE may transmit PSFCH (e.g., “PSFCH 1” in FIG. 7) using 4-th sidelink slot in the sidelink resource pool. The first UE may perform LBT before the second UE FFP. The first UE may determine (e.g., verify and/or validate) whether or not there is COT initiated by a second UE at least in 4-th sidelink slot in this sidelink resource pool. If the first UE cannot determine (e.g., cannot verify and/or validate) there is COT initiated by the second UE (e.g., if the first UE cannot identify COT initiated by the second UE in 4-th sidelink slot in the sidelink resource pool), the first UE may drop the PSFCH and/or may not transmit PSFCH in 4-th sidelink slot in the sidelink resource pool. In some examples, PSFCH in 4-th sidelink slot in this sidelink resource pool may be in response to sidelink transmission from the second UE, e.g. a PSSCH transmission from the second UE in 2-nd sidelink slot. In some examples, the second UE may be configured (e.g., pre-configured) with/as a UE-type RSU. Alternatively and/or additionally, the second UE is any UE performing sidelink transmission in this sidelink resource pool. Alternatively and/or additionally, the second UE and the first UE may belong to a group for groupcast sidelink transmission. Alternatively and/or additionally, the first UE may have PC5-RRC connection to the second UE.

In a second embodiment, a length of FFP may be based upon a number of slots of a plurality of consecutive slots (e.g., a plurality of consecutive physical slots). In some examples, a length of FFP may be (further) based upon periodicity of PSFCH for the sidelink resource pool. In some examples, a beginning of FFP may be based upon the initial symbol for SL (e.g., starting symbol for SL) in a slot, or the initial symbol for PSFCH (e.g., starting symbol for PSFCH). In some examples, ending of FFP may be based upon the last symbol for SL in a slot, or a symbol preceding the initial symbol for PSFCH (e.g., starting symbol for PSFCH), or the last symbol for SL in a last slot in a cluster of slots belonging to sidelink resource pool. In some examples, the initial symbol for SL (e.g., starting symbol for SL) in a slot may be based upon sl-StartSymbol-r16. In some examples, the initial symbol for SL (e.g., starting symbol for SL) in a slot may be based upon a configuration different than sl-StartSymbol-r16. In some examples, the initial symbol for SL (e.g., starting symbol for SL) in a slot may be always symbol index 0 (e.g., the initial symbol, such as starting symbol, in the slot). In some examples, the last symbol for SL in a slot may be determined (e.g., derived) based upon sl-StartSymbol-r16 and sl-LengthSymbols-r16. For example, for sl-StartSymbol-r16 being as “sym0” and sl-LengthSymbols-r16 being as “sym14”, the last symbol for SL in a slot is symbol index 13. In some examples, sl-StartSymbol-r16 may be “sym0”, “sym1”, “sym2”, “sym3”, “sym4”, “sym5”, “sym6”, and/or “sym7”. In some examples, sl-LengthSymbols-r16 may be “sym7”, “sym8”, “sym9”, “sym10”, “sym11”, “sym12”, “sym13”, and/or “sym14”. For example, in Emb2 (corresponding to the second embodiment, for example) in FIG. 7, there are four (types of) FFPs with different lengths denoted as (1), (2), (3), (4). FFP (1) is from symbol index 0 in a sidelink slot without PSFCH to (and including, for example) a gap symbol preceding PSFCH in another sidelink slot. FFP (2) is from initial symbol of PSFCH to (and including, for example) gap symbol within a sidelink slot. FIG. 7 shows gaps (e.g., each having one or more gap symbols) with dot-filled rectangles, and PSFCHs with diagonal line-filled rectangles. FFP (3) is from symbol index 0 in a sidelink slot without PSFCH to (and including, for example) gap symbol in the sidelink slot or another sidelink slot (e.g., the gap symbol may correspond to an ending symbol of the sidelink slot or another sidelink slot belonging to the first cluster of (consecutive physical) slots belonging to sidelink resource pool). FFP (4) is from symbol index 0 in a sidelink slot with PSFCH (e.g., shown as “PSFCH 1” in FIG. 7) to (and including, for example) gap symbol preceding PSFCH within the sidelink slot. For FFP (4), symbol index 0 is in a sidelink slot with PSFCH (e.g., shown as “PSFCH 1” in FIG. 7), wherein the sidelink slot is also an initial slot (e.g., beginning slot) among a cluster of slots. FFP (1), FFP (3), and FFP (4) may be used for COT for PSCCH and/or PSSCH transmission. FFP (2) may be used for COT for PSFCH. According to the second embodiment, sidelink transmission may be performed once channel is sensed as idle, which may reduce the likelihood of dropping PSFCH since there is idle duration before PSFCH for sensing.

In a third embodiment, there may be a FFP with a length for sidelink slot without PSFCH and/or two FFPs (having two different lengths, for example) for sidelink slot with PSFCH. In some examples, FFP for sidelink slot without PSFCH may be based upon number of symbols for SL in the sidelink slot. In some examples, a first FFP for slot with PSFCH is based upon the initial symbol for SL (e.g., starting symbol for SL) in a sidelink slot and gap symbol preceding PSFCH. In some examples, the first FFP for sidelink slot with PSFCH is from the initial symbol for SL (e.g., starting symbol for SL) in a sidelink slot to (and including, for example) gap symbol preceding PSFCH. In some examples, a second FFP for sidelink slot with PSFCH is based upon the initial symbol for PSFCH (e.g., starting symbol for PSFCH) and last symbol for SL in a sidelink slot. In some examples, the second FFP for sidelink slot with PSFCH is from the initial symbol for PSFCH (e.g., starting symbol for PSFCH) to last symbol for SL within a sidelink slot or last gap symbol within a sidelink slot. For example, in Emb3 (corresponding to the third embodiment, for example) in FIG. 7, there are three (types of) FFP with different lengths denoted as (1′), (2′), (3′). For sidelink slot without PSFCH (in this sidelink resource pool), FFP (1′) is used. For example, FFP (1′) may be from an initial symbol of a sidelink slot without PSFCH to (and including, for example) a last symbol of the sidelink slot without PSFCH. For sidelink slot with PSFCH (in this sidelink resource pool), FFP (2′) and FFP (3′) are used. FFP (1′), and FFP (2′) may be used for COT for PSCCH and/or PSSCH transmission. FFP (3′) may be used for COT for PSFCH. According to third embodiment, sidelink transmission may be performed once channel is sensed as idle, which may reduce the likelihood of dropping PSFCH since there is idle duration before PSFCH for sensing.

The fourth embodiment is each sidelink slot in the sidelink resource pool is a FFP, where 95% of a duration of a slot (e.g., sidelink slot) may be COT, and 5% of the duration of the slot may be idle duration. In some examples, according to SCS, the last symbol (of the slot and/or the FFP) typically is gap symbol which may be suitable for sensing.

According to the first embodiment, the second embodiment, the third embodiment, and/or the fourth embodiment (and/or a combination of the first embodiment, the second embodiment, the third embodiment, and/or the fourth embodiment), a second UE may transmit a sidelink transmission requiring PSFCH feedback and the sidelink transmission may not comprise information related to COT initiator. For a first UE performing PSFCH (e.g., according to Emb2 and/or Emb3 in FIG. 7), the first UE would initiate COT for itself for PSFCH transmission.

In some examples, embodiments disclosed herein, such as embodiments described with respect to one or more of the discussed concepts, the first embodiment, the second embodiment, the third embodiment and/or the fourth embodiment, may be implemented independently and/or separately. Alternatively and/or additionally, a combination of embodiments described herein, such as embodiments described with respect to one or more of the discussed concepts, the first embodiment, the second embodiment, the third embodiment and/or the fourth embodiment, may be implemented. Alternatively and/or additionally, a combination of embodiments described herein, such as embodiments described with respect to one or more of the discussed concepts, the first embodiment, the second embodiment, the third embodiment and/or the fourth embodiment, may be implemented concurrently and/or simultaneously.

Various techniques, embodiments, methods, concepts and/or alternatives of the present disclosure may be performed independently and/or separately from one another. Alternatively and/or additionally, various techniques, embodiments, methods, concepts and/or alternatives of the present disclosure may be combined and/or implemented using a single system. Alternatively and/or additionally, various techniques, embodiments, methods, concepts and/or alternatives of the present disclosure may be implemented concurrently and/or simultaneously.

With respect to one or more embodiments herein, such as one or more techniques, devices, concepts, methods, example scenarios and/or alternatives described above, in some examples, one, some and/or all instances of “LBT” may be replaced by “channel access procedure”. For example, LBT and/or sensing exemption for sidelink (e.g., LBT and/or sensing exemption for a PSFCH) may be replaced with channel access procedure exemption for sidelink, such as for the PSFCH (e.g., a UE may be exempted from a requirement to perform channel access procedure for a sidelink transmission (e.g., the UE may not be required to perform channel access procedure, for the sidelink transmission, based upon an exemption). In some examples, channel access procedure exemption may be implemented using one or more of the techniques provided herein with respect to implementing LBT exemption. For example, whether or not a transmission (e.g., a sidelink transmission) is exempted from channel access procedure (e.g., type-1 channel access procedure) may be determined using one or more of the techniques provided herein with respect to determining whether or not a sidelink transmission is exempted from LBT and/or sensing.

With respect to one or more embodiments herein, in some examples, LBT may be CAT-1, 2, 3, or 4 LBT.

With respect to one or more embodiments herein, in some examples, an ending timing of a sidelink transmission may correspond to (and/or comprise) an Orthogonal Frequency Division Multiplexing (OFDM) symbol for gap (e.g., a gap symbol).

With respect to one or more embodiments herein, in some examples, a UE cannot transmit the sidelink transmission on the OFDM symbol for gap.

Alternatively and/or additionally, an ending timing of a sidelink transmission may not correspond to (and/or may not comprise) an OFDM symbol for gap (e.g., a gap symbol).

With respect to one or more embodiments herein, in some examples, a slot in a sidelink resource pool may comprise n-th~m-th symbols for sidelink.

With respect to one or more embodiments herein, in some examples, gap symbol is the m-th symbol or the (m+1)-th symbol.

With respect to one or more embodiments herein, in some examples, the PSFCH may be utilized for transmitting, (e.g., delivering, and/or carrying) and/or comprising sidelink HARQ feedback.

With respect to one or more embodiments herein, in some examples, the PSFCH may be utilized for transmitting, (e.g., delivering, and/or carrying) and/or comprising inter-UE coordination information (e.g., scheme 2) or resource conflict indication.

In some examples, one or more of the embodiments herein (for PSFCH, for example) utilized for transmitting, (e.g., delivering, and/or carrying) and/or comprising sidelink HARQ feedback may be applied for PSFCH utilized for transmitting, (e.g., delivering, and/or carrying) and/or comprising inter-UE coordination information (e.g., scheme 2 inter-UE coordination information) and/or resource conflict indication. In some examples, the inter-UE coordination information (e.g., scheme 2) and/or resource conflict indication may be used to indicate that a reserved and/or scheduled sidelink resource (e.g., reserved by TX UE) collided with (and/or will collide with) another sidelink resource reserved/scheduled by one or more other UEs. In this case of inter-UE coordination information (e.g., scheme 2) or resource conflict indication, the UE or the first UE transmitting the PSFCH is UE-A, and the TX UE may be UE-B. For example, inter-UE coordination information (e.g., scheme 2 inter-UE coordination information) and/or resource conflict indication may be transmitted utilizing PSFCH using one or more of the techniques provided herein with respect to utilizing PSFCH to transmit sidelink HARQ feedback.

In some examples, one or more of the embodiments herein (for PSFCH, for example) utilized for transmitting, (e.g., delivering, and/or carrying) and/or comprising sidelink HARQ feedback may be applied for PSFCH utilized for one or more other purposes, features and/or functions (and/or may be applied in other applications).

With respect to one or more embodiments herein, in some examples, the second UE may transmit unicast sidelink transmission on the shared COT (initiated by the first UE, for example) if the unicast sidelink transmission is targeted to the first UE.

With respect to one or more embodiments herein, in some examples, the second UE may transmit broadcast or groupcast sidelink transmission on the shared COT (initiated by the first UE, for example) if the broadcast or groupcast sidelink transmission includes a target UE corresponding to the first UE.

With respect to one or more embodiments herein, in some examples, the second UE does not transmit (and/or is not allowed to transmit) unicast sidelink transmission on the shared COT (initiated by the first UE, for example) if the unicast sidelink transmission is not targeting to the first UE.

With respect to one or more embodiments herein, in some examples, the second UE does not transmit (and/or is not allowed to transmit) broadcast or groupcast sidelink transmission on the shared COT (initiated by the first UE, for example) if the broadcast or groupcast sidelink transmission does not include a target UE corresponding to the first UE.

With respect to one or more embodiments herein, in some examples, the first sidelink transmission is scheduled by a 1-st stage SCI and a 2-nd stage SCI.

With respect to one or more embodiments herein, in some examples, a UE performing a successful LBT may refer to the UE sensing (via the LBT) a channel is idle according to the LBT required duration.

With respect to one or more embodiments herein, in some examples, a UE performing a LBT failure (and/or the UE failing to pass the LBT) may refer to the UE sensing (via the LBT) a channel is not idle (e.g., the UE senses the channel is busy) according to the LBT required duration.

With respect to one or more embodiments herein, in some examples, a UE performing a successful LBT may refer to the energy of the channel sensed by the UE (via the LBT) being lower than or equal to an energy threshold and/or energy detection threshold.

With respect to one or more embodiments herein, in some examples, a UE performing a LBT failure (and/or the UE failing to pass the LBT) may refer to the energy of the channel sensed by the UE (via the LBT) being larger than an energy threshold and/or energy detection threshold.

With respect to one or more embodiments herein, in some examples, the first sidelink transmission is associated with (e.g., is in) a first sidelink resource pool. In some examples, the second sidelink transmission is associated with (e.g., is in) a second sidelink resource pool. In some examples, the first sidelink resource pool and the second sidelink resource pool are the same pool or different pools. In some examples, the first sidelink resource pool is associated with (e.g., is in) a first carrier/cell. In the present disclosure, the term “carrier/cell” may refer to a carrier and/or a cell. In some examples, the second sidelink resource pool is associated with (e.g., is in) a second carrier/cell. In some examples, the first carrier/cell and the second carrier/cell may be the same carrier/cell or different carriers/cells. In some examples, the first carrier/cell is associated with a shared and/or unlicensed spectrum. In some examples, the second carrier/cell is associated with a shared and/or unlicensed spectrum. In some examples, a UE (e.g., the first UE or the second UE) may perform at least one type of LBT or performing sensing (on one or more sensing slots, for example) before performing sidelink transmission. In some examples, the first UE operates in shared spectrum channel access.

With respect to one or more embodiments herein, in some examples, the second UE operates in shared spectrum channel access.

With respect to one or more embodiments herein, in some examples, a device may be a UE or a network node.

In some examples, in the present disclosure, the term “timing” may refer to at least one of a time unit, a slot, a symbol, a point in time, a time location, a location, a time domain position, etc.

In some examples, one, some and/or all instances of “timing” may be replaced (and/or may be used interchangeably with) “time unit”, “slot”, “symbol”, “point in time”, “time location”, “location” and/or “time domain position”.

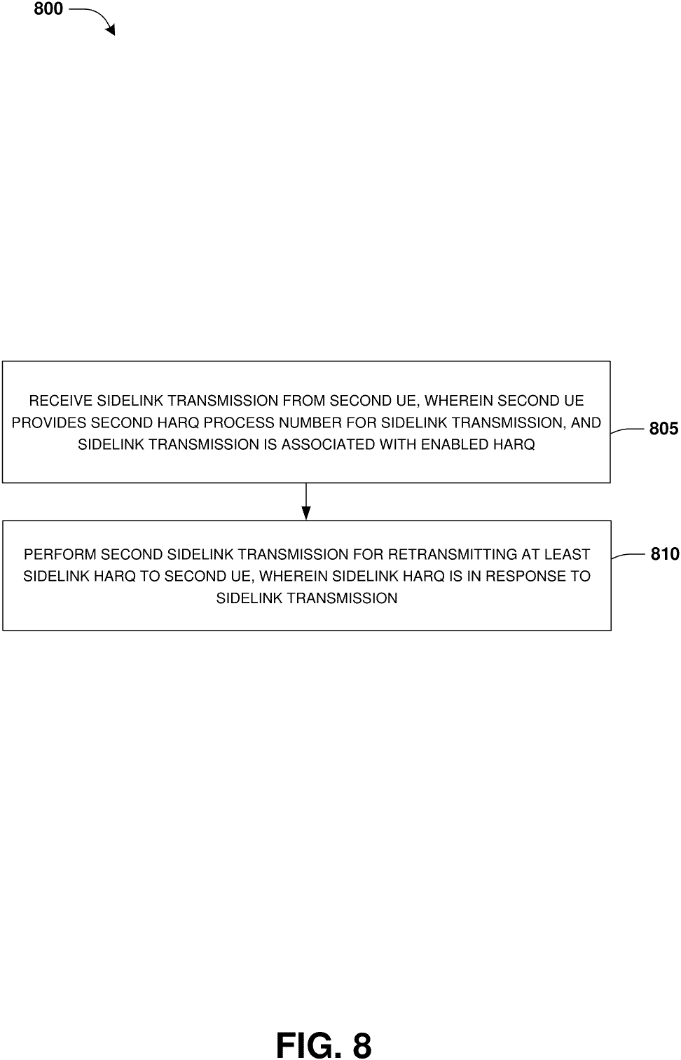

FIG. 8 is a flow chart 800 according to one exemplary embodiment from the perspective of a first UE. In step 805, the first UE receives a sidelink transmission from a second UE, wherein the second UE provides a second HARQ process number (of the second UE, for example) for the sidelink transmission, and the sidelink transmission is associated with enabled HARQ (e.g., HARQ feedback is enabled for the sidelink transmission). In step 810, the first UE performs a second sidelink transmission for retransmitting at least a sidelink HARQ to the second UE, wherein the sidelink HARQ (e.g., sidelink HARQ feedback) is in response to the sidelink transmission. For example, the sidelink HARQ may indicate, to the second UE, whether or not the sidelink transmission is successfully received by the first UE.

In one embodiment, the sidelink HARQ is associated with the second HARQ process number (of the second UE, for example).

In one embodiment, the sidelink HARQ is not based upon a first HARQ process number of the first UE.

In one embodiment, the first UE uses (e.g., allocates) a first HARQ process number of the first UE to process the sidelink transmission.

In one embodiment, the first HARQ process number is different than the second HARQ process number.

In one embodiment, the first HARQ process number may be the same as the second HARQ process number.

In one embodiment, one or more of the techniques provided herein inform the second UE of which HARQ process number, of the second UE, is associated with the sidelink HARQ (e.g., the retransmitted sidelink HARQ). In an example, the second sidelink transmission of the sidelink HARQ (e.g., the second sidelink transmission for retransmitting the sidelink HARQ) may indicate that the sidelink HARQ is associated with the second HARQ process number of the second UE, which may let the second UE know that the sidelink HARQ corresponds to feedback that is in response to the sidelink transmission (associated with the second HARQ process number of the second UE) transmitted by the second UE. In some examples, the first UE may indicate, to the second UE and via the second sidelink transmission, that the sidelink HARQ is associated with the second HARQ process number (instead of the first HARQ process number the first UE uses to process the sidelink transmission) based upon a determination that a HARQ process number, of the second UE, for the sidelink transmission is the second HARQ process number (e.g., the determination may be based upon an indication, received by the first UE from the second UE, that the sidelink transmission is associated with the HARQ process number).

In one embodiment, the first UE cannot access and/or occupy a channel (e.g., the first UE fails to access a channel for transmitting sidelink HARQ feedback in response to the sidelink transmission).

In one embodiment, the first UE fails to pass LBT for transmitting PSFCH in response to the sidelink transmission. For example, a LBT result of LBT performed by the first UE for transmitting PSFCH that is in response to the sidelink transmission (e.g., PSFCH comprising sidelink HARQ feedback that is in response to the sidelink transmission) may correspond to busy.

In one embodiment, a number of consecutive slots is based upon one or more available slots for sidelink in a SL BWP or in a carrier. The number of consecutive slots may correspond to a number of slots of a set of consecutive sidelink slots that are available in the SL BWP or in the carrier. In an example, there may be a plurality of consecutive slots corresponding to “DUDDSSSU”, wherein “D” refers to downlink slot, “U” refers to uplink slot, and “S” refers to sidelink slot (available for sidelink in the SL BWP or in the carrier). Accordingly, the set of consecutive slots (that are available in the SL BWP or in the carrier) may correspond to the three sidelink slots “SSS” and/or the number of consecutive slots may be three.

In one embodiment, based upon different consecutive numbers of slots in the carrier, lengths of different FFP in a sidelink resource pool (e.g., a sidelink resource pool that comprises sidelink resources used for the sidelink transmission and/or the second sidelink transmission) may be different from each other.

In one embodiment, the first UE may receive a first request to perform the second sidelink transmission (and/or other sidelink transmission) for retransmitting at least the sidelink HARQ.

In one embodiment, the first request is transmitted by the second UE.

In one embodiment, the first request may be a request for a one or more sidelink HARQs associated with a plurality of HARQ process numbers.

In one embodiment, the first request may be a request for sidelink HARQ associated with all HARQ process numbers (e.g., all HARQ process numbers of the second UE or all HARQ process numbers of the requested UE, such as the first UE).

In one embodiment, the first request may be a request for a subset of sidelink HARQs of a plurality of sidelink HARQs associated with all HARQ process numbers of the second UE.

In one embodiment, the first request may be a request for a sidelink HARQ associated with a HARQ process number (e.g., a specific HARQ process number), such as a HARQ process number (e.g., a specific HARQ process number) of the second UE.

In one embodiment, the first request may indicate a code-point associated with one or more HARQ process numbers.

In one embodiment, the first UE and the second UE may have PC5-RRC signaling with each other.

In one embodiment, the PC5-RRC signaling may have one or more code-points, and/or each code-point of the one or more code-points may indicate a one or more HARQ process number associated with requested UE.

In one embodiment, the first UE maintains an association (e.g., a relation) between the second HARQ process number of the second UE and the first HARQ process number of the first UE. In an example, the first UE may determine that the second HARQ process number of the second UE corresponds to the first HARQ process number of the first UE.

In one embodiment, when the first UE transmits multiple sidelink HARQs associated with a plurality of HARQ process numbers, an arrangement (e.g., order) of the multiple sidelink HARQs (e.g., an order with which the multiple sidelink HARQs are arranged in a bit-map) is based upon an increasing order of HARQ process numbers of the second UE (e.g., a sidelink HARQ ACK associated with a smaller HARQ process number of the second UE may be arranged in front of and/or before a sidelink HARQ ACK associated with a larger HARQ process number of the second UE) or a decreasing order of HARQ process numbers of the second UE (e.g., a sidelink HARQ ACK associated with a larger HARQ process number of the second UE may be arranged in front of and/or before a sidelink HARQ ACK associated with a smaller HARQ process number of the second UE).

In one embodiment, when the first UE transmits multiple sidelink HARQs associated with a plurality of HARQ process numbers, an arrangement (e.g., order) of the multiple sidelink HARQs (e.g., an order with which the multiple sidelink HARQs are arranged in a bit-map) is based upon an increasing order of HARQ process numbers of the requested UE such as the first UE (e.g., a sidelink HARQ ACK associated with a smaller HARQ process number of the requested UE may be arranged in front of and/or before a sidelink HARQ ACK associated with a larger HARQ process number of the requested UE) or a decreasing order of HARQ process numbers of the requested UE (e.g., a sidelink HARQ ACK associated with a larger HARQ process number of the requested UE may be arranged in front of and/or before a sidelink HARQ ACK associated with a smaller HARQ process number of the requested UE).

In one embodiment, when the first UE transmits multiple sidelink HARQs associated with a plurality of HARQ process numbers, an arrangement (e.g., order) of the multiple sidelink HARQs (e.g., an order with which the multiple sidelink HARQs are arranged in a bit-map) is based upon an order of HARQ process numbers (e.g., a specific order of HARQ process numbers) associated with the code-point.

In one embodiment, the first UE may provide the second HARQ process number (and/or information associated with the second HARQ process number) along with the sidelink HARQ (e.g., the first UE may transmit an indication of the second HARQ process number and the sidelink HARQ in the same transmission, wherein the transmission may indicate that the sidelink HARQ is associated with the second HARQ process number).

In one embodiment, the second sidelink transmission for retransmitting at least the sidelink HARQ may be delivered by PSCCH, PSSCH, 1-st stage SCI, 2-nd stage SCI and/or PSFCH.

In one embodiment, the second sidelink transmission for retransmitting at least the sidelink HARQ is not delivered by PSFCH.

In one embodiment, when the second sidelink transmission for retransmitting at least a sidelink HARQ is delivered by PSFCH, a PSFCH format (e.g., a long format of PSFCH) for delivering multiple sidelink HARQs is used (e.g., the secpmd sidelink transmission may comprise a transmission according to the PSFCH format, such as the long format of PSFCH).

In one embodiment, in response to a timer expiring or a counter reaching a threshold and/or after a window, the first UE triggers resource selection for transmitting the sidelink HARQ on PSFCH.

In one embodiment, the first UE triggers resource selection for transmitting the sidelink HARQ on PSFCH based upon a determination that the timer is expired, the counter meets the threshold, and/or the window elapsed (e.g., a current time is after an end of the window).

In one embodiment, the first UE determines the window that starts at an original timing of PSFCH (e.g., a timing of a PSFCH resource that the first UE fails to access for transmitting the sidelink HARQ), and/or starts at a timing of a PSCCH/PSSCH/PSFCH (e.g., an original PSCCH/PSSCH/PSFCH) which the sidelink HARQ is in response to.

In one embodiment, the first UE receives a PSCCH1, a PSSCH1 and/or a PSFCH from a second UE in slot n. The first UE may determine to transmit sidelink HARQ feedback on PSFCH in slot m, therein the sidelink HARQ feedback is in response to the PSCCH1, the PSSCH1 and/or the PSFCH.

In one embodiment, the window starts from a starting symbol of slot n, slot m, slot n+1, or slot m+1.

In one embodiment, the first UE retransmits (in slot k before the window is elapsed, for example) the sidelink HARQ on another PSFCH resource (e.g., different than the PSFCH resource that the first UE fails to access for transmitting the sidelink HARQ).

In one embodiment, before the window is elapsed (e.g., during the window), if the first UE may transmit the sidelink HARQ feedback on another PSFCH resource such as in slot k, the first UE may determine (e.g., re-determine an updated version of) a beginning (e.g., a starting timing) of the window.

Referring back to FIGS. 3 and 4, in one exemplary embodiment of a first UE, the device 300 includes a program code 312 stored in the memory 310. The CPU 308 may execute program code 312 to enable the first UE (i) to receive a sidelink transmission from a second UE, wherein the second UE provides a second HARQ process number for the sidelink transmission, and the sidelink transmission is associated with enabled HARQ, and (ii) to perform a second sidelink transmission for retransmitting at least a sidelink HARQ to the second UE, wherein the sidelink HARQ is in response to the sidelink transmission. Furthermore, the CPU 308 can execute the program code 312 to perform one, some and/or all of the above-described actions and steps and/or others described herein.

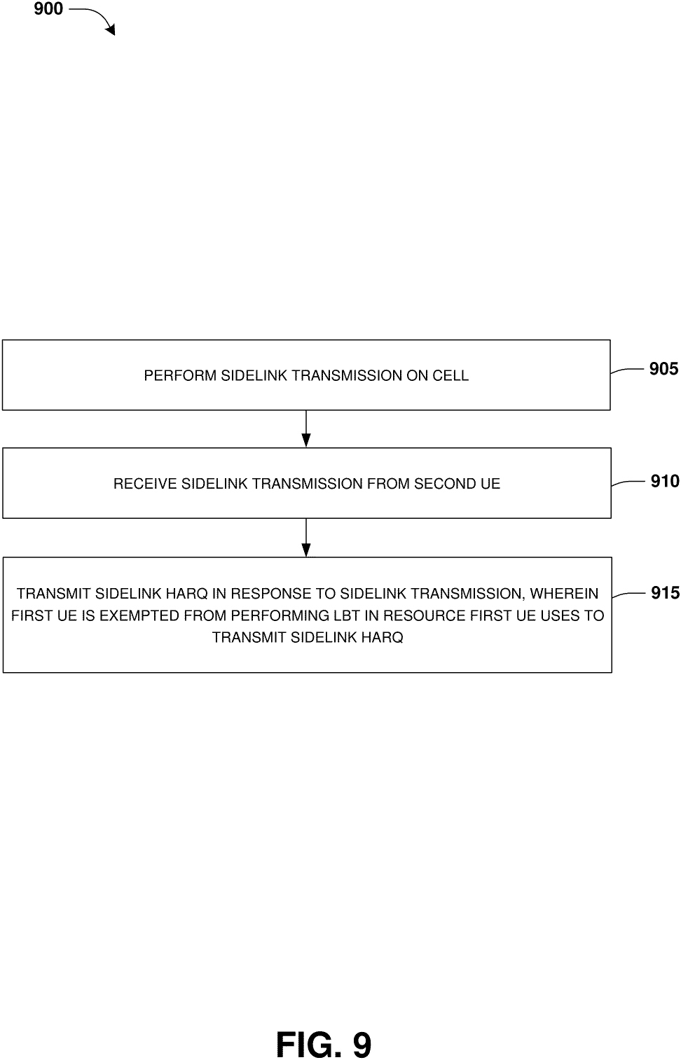

FIG. 9 is a flow chart 900 according to one exemplary embodiment from the perspective of a first UE. In step 905, the first UE performs sidelink transmission on a cell (e.g., a cell in unlicensed spectrum). In step 910, the first UE receives a sidelink transmission from a second UE. In step 915, the first UE transmits a sidelink HARQ (e.g., sidelink HARQ feedback) in response to the sidelink transmission, wherein the first UE is exempted from performing LBT in a resource the first UE uses to transmit the sidelink HARQ (e.g., the resource is associated with a LBT exemption and/or the resource may be exempted from LBT requirement).

Referring back to FIGS. 3 and 4, in one exemplary embodiment of a first UE, the device 300 includes a program code 312 stored in the memory 310. The CPU 308 may execute program code 312 to enable the first UE (i) to perform sidelink transmission on a cell (e.g., a cell in unlicensed spectrum), (ii) to receive a sidelink transmission from a second UE, and (iii) to transmit a sidelink HARQ in response to the sidelink transmission, wherein the first UE is exempted from performing LBT in a resource the first UE uses to transmit the sidelink HARQ. Furthermore, the CPU 308 can execute the program code 312 to perform one, some and/or all of the above-described actions and steps and/or others described herein.

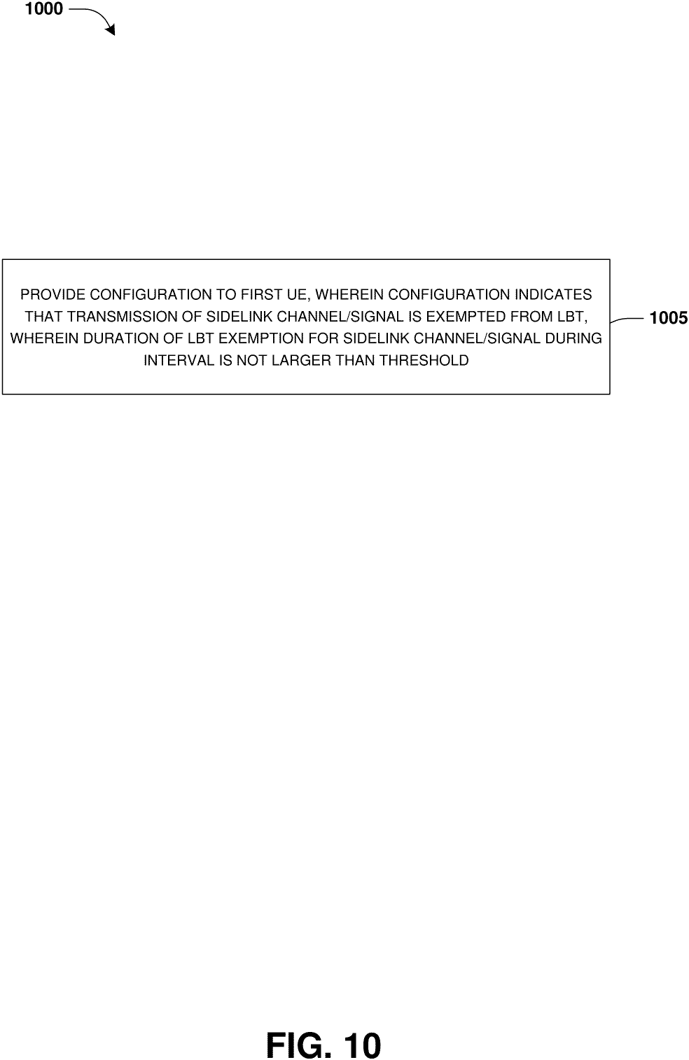

FIG. 10 is a flow chart 1000 according to one exemplary embodiment from the perspective of a network node. In step 1005, the network node provides (e.g., transmits) a configuration to a first UE, wherein the configuration indicates that transmission of a sidelink channel/signal is exempted from LBT, wherein a duration (e.g., a time duration) of LBT exemption for the sidelink channel/signal during an interval is not larger than a threshold. In the present disclosure, the term “sidelink channel/signal” may refer to a sidelink channel and/or a sidelink signal.

Referring back to FIGS. 3 and 4, in one exemplary embodiment of a network node, the device 300 includes a program code 312 stored in the memory 310. The CPU 308 may execute program code 312 to enable the network node (i) to provide (e.g., transmit) a configuration to a first UE, wherein the configuration indicates that transmission of a sidelink channel/signal is exempted from LBT, wherein a duration (e.g., a time duration) of LBT exemption for the sidelink channel/signal during an interval is not larger than a threshold. Furthermore, the CPU 308 can execute the program code 312 to perform one, some and/or all of the above-described actions and steps and/or others described herein.

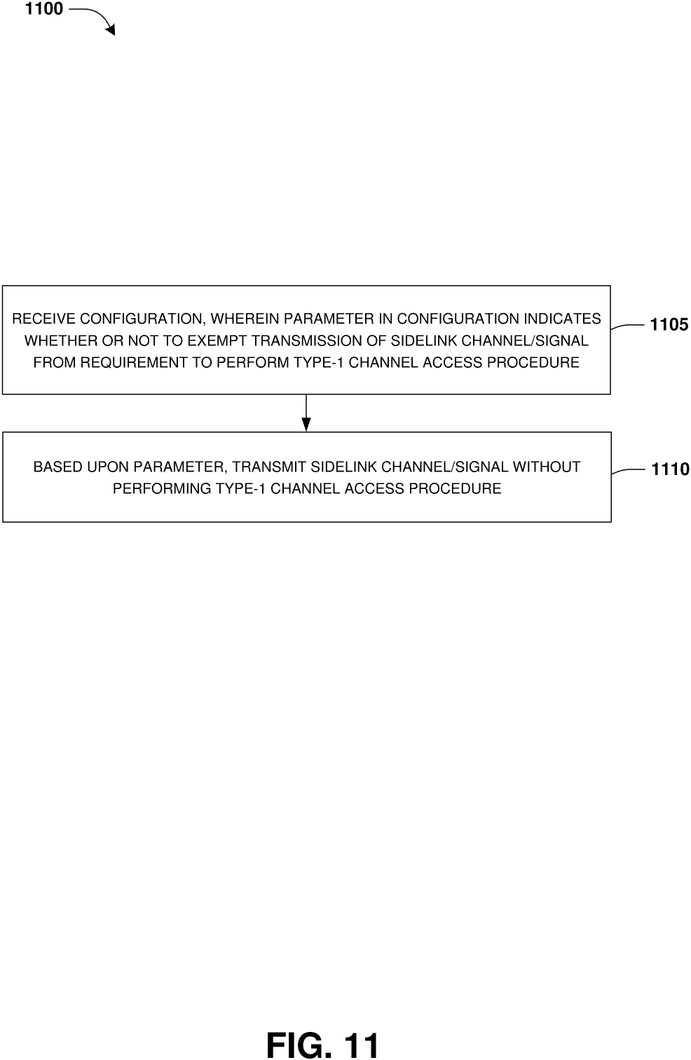

FIG. 11 is a flow chart 1100 according to one exemplary embodiment from the perspective of a first UE. In step 1105, the first UE receives a configuration (e.g., a pre-configuration), wherein a parameter (e.g., one parameter) in the configuration indicates whether or not to exempt transmission of a sidelink channel/signal from a requirement to perform type-1 channel access procedure. In step 1110, based upon the parameter (e.g., based upon an indication of the parameter in the configuration), the first UE transmits the sidelink channel/signal without performing type-1 channel access procedure. For example, the first UE may not perform type-1 channel access procedure based upon the parameter indicating that transmission of the sidelink channel/signal is exempted from a requirement to perform type-1 channel access procedure.

With respect to FIGS. 9-11, in one embodiment, in response to determining to transmit a sidelink channel/signal without performing type-1 channel access procedure (e.g., the determination to transmit the sidelink channel/signal without performing type-1 channel access procedure may be based upon the parameter, such as based upon a determination that the transmission of the sidelink channel/signal is exempted from the requirement to perform type-1 channel access procedure), the first UE transmits the sidelink channel/signal without performing type-1 channel access procedure.

In one embodiment, in response to determining to transmit a sidelink channel/signal with a type-1 channel access procedure (e.g., the determination to transmit the sidelink channel/signal with the type-1 channel access procedure may be based upon the parameter, such as based upon a determination that the transmission of the sidelink channel/signal is not exempted from the requirement to perform type-1 channel access procedure), the first UE may transmit the sidelink channel/signal with performing the type-1 channel access procedure (e.g., the first UE may use the type-1 channel access procedure to perform the transmission of the sidelink channel/signal).

In one embodiment, the duration (e.g., time duration) of LBT exemption for the sidelink channel/signal during an interval is determined based upon a periodicity of the sidelink channel/signal (and/or based upon other information in addition to the periodicity, for example).

In one embodiment, the parameter (e.g., the one parameter in the configuration) indicates (i) a subset of pool-specific locations (e.g., a subset of resources of a sidelink resource pool) for one or more sidelink channels and/or signals (e.g., the sidelink channel/signal) that are exempted from a requirement to perform type-1 channel access procedure, (ii) a subset of LBT band-specific locations (e.g., a subset of resources of a LBT band) for one or more sidelink channels and/or signals (e.g., the sidelink channel/signal) that are exempted from a requirement to perform type-1 channel access procedure, (iii) a subset of carrier-specific locations (e.g., a subset of resources of a carrier) for one or more sidelink channels and/or signals (e.g., the sidelink channel/signal) that are exempted from a requirement to perform type-1 channel access procedure, and/or (iv) a subset of SL BWP-specific locations (e.g., a subset of resources of a SL BWP) for one or more sidelink channels and/or signals (e.g., the sidelink channel/signal) that are exempted from a requirement to perform type-1 channel access procedure.

In one embodiment, the parameter (e.g., the one parameter in the configuration) indicates (i) all pool-specific locations (e.g., all resources of a sidelink resource pool) for one or more sidelink channels and/or signals (e.g., the sidelink channel/signal) that are exempted from a requirement to perform type-1 channel access procedure, (ii) all LBT band-specific locations (e.g., all resources of a LBT band) for one or more sidelink channels and/or signals (e.g., the sidelink channel/signal) that are exempted from a requirement to perform type-1 channel access procedure, (iii) all carrier-specific locations (e.g., all resources of a carrier) for one or more sidelink channels and/or signals (e.g., the sidelink channel/signal) that are exempted from a requirement to perform type-1 channel access procedure, and/or (iv) all SL BWP-specific locations (e.g., all resources of a SL BWP) for one or more sidelink channels and/or signals (e.g., the sidelink channel/signal) that are exempted from a requirement to perform type-1 channel access procedure.

In one embodiment, the parameter indicates a set of locations in a carrier for one or more sidelink channels and/or signals (e.g., the sidelink channel/signal) that are exempted from a requirement to perform type-1 channel access procedure.

In one embodiment, the parameter (e.g., the indication of the parameter in the configuration) guarantees that occupying time duration for the sidelink channel/signal during an interval is not larger than a threshold (e.g., the first UE is configured, via the parameter, to perform the sidelink channel/signal such that an occupying time duration for the sidelink channel/signal during the interval is not larger than the threshold).

In one embodiment, the configuration (e.g., the pre-configuration) is per sidelink resource pool, per SL BWP, or per carrier. For example, there may be a (e.g., unique) configuration for each sidelink resource pool, each SL BWP and/or each carrier.

In one embodiment, the sidelink channel/signal is a PSFCH and/or Sidelink Synchronization Signal/PBCH Block (SL-SSB).

Referring back to FIGS. 3 and 4, in one exemplary embodiment of a first UE, the device 300 includes a program code 312 stored in the memory 310. The CPU 308 may execute program code 312 to enable the first UE (i) to receive a configuration (e.g., a pre-configuration), wherein a parameter (e.g., one parameter) in the configuration indicates whether or not to exempt transmission of a sidelink channel/signal from a requirement to perform type-1 channel access procedure, and (ii) based upon the parameter (e.g., based upon an indication of the parameter in the configuration), to transmit the sidelink channel/signal without performing type-1 channel access procedure. Furthermore, the CPU 308 can execute the program code 312 to perform one, some and/or all of the above-described actions and steps and/or others described herein.

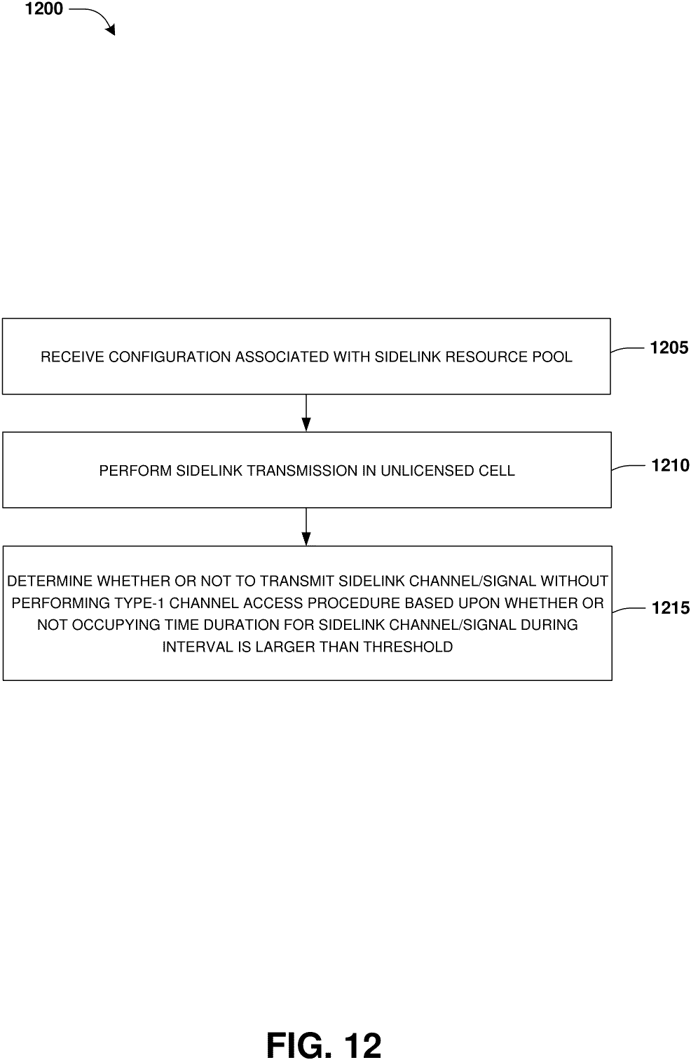

FIG. 12 is a flow chart 1200 according to one exemplary embodiment from the perspective of a first UE. In step 1205, the first UE receives a configuration (e.g., a pre-configuration) associated with a sidelink resource pool. In step 1210, the first UE performs sidelink transmission in an unlicensed cell. In step 1215, the first UE determines whether or not to transmit a sidelink channel/signal without performing type-1 channel access procedure based upon whether or not an occupying time duration for the sidelink channel/signal during an interval is larger than a threshold (and/or based upon other information in addition to whether or not the occupying time duration for the sidelink channel/signal during the interval is larger than the threshold). In some examples, the occupying time duration may correspond to a duration of time occupied by a transmission of the sidelink channel/signal.

In one embodiment, the occupying time duration for the sidelink channel/signal during the interval is determined based upon a configuration (e.g., a pre-configuration) associated with a timing, of the sidelink channel/signal, in a sidelink resource pool.

In one embodiment, if the occupying time duration for the sidelink channel/signal during the interval is not larger than the threshold (e.g., if a duration of time that is occupied during the interval by transmission of the sidelink channel/signal is not larger than the threshold), the first UE may transmit the sidelink channel/signal without performing type-1 channel access procedure.

In one embodiment, if the occupying time duration for the sidelink channel/signal during the interval is larger than the threshold (e.g., if a duration of time that is occupied during the interval by transmission of the sidelink channel/signal larger than the threshold), the first UE is not configured (and/or not allowed) to transmit the sidelink channel/signal without performing type-1 channel access procedure (e.g., the first UE may perform type-1 channel access procedure for transmitting the sidelink channel/signal).

In one embodiment, a subset of pool-specific locations, a subset of LBT band-specific locations, a subset of carrier-specific locations and/or a subset of SL BWP-specific locations for the sidelink channel/signal are exempted from a type-1 channel access procedure requirement (e.g., exempted from performing type-1 channel access procedure).

In one embodiment, all pool-specific locations, all LBT band-specific locations, all carrier-specific locations and/or all SL BWP-specific locations for the sidelink channel/signal are exempted from type-1 channel access procedure requirement (e.g., exempted from performing type-1 channel access procedure).

Referring back to FIGS. 3 and 4, in one exemplary embodiment of a first UE, the device 300 includes a program code 312 stored in the memory 310. The CPU 308 may execute program code 312 to enable the first UE (i) to receive a configuration (e.g., a pre-configuration) associated with a sidelink resource pool, (ii) to perform sidelink transmission in an unlicensed cell, and (iii) to determine whether or not to transmit a sidelink channel/signal without performing type-1 channel access procedure based upon whether or not an occupying time duration for the sidelink channel/signal during an interval is larger than a threshold. Furthermore, the CPU 308 can execute the program code 312 to perform one, some and/or all of the above-described actions and steps and/or others described herein.

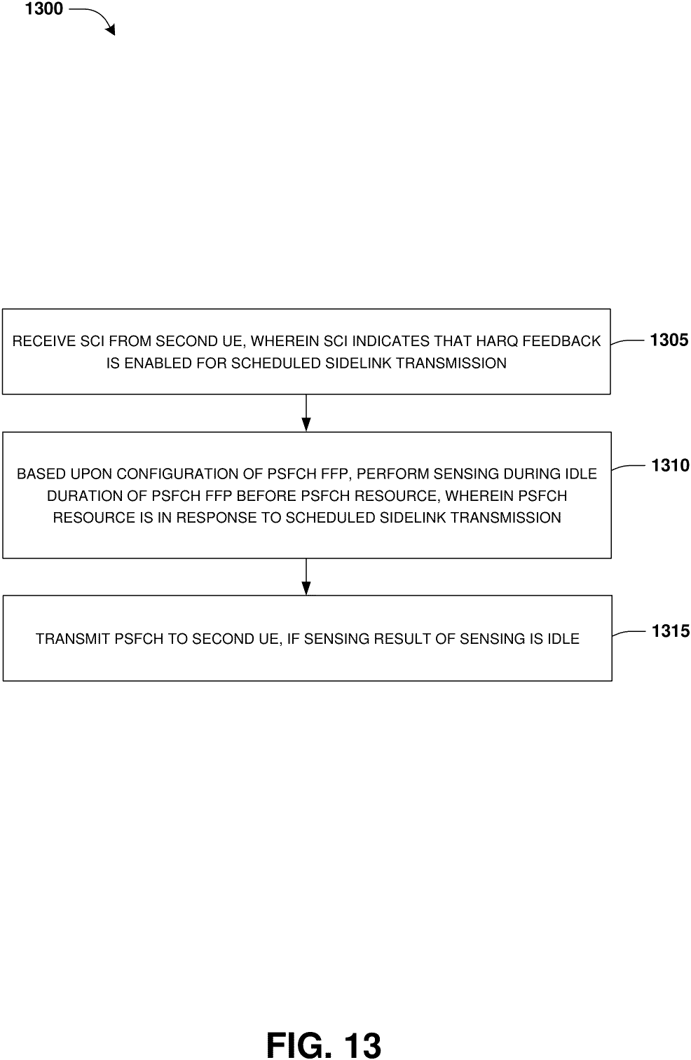

FIG. 13 is a flow chart 1300 according to one exemplary embodiment from the perspective of a first UE. In step 1305, the first UE receives a SCI from a second UE, wherein the SCI indicates that HARQ feedback is enabled for a scheduled sidelink transmission. In step 1310, based upon a configuration (e.g., a pre-configuration) of PSFCH FFP, the first UE performs sensing during an idle duration of PSFCH FFP before a PSFCH resource (e.g., a timing of PSFCH), wherein the PSFCH resource is in response to the scheduled sidelink transmission. In step 1315, the first UE transmits PSFCH to the second UE if a sensing result of the sensing is idle.

In one embodiment, the configuration of PSFCH FFP is for one or more UEs (e.g., the first UE) in a sidelink resource pool and/or for transmitting one or more PSFCHs (e.g., the PSFCH). For example, the configuration of PSFCH FFP may be used by one or more UEs (e.g., the first UE) for transmitting one or more PSFCHs (e.g., the PSFCH) using the sidelink resource pool (e.g., the sidelink resource pool may be used for transmitting the one or more PSFCHs).

In one embodiment, the idle duration of PSFCH FFP is based upon PSFCH periodicity.

In one embodiment, a maximum channel occupancy according to PSFCH FFP is based upon a number of PSFCH symbols in a slot (e.g., 2 symbols).

In one embodiment, the configuration of PSFCH FFP is pool-specific (e.g., the configuration of PSFCH FFP may be the same for a pool). For example, transmissions performed using the pool may be performed according to the configuration.

In one embodiment, the configuration of PSFCH FFP is SL BWP-specific (e.g., the configuration of PSFCH FFP may be the same for a SL BWP). For example, transmissions performed using the SL BWP may be performed according to the configuration.

In one embodiment, the configuration of PSFCH FFP is carrier-specific (e.g., the configuration of PSFCH FFP may be the same for a carrier). For example, transmissions performed using the carrier may be performed according to the configuration.

In one embodiment, the first UE, based upon the SCI indicating that a COT initiator is the first UE (e.g., RX UE), performs sensing based upon the configuration of PSFCH FFP. Alternatively and/or additionally, when the second UE provides information with COT information is the second UE (or TX UE), the first UE may transmit PSFCH in response to the sidelink transmission based upon channel occupancy by itself UE.

In one embodiment, the first UE initiates COT for transmitting the PSFCH when there is no channel occupancy that covers (e.g., overlaps with, such as fully overlaps with) the PSFCH (e.g., when no channel occupancy associated with the first UE overlaps in time domain with a timing of the PSFCH).

In one embodiment, the first UE initiates COT for transmitting the PSFCH when there is no channel occupancy for a time resource of the PSFCH.

In one embodiment, the first UE performs sensing before transmitting the PSFCH.

In one embodiment, if the first UE has a previous channel occupancy (which may cover, such as overlap with, a timing of the PSFCH), the first UE, based upon a time gap between a previous sidelink transmission in the channel occupancy time and the PSFCH, determines whether to transmit the PSFCH with sensing or without sensing (e.g., whether or not the first UE performs sensing for transmitting the PSFCH may be based upon the time gap).

In one embodiment, when the first UE transmits SCI and/or PSSCH to a third UE, the first UE is not configured to (e.g., the first UE cannot and/or is not allowed to) perform sensing according to PSFCH FFP.

In one embodiment, when the first UE transmits SCI and/or PSSCH to a third UE, the first UE may use a second configuration (e.g., a second pre-configuration) which is for PSSCH and/or PSCCH FFP.

In one embodiment, the second configuration is pool-specific (e.g., the second configuration may be the same for a pool). For example, transmissions performed using the pool may be performed according to the second configuration.

In one embodiment, the second configuration is SL BWP-specific (e.g., the second configuration may be the same for a SL BWP). For example, transmissions performed using the SL BWP may be performed according to the second configuration.

In one embodiment, the second configuration is carrier-specific (e.g., the second configuration may be the same for a carrier). For example, transmissions performed using the carrier may be performed according to the second configuration. In one embodiment, the second configuration is group common for a groupcast sidelink transmission (for a group, for example). Alternatively and/or additionally, when the first UE performs groupcast sidelink transmission, the first UE may perform sensing based upon the second configuration (e.g., the first UE may perform the sensing for the group and/or the second configuration may be for the group).

In one embodiment, the second configuration is link specific (e.g., the second configuration is associated with a link, such as where the second configuration is used to perform sensing and/or transmission over the link). Alternatively and/or additionally, the second configuration may be based upon a PC5-RRC signaling (between the first UE and a third UE, for example). Alternatively and/or additionally, when the first UE performs unicast sidelink transmission, the first UE perform sensing based upon the second configuration (for the link, for example).

In one embodiment, when the second UE provides information indicating that COT initiator is the second UE (or TX UE), the first UE may transmit PSFCH in response to the sidelink transmission based upon channel occupancy by the second UE.

In one embodiment, the PSFCH resource and/or a resource for the sidelink transmission (transmitted by the second UE) are in shared and/or unlicensed spectrum.

In one embodiment, a symbol level offset for PSFCH FFP is based upon (e.g., implicitly derived from) a starting symbol for sidelink in a slot belonging to a sidelink resource pool.

Referring back to FIGS. 3 and 4, in one exemplary embodiment of a first UE, the device 300 includes a program code 312 stored in the memory 310. The CPU 308 may execute program code 312 to enable the first UE (i) to receive a SCI from a second UE, wherein the SCI indicates that HARQ feedback is enabled for a scheduled sidelink transmission, (ii) based upon a configuration (e.g., a pre-configuration) of PSFCH FFP, to perform sensing during an idle duration of PSFCH FFP before a PSFCH resource (e.g., a timing of PSFCH), wherein the PSFCH resource is in response to the scheduled sidelink transmission, and (iii) to transmit PSFCH to the second UE, if a sensing result of the sensing is idle. Furthermore, the CPU 308 can execute the program code 312 to perform one, some and/or all of the above-described actions and steps and/or others described herein.

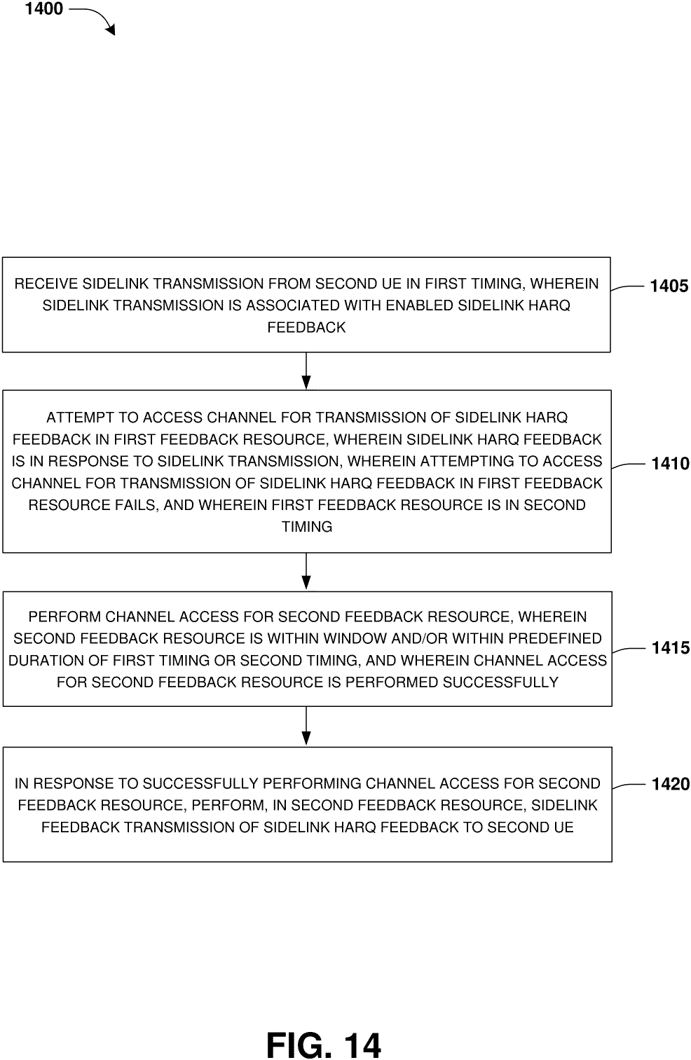

FIG. 14 is a flow chart 1400 according to one exemplary embodiment from the perspective of a first UE. In step 1405, the first UE receives a sidelink transmission from a second UE in a first timing, wherein the sidelink transmission is associated with enabled sidelink HARQ feedback. For example, sidelink HARQ feedback functionality may be enabled for the sidelink transmission. For example, based upon sidelink HARQ feedback functionality being enabled for the sidelink transmission, the second UE may expect sidelink HARQ feedback, from the first UE, that indicates whether or not the first UE successfully received the sidelink transmission from the second UE. In step 1410, the first UE attempts to access a channel for transmission of a sidelink HARQ feedback in a first feedback resource in a second timing. The attempt to access the channel for the transmission of the sidelink HARQ feedback in the first feedback resource fails (e.g., the first UE fails to access the channel for transmitting the sidelink HARQ feedback in the first feedback resource). The sidelink HARQ feedback is in response to the sidelink transmission. For example, the sidelink HARQ feedback may indicate whether or not the UE successfully received the sidelink transmission from the second UE. In step 1415, the first UE performs channel access for a second feedback resource, wherein the second feedback resource is within a window (e.g., a time of the second feedback resource is during the window) and/or is within a predefined duration of the first timing or the second timing (e.g., a time of the second feedback resource is within the predefined duration of the first timing or the second timing). The channel access for the second feedback resource is performed successfully (e.g., the first UE may successfully access a second channel for transmission of the sidelink HARQ feedback using the second feedback resource). In an example, the channel access may correspond to semi-static channel access and/or dynamic channel access. In step 1420, in response to successfully performing the channel access for the second feedback resource, the first UE performs, in the second feedback resource, a sidelink feedback transmission of the sidelink HARQ feedback to the second UE.

In an example in which the predefined duration corresponds to a time length of 10 ms, the second feedback resource may be within 10 ms of the first timing or the second timing (e.g., between 0 ms and 10 ms after the first timing or the second timing).

In one embodiment, the first UE receives the sidelink transmission in the first timing. The first timing may correspond at least one of a time unit, a slot, a symbol, a point in time, a time location, a location, a time domain position, etc.

In one embodiment, the first feedback resource is in the second timing. In one embodiment, the first UE attempts to access the channel (for transmitting the sidelink HARQ feedback) and/or fails the attempt to access the channel in the second timing (e.g., the first UE fails to access the channel for transmitting the sidelink HARQ feedback in the second timing). The second timing may correspond at least one of a time unit, a slot, a symbol, a point in time, a time location, a location, a time domain position, etc.

In one embodiment, the first UE performs the sidelink feedback transmission of the sidelink HARQ feedback (in the second feedback resource) in a third timing. The third timing may correspond at least one of a time unit, a slot, a symbol, a point in time, a time location, a location, a time domain position, etc.

In one embodiment, the first timing is before (e.g., earlier than) the second timing.

In one embodiment, the second timing is before (e.g., earlier than) the third timing.

In one embodiment, the first UE determines a beginning of the window based upon the first timing or the second timing. In some examples, the window starts from the first timing or the second timing. The beginning of the window may correspond to at least one of a starting time of the window, a starting slot of the window (e.g., a slot in which the window starts), a starting symbol of the window (e.g., a symbol in which the window starts), etc. In some examples, the beginning of the window is determined in response to the first timing or the second timing (e.g., in response to the reception of the sidelink transmission in the first timing and/or in response to attempting to access and/or failing to access the channel in the second timing). In some examples, a duration (e.g., at least one of a time length, a quantity of slots, etc.) of the window may correspond to a predefined value, such as a value that is determined (e.g., pre-determined) and/or configured (e.g., pre-configured) (e.g., the first UE may determine the predefined value and/or be configured with the predefined value prior to the beginning of the window). In an example in which the predefined value (and/or the duration of the window) correspond to a time length, and the window starts from a starting time (e.g., the first timing or the second timing), the window may extend from the starting time to an ending time, wherein the ending time may correspond to a sum of the starting time and the time length.

In one embodiment, the predefined duration (e.g., at least one of a time length, a quantity of slots, etc.) may correspond to a predefined value, such as a value that is determined (e.g., pre-determined) and/or configured (e.g., pre-configured) (e.g., the first UE may determine the predefined value and/or be configured with the predefined value prior to the first timing or the second timing). In an example in which the predefined duration is a time length, and the second feedback resource is within the predefined duration of the first timing, the second feedback resource may be within a span of time that extends from the first timing (e.g., a starting time of the span of time) to an ending time, wherein the ending time may correspond to a sum of the first timing (e.g., the starting time) and the time length, wherein the first UE may determine the predefined duration and/or be configured with the predefined duration prior to the first timing. In an example in which the predefined duration is a time length, and the second feedback resource is within the predefined duration of the second timing, the second feedback resource may be within the span of time that extends from the second timing (e.g., a starting time of the span of time) to an ending time, wherein the ending time may correspond to a sum of the second timing (e.g., the starting time) and the time length, wherein the first UE may determine the predefined duration and/or be configured with the predefined duration prior to the second timing.

In one embodiment, the window and/or the predefined duration is associated with (e.g., used for) retransmission, of the sidelink HARQ feedback, without reception of a signal (e.g., a request, such as a request to perform one or more sidelink transmissions) from the second UE. For example, the window and/or the predefined duration may be used for the first UE to retransmit the sidelink HARQ feedback without receiving a signal (e.g., a request) from the second UE. For example, during the window and/or within the predefined duration of the first timing or the second timing (e.g., during the span of time associated with the predefined duration), the first UE may perform one or more retransmissions of the sidelink HARQ feedback (and/or one or more retransmissions of one or more other sidelink HARQ feedbacks) without receiving a signal (e.g., a request) from the second UE.

In one embodiment, the window and/or the predefined duration is associated with (e.g., used for) retransmission, of the sidelink HARQ feedback, without triggering resource selection. For example, the window and/or the predefined duration may be used for the first UE to retransmit the sidelink HARQ feedback without triggering resource selection (e.g., without triggering and/or performing resource selection for retransmission of the sidelink HARQ feedback). For example, during the window and/or within the predefined duration of the first timing or the second timing (e.g., during the span of time associated with the predefined duration), the first UE may perform one or more retransmissions of the sidelink HARQ feedback (and/or one or more retransmissions of one or more other sidelink HARQ feedbacks) without triggering resource selection (e.g., without triggering and/or performing resource selection for retransmission of the sidelink HARQ feedback).

In one embodiment, the window and/or the span of time associated with the predefined duration are different than channel occupancy time (e.g., the window and/or the span of time associated with the predefined duration are not channel occupancy time).

In one embodiment, the first UE performs the sidelink feedback transmission of the sidelink HARQ feedback during the window and/or within the predefined duration of the first timing or the second timing (e.g., during the span of time associated with the predefined duration).

In one embodiment, if the third timing is during the window and/or within the predefined duration of the first timing or the second timing (e.g., during the span of time associated with the predefined duration), the first UE performs the sidelink feedback transmission of the sidelink HARQ feedback without triggering resource selection (e.g., without triggering and/or performing resource selection for the sidelink feedback transmission of the sidelink HARQ feedback).

In one embodiment, if the third timing is after the window and/or after the span of time associated with the predefined duration, the first UE triggers resource selection for transmitting the sidelink HARQ feedback.

In one embodiment, the first UE determines whether or not to trigger resource selection for the sidelink feedback transmission of the sidelink HARQ feedback based upon whether or not the third timing is during the window and/or within the predefined duration of the first timing or the second timing (e.g., whether or not the third timing is during the span of time associated with the predefined duration). The first UE may perform the sidelink feedback transmission of the sidelink HARQ feedback without triggering resource selection based upon a determination that the third timing is during the window and/or within the predefined duration of the first timing or the second timing (e.g., whether or not the third timing is during the span of time associated with the predefined duration). Alternatively and/or additionally, the first UE may trigger resource selection for transmitting the sidelink HARQ feedback based upon a determination that the third timing is after the window and/or after the span of time associated with the predefined duration.

In one embodiment, the sidelink feedback transmission of the sidelink HARQ feedback is performed using a PSFCH format associated with delivery of multiple sidelink HARQ feedbacks. For example, the PSFCH format (e.g., a long format of PSFCH for delivering multiple sidelink HARQ feedbacks) is used for the sidelink feedback transmission of the sidelink HARQ feedback. In an example, the PSFCH format may be associated with a larger size than a (smaller) PSFCH format associated with delivery of a single sidelink HARQ feedback.

In one embodiment, the sidelink feedback transmission of the sidelink HARQ feedback (in the second feedback resource) is a PSFCH transmission (e.g., the sidelink feedback transmission is PSFCH).

In one embodiment, the sidelink transmission is scheduled by a SCI (e.g., a SCI received by the first UE). The SCI provides a HARQ process number (e.g., HARQ feedback process number), of the second UE, for the sidelink transmission. In an example, the sidelink transmission of the sidelink HARQ feedback (in the second feedback resource) may be based upon the HARQ process number indicated by the sidelink transmission. In an example, the sidelink HARQ feedback may be indicative of (and/or based upon) the HARQ process number indicated by the sidelink transmission.

In one embodiment, a first parameter in the sidelink resource pool indicates whether or not retransmission of the sidelink HARQ feedback is supported (e.g., at least one of supported by the first UE, supported by the second UE, supported by the sidelink resource pool, etc.). For example, the first parameter may configure the first UE to (i) support (and/or perform) retransmission of the sidelink HARQ feedback, or (ii) not support (and/or not perform) retransmission of the sidelink HARQ feedback. For example, if the first parameter is a first value, the first UE may be configured (and/or allowed) to perform retransmission of the sidelink HARQ feedback. Alternatively and/or additionally, if the first parameter is a second value, the first UE may be configured not to perform retransmission of the sidelink HARQ feedback (and/or the first UE may not be allowed to perform retransmission of the sidelink HARQ feedback).

In one embodiment, a second parameter associated with PC5 RRC signaling between the first UE and the second UE indicates whether or not retransmission of the sidelink HARQ feedback is supported (e.g., at least one of supported by the first UE, supported by the second UE, supported by the sidelink resource pool, etc.). The PC5 RRC signaling may correspond to transmissions of one or more PC5 RRC signals between the first UE and the second UE (e.g., the second parameter may be indicated by a signal of the one or more PC5 RRC signals). For example, the second parameter may configure the first UE to (i) support (and/or perform) retransmission of the sidelink HARQ feedback, or (ii) not support (and/or not perform) retransmission of the sidelink HARQ feedback. For example, if the second parameter is a first value, the first UE may be configured (and/or allowed) to perform retransmission of the sidelink HARQ feedback. Alternatively and/or additionally, if the second parameter is a second value, the first UE may be configured not to perform retransmission of the sidelink HARQ feedback (and/or the first UE may not be allowed to perform retransmission of the sidelink HARQ feedback).

In one embodiment, the first UE determines, based upon the first parameter and/or the second parameter, whether or not to (i) retransmit the sidelink HARQ feedback and/or (ii) perform the sidelink feedback transmission of the sidelink HARQ feedback in the second feedback resource. In an example, if the first parameter and/or the second parameter indicate retransmission of the sidelink HARQ feedback is supported (e.g., if the first parameter and/or the second parameter (i) indicate to the first UE to support retransmission of the sidelink HARQ feedback and/or (ii) configure the first UE to support retransmission of the sidelink HARQ feedback), the first UE does not retransmit the sidelink HARQ feedback (and/or does not retransmit one or more other sidelink HARQ feedbacks), and/or the first UE does not perform the sidelink feedback transmission of the sidelink HARQ feedback in the second feedback resource.

In one embodiment, the first UE determines a CBR (e.g., a CBR associated with the channel). The CBR may be used to disable and/or enable retransmission of the sidelink HARQ feedback. The first UE may determine, based upon a comparison of the CBR with a threshold (e.g., based upon whether or not the CBR is larger than the threshold), whether or not to perform the sidelink feedback transmission of the sidelink HARQ feedback in the second feedback resource. In some examples, the first UE may perform the sidelink feedback transmission of the sidelink HARQ feedback in the second feedback resource based upon a determination that the CBR is not larger than the threshold. Alternatively and/or additionally, the first UE may not perform the sidelink feedback transmission of the sidelink HARQ feedback in the second feedback resource based upon a determination that the CBR is larger than the threshold.

In one embodiment, the sidelink feedback transmission of the sidelink HARQ feedback in the second feedback resource corresponds to a retransmission of the sidelink HARQ feedback.

In one embodiment, a third parameter in the sidelink resource pool indicates whether or not the sidelink feedback transmission of the sidelink HARQ feedback in the second feedback resource is supported (e.g., at least one of supported by the first UE, supported by the second UE, supported by the sidelink resource pool, etc.). For example, the third parameter may configure the first UE to (i) support (and/or perform) the sidelink feedback transmission of the sidelink HARQ feedback in the second feedback resource, or (ii) not support (and/or not perform) the sidelink feedback transmission of the sidelink HARQ feedback in the second feedback resource. For example, if the third parameter is a first value, the first UE may be configured (and/or allowed) to perform the sidelink feedback transmission of the sidelink HARQ feedback in the second feedback resource. Alternatively and/or additionally, if the third parameter is a second value, the first UE may be configured not to perform the sidelink feedback transmission of the sidelink HARQ feedback in the second feedback resource (and/or the first UE may not be allowed to perform the sidelink feedback transmission of the sidelink HARQ feedback in the second feedback resource).

In one embodiment, a fourth parameter associated with PC5 RRC signaling between the first UE and the second UE indicates whether or not the sidelink feedback transmission of the sidelink HARQ feedback in the second feedback resource is supported (e.g., at least one of supported by the first UE, supported by the second UE, supported by the sidelink resource pool, etc.). The PC5 RRC signaling may correspond to transmissions of one or more PC5 RRC signals between the first UE and the second UE (e.g., the fourth parameter may be indicated by a signal of the one or more PC5 RRC signals). For example, the fourth parameter may configure the first UE to (i) support (and/or perform) the sidelink feedback transmission of the sidelink HARQ feedback in the second feedback resource, or (ii) not support (and/or not perform) the sidelink feedback transmission of the sidelink HARQ feedback in the second feedback resource. For example, if the fourth parameter is a first value, the first UE may be configured (and/or allowed) to perform the sidelink feedback transmission of the sidelink HARQ feedback in the second feedback resource. Alternatively and/or additionally, if the fourth parameter is a second value, the first UE may be configured not to perform the sidelink feedback transmission of the sidelink HARQ feedback in the second feedback resource (and/or the first UE may not be allowed to perform the sidelink feedback transmission of the sidelink HARQ feedback in the second feedback resource).

In one embodiment, the CBR (associated with the channel, for example) is used to disable and/or enable the sidelink feedback transmission of the sidelink HARQ feedback in the second feedback resource. The first UE may determine, based upon a comparison of the CBR with a threshold (e.g., based upon whether or not the CBR is larger than the threshold), whether or not to perform the sidelink feedback transmission of the sidelink HARQ feedback in the second feedback resource. In some examples, the first UE may perform the sidelink feedback transmission of the sidelink HARQ feedback in the second feedback resource based upon a determination that the CBR is not larger than the threshold. Alternatively and/or additionally, the first UE may not perform the sidelink feedback transmission of the sidelink HARQ feedback in the second feedback resource based upon a determination that the CBR is larger than the threshold.

In one embodiment, the first UE performs the sidelink feedback transmission of the sidelink HARQ feedback in the second feedback resource in response to failing to access the channel for the transmission of the sidelink HARQ feedback in the first feedback resource.

In one embodiment, the first UE performs the channel access for the second feedback resource in response to failing to access the channel for the transmission of the sidelink HARQ feedback in the first feedback resource.

Referring back to FIGS. 3 and 4, in one exemplary embodiment of a first UE, the device 300 includes a program code 312 stored in the memory 310. The CPU 308 may execute program code 312 to enable the first UE (i) to receive a sidelink transmission from a second UE in a first timing, wherein the sidelink transmission is associated with enabled sidelink HARQ feedback, (ii) attempting to access a channel for transmission of a sidelink HARQ feedback in a first feedback resource, wherein the sidelink HARQ feedback is in response to the sidelink transmission, wherein attempting to access the channel for the transmission of the sidelink HARQ feedback in the first feedback resource fails, and wherein the first feedback resource is in a second timing, (iii) to perform channel access for a second feedback resource, wherein the second feedback resource is within a window and/or is within a predefined duration of the first timing or the second timing, and wherein the channel access for the second feedback resource is performed successfully, and (iv) in response to successfully performing the channel access for the second feedback resource, to perform, in the second feedback resource, a sidelink feedback transmission of the sidelink HARQ feedback to the second UE. Furthermore, the CPU 308 can execute the program code 312 to perform one, some and/or all of the above-described actions and steps and/or others described herein.

A communication device (e.g., a UE, a base station, a network node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 8-14. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 8-14, and/or one, some and/or all of the above-described actions and steps and/or others described herein.

It may be appreciated that applying one or more of the techniques presented herein may result in one or more benefits including, but not limited to, increased efficiency of communication between devices (e.g., UEs, such as UEs communicating in sidelink). The increased efficiency may be a result of enabling UEs to communicate with each other in sidelink via sidelink transmission on unlicensed spectrum (e.g., wideband unlicensed spectrum), which may improve throughput. For example, for sidelink transmission applied on unlicensed spectrum which may need fair coexistence with one or more other RATs and/or non-3GPP devices, sidelink transmission may be performed under regulation for unlicensed spectrum using the techniques provided herein. With sidelink transmission on unlicensed spectrum, benefit of wideband unlicensed spectrum could improve throughput.

Various aspects of the disclosure have been described above. It should be apparent that the teachings herein may be embodied in a wide variety of forms and that any specific structure, function, or both being disclosed herein is merely representative. Based upon the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based upon pulse repetition frequencies. In some aspects concurrent channels may be established based upon pulse position or offsets. In some aspects concurrent channels may be established based upon time hopping sequences. In some aspects concurrent channels may be established based upon pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method of a first User Equipment (UE) performing sidelink communication in a sidelink resource pool, the method comprising:
receiving a sidelink transmission from a second UE, wherein the sidelink transmission is associated with enabled sidelink Hybrid Automatic Repeat Request (HARQ) feedback;
attempting to access a channel for transmission of a sidelink HARQ feedback in a first feedback resource, wherein:
the sidelink HARQ feedback is in response to the sidelink transmission; and
attempting to access the channel for the transmission of the sidelink HARQ feedback in the first feedback resource fails;
performing channel access for a second feedback resource, wherein:
the second feedback resource is within a window; and
the channel access for the second feedback resource is performed successfully; and
in response to successfully performing the channel access for the second feedback resource, performing, in the second feedback resource, a sidelink feedback transmission of the sidelink HARQ feedback to the second UE.

2. The method of claim 1, wherein at least one of:
the first UE receives the sidelink transmission in a first timing;
the first feedback resource is in a second timing;
the first UE performs the sidelink feedback transmission of the sidelink HARQ feedback in the second feedback resource in a third timing;
the first timing is before the second timing; or
the second timing is before the third timing.

3. The method of claim 2, wherein at least one of:
the method comprises determining a beginning of the window based upon the first timing or the second timing;
a duration of the window corresponds to a predefined value;
the window is associated with retransmission, of the sidelink HARQ feedback, without reception of a signal from the second UE;
the window is associated with retransmission, of the sidelink HARQ feedback, without triggering resource selection;
the window is different than channel occupancy time; or
the first UE performs the sidelink feedback transmission of the sidelink HARQ feedback during the window.

4. The method of claim 3, comprising:
determining whether or not to trigger resource selection for the sidelink feedback transmission of the sidelink HARQ feedback based upon whether or not the third timing is during the window, wherein the first UE performs the sidelink feedback transmission of the sidelink HARQ feedback without triggering resource selection based upon a determination that the third timing is during the window.

5. The method of claim 1, wherein at least one of:
the sidelink feedback transmission of the sidelink HARQ feedback is performed using a Physical Sidelink Feedback Channel (PSFCH) format associated with delivery of multiple sidelink HARQ feedbacks; or
the sidelink feedback transmission of the sidelink HARQ feedback is a PSFCH transmission.

6. The method of claim 1, wherein:
the sidelink transmission is scheduled by a Sidelink Control Information (SCI); and
the SCI provides a HARQ process number, of the second UE, for the sidelink transmission.

7. The method of claim 1, wherein at least one of:
a first parameter in the sidelink resource pool indicates whether or not retransmission of the sidelink HARQ feedback is supported;
a second parameter associated with PC5 Radio Resource Control (RRC) signaling between the first UE and the second UE indicates whether or not retransmission of the sidelink HARQ feedback is supported; or
the method comprises determining, based upon at least one of the first parameter or the second parameter, whether or not to at least one of:
retransmit the sidelink HARQ feedback; or
perform the sidelink feedback transmission of the sidelink HARQ feedback in the second feedback resource.

8. The method of claim 7, comprising:
determining a Channel Busy Ratio (CBR), wherein at least one of:
the CBR is used to at least one of disable or enable retransmission of the sidelink HARQ feedback;
the method comprises determining, based upon a comparison of the CBR is with a threshold, whether or not to perform the sidelink feedback transmission of the sidelink HARQ feedback in the second feedback resource; or
the first UE performs the sidelink feedback transmission of the sidelink HARQ feedback in the second feedback resource based upon a determination that the CBR is not larger than the threshold.

9. The method of claim 1, wherein:
the sidelink feedback transmission of the sidelink HARQ feedback in the second feedback resource corresponds to a retransmission of the sidelink HARQ feedback.

10. The method of claim 1, wherein at least one of:
a first parameter in the sidelink resource pool indicates whether or not the sidelink feedback transmission of the sidelink HARQ feedback in the second feedback resource is supported; or
a second parameter associated with PC5 Radio Resource Control (RRC) signaling between the first UE and the second UE indicates whether or not the sidelink feedback transmission of the sidelink HARQ feedback in the second feedback resource is supported.

11. The method of claim 10, comprising:
determining a Channel Busy Ratio (CBR), wherein at least one of:
the CBR is used to at least one of disable or enable the sidelink feedback transmission of the sidelink HARQ feedback in the second feedback resource;
the method comprises determining, based upon a comparison of the CBR is with a threshold, whether or not to perform the sidelink feedback transmission of the sidelink HARQ feedback in the second feedback resource; or
the first UE performs the sidelink feedback transmission of the sidelink HARQ feedback in the second feedback resource based upon a determination that the CBR is not larger than the threshold.

12. The method of claim 1, wherein at least one of:
the first UE performs the sidelink feedback transmission of the sidelink HARQ feedback in the second feedback resource in response to failing to access the channel for the transmission of the sidelink HARQ feedback in the first feedback resource; or
the first UE performs the channel access for the second feedback resource in response to failing to access the channel for the transmission of the sidelink HARQ feedback in the first feedback resource.

13. A method of a first User Equipment (UE) performing sidelink communication in a sidelink resource pool, the method comprising:
receiving a sidelink transmission from a second UE in a first timing, wherein the sidelink transmission is associated with enabled sidelink Hybrid Automatic Repeat Request (HARQ) feedback;
attempting to access a channel for transmission of a sidelink HARQ feedback in a first feedback resource, wherein:
the sidelink HARQ feedback is in response to the sidelink transmission;
attempting to access the channel for the transmission of the sidelink HARQ feedback in the first feedback resource fails; and
the first feedback resource is in a second timing;
performing channel access for a second feedback resource, wherein:
the second feedback resource is within a predefined duration of the first timing or the second timing; and
the channel access for the second feedback resource is performed successfully; and
in response to successfully performing the channel access for the second feedback resource, performing, in the second feedback resource, a sidelink feedback transmission of the sidelink HARQ feedback to the second UE.

14. The method of claim 13, wherein at least one of:
the first UE performs the sidelink feedback transmission of the sidelink HARQ feedback in a third timing;
the first timing is before the second timing; or
the second timing is before the third timing.

15. The method of claim 13, wherein at least one of:
the predefined duration is associated with retransmission, of the sidelink HARQ feedback, without triggering resource selection; or
the method comprises determining whether or not to trigger resource selection for the sidelink feedback transmission of the sidelink HARQ feedback based upon whether or not the sidelink feedback transmission is within the predefined duration of the first timing or the second timing, wherein the first UE performs the sidelink feedback transmission of the sidelink HARQ feedback without triggering resource selection based upon a determination that the sidelink feedback transmission is within the predefined duration of the first timing or the second timing.

16. The method of claim 13, wherein at least one of:
the sidelink feedback transmission of the sidelink HARQ feedback is performed using a Physical Sidelink Feedback Channel (PSFCH) format associated with delivery of multiple sidelink HARQ feedbacks; or
the sidelink feedback transmission of the sidelink HARQ feedback is a PSFCH transmission.

17. The method of claim 13, wherein at least one of:
a first parameter in the sidelink resource pool indicates whether or not retransmission of the sidelink HARQ feedback is supported;
a second parameter associated with PC5 Radio Resource Control (RRC) signaling between the first UE and the second UE indicates whether or not retransmission of the sidelink HARQ feedback is supported;
a third parameter in the sidelink resource pool indicates whether or not the sidelink feedback transmission of the sidelink HARQ feedback in the second feedback resource is supported;
a fourth parameter associated with the PC5 RRC signaling between the first UE and the second UE indicates whether or not the sidelink feedback transmission of the sidelink HARQ feedback in the second feedback resource is supported; or
the method comprises determining, based upon at least one of the first parameter, the second parameter, the third parameter or the fourth parameter, whether or not to at least one of:
retransmit the sidelink HARQ feedback; or
perform the sidelink feedback transmission of the sidelink HARQ feedback in the second feedback resource.

18. The method of claim 13, comprising:
determining a Channel Busy Ratio (CBR), wherein at least one of:
the CBR is used to at least one of disable or enable at least one of retransmission of the sidelink HARQ feedback or the sidelink feedback transmission of the sidelink HARQ feedback in the second feedback resource;
the method comprises determining, based upon a comparison of the CBR is with a threshold, whether or not to perform the sidelink feedback transmission of the sidelink HARQ feedback in the second feedback resource; or
the first UE performs the sidelink feedback transmission of the sidelink HARQ feedback in the second feedback resource based upon a determination that the CBR is not larger than the threshold.

19. The method of claim 13, wherein:
the sidelink feedback transmission of the sidelink HARQ feedback in the second feedback resource corresponds to a retransmission of the sidelink HARQ feedback.

20. The method of claim 13, wherein at least one of:
the first UE performs the sidelink feedback transmission of the sidelink HARQ feedback in the second feedback resource in response to failing to access the channel for the transmission of the sidelink HARQ feedback in the first feedback resource; or
the first UE performs the channel access for the second feedback resource in response to failing to access the channel for the transmission of the sidelink HARQ feedback in the first feedback resource.
